(19) United States
(12) Patent Application Publication
(10) Pub. No.: US 2014/0156512 A1
(43) Pub. Date: Jun. 5, 2014

(54) PROVIDING MONEY TRANSFER USING A MONEY TRANSFER PLATFORM

(71) Applicant: Pangea Universal Holdings, Inc., Chicago, IL (US)

(72) Inventors: Rahier Rahman, Chicago, IL (US); Carson Junginger, Chicago, IL (US)

(73) Assignee: Pangea Universal Holdings, Inc., Chicago, IL (US)

(21) Appl. No.: 14/095,806

(22) Filed: Dec. 3, 2013

Related U.S. Application Data
(60) Provisional application No. 61/733,028, filed on Dec. 4, 2012.
(60) Provisional application No. 61/803,036, filed on Mar. 18, 2013.
(60) Provisional application No. 61/888,062, filed on Oct. 8, 2013.

(51) Int. Cl. G06Q 20/10

(52) U.S. Cl. CPC G06Q 20/10
USPC 705/39

(57) ABSTRACT

The present disclosure describes methods, systems, and computer program products for providing funds transfer over an existing retail payment system using a money transfer platform. One method includes receiving a funds transfer request associated with a funds pack for transferring funds from a first location to a receiver in a second location, requesting validation of a unique identifier associated with the funds pack from a first-location payment network provider, receiving a validation success notification responsive to the requested validation of a unique identifier from the first payment network provider, generating a termination identifier identifying the funds transfer transaction request, transmitting the termination identifier to the receiver, providing instructions causing funds to be paid to the receiver upon presentation of the termination identifier, and receiving a request for funds from a second-location payment network provider, the request for funds associated with payment of funds based on presentation of the termination identifier.

### CROSS REFERENCE TO RELATED APPLICATIONS

This application is related to and claims priority to U.S. Provisional Patent Application No. 61/733,028, entitled “System and Method for Peer-to-Peer Funds Transfer,” filed Dec. 4, 2012, which is hereby incorporated by reference for all purposes. This application is further related to and claims priority to U.S. Provisional Patent Application No. 61/803,036, entitled “System and Method for Providing Peer-To-Peer Money Transfer,” filed Mar. 18, 2013, which is hereby incorporated by reference for all purposes. This application is further related to and claims priority to U.S. Provisional Patent Application No. 61/888,062, entitled “System and Method for Providing Peer-To-Peer Funds Transfer,” filed Oct. 8, 2013, which is hereby incorporated by reference for all purposes.

### BACKGROUND

Electronic money transfer (also referred to herein as electronic funds transfer or EFT for short) has been widely available for many years. For example, a sender requests his bank to wire a certain amount of money to a receiver. The sender can initiate such funds transfer by physically visiting the bank, or using a web interface provided by the bank. The conventional electronic funds transfer presents numerous problems, including that bank-operated electronic funds transfer is very expensive. Fund-in (also referred to herein as “money-in” and/or “cash-in”) and fund-out (also referred to herein as “money-out” and/or “cash-out”) options also require bank accounts. However, big portions of most countries' population, especially those residing in developing countries or in rural areas of developed countries, do not have bank accounts, credit cards, etc. and remain at a disadvantage compared to those that do. These underbanked people often find it challenging or even impossible to transfer a small amount of money to another person at a low cost.

### SUMMARY

The present disclosure relates to computer-implemented methods, computer-readable media, and computer systems for providing funds transfer over an existing retail payment system using a money transfer platform (MTP). Multiple fund-in options and fund-out options are supported. In some implementations, a sender uses a mobile device to communicate with a server within the system to initiate a funds transfer to a receiver (e.g., a recipient, beneficiary, etc.). In some implementations, a system at a retail location, such as a point-of-sale device, reads data from the sender's mobile device. The server further communicates with one or more third-party service providers to complete the funds transfer, and provide the transferred funds to the receiver.

As used herein, a fund-in option is an instrument and process that allows a sender to provide funds for a transfer, while a fund-out option is an instrument and process that allow a receiver to obtain the transferred fund. People have needs for other types of fund-in/fund-out options, examples of which are merchants and retail stores that operate point-of-sales (POS) systems, prepaid load networks (such as the RELOADIT PACK or Vanilla Reload Network), self-service kiosks, card payments (such as credit, debit and prepaid debit cards), gift cards, mobile wallets (such as GOOGLE WALLET, APPLE ID, PayPal, ISIS, Facebook or AMAZON LOGIN), digital currency (such as BITCOIN), reward programs, value transfer vouchers, mobile money accounts that are linked to mobile phone numbers, remote deposit captures (such as a photo image of a check), mobile applications that store credit card information, ATMs (Automated Teller Machines), online gaming platforms, social networks, and/or other fund-in/fund-out options.

Conventional electronic funds transfer demands that both the sender and the receiver have bank accounts at banks that support international electronic funds transfer. However, many banks in rural areas of underdeveloped countries likely do not provide an international electronic funds transfer service. Accordingly, underbanked people who lack a sufficient bank account or a credit card are at a disadvantage. The underbanked often use pre-paid cards, some of which can be reloaded with additional funds. Family and friends have the additional inconvenience of sending money to the underbanked. At times, options are to send money through money transfer services, such as Western Union and the like, paying an additional fee, or sending pre-paid cards through the mail, which can get lost and take additional time for the underbanked individual to receive. The sender and the underbanked are both looking for an inexpensive and quick way of sending funds electronically.

In recent years, technologies for transferring money using mobile devices, such as smartphones, have been developed. However, the prior art to date does not disclose a system and method for funds transfer that acts as its own clearing house, does not use third-party processors, requires minimal user interaction, and provides fraud protection. Furthermore, the prior art to date does not disclose seamless software integration into POS activation networks within the existing retail payment ecosystem. With wide popularity of mobile phones in underdeveloped rural areas, mobile-phone-based national and international funds transfer using a MTP is thus desirable—where the MTP takes advantage of the existing retail payment systems to provide money transfer services to the underbanked.

Accordingly, there is a need for a MTP funds transfer system and method that provide various types of fund-in and fund-out options. Additionally, the MTP funds transfer system needs to support national and/or international funds transfer.

In some implementations, the described system and method primarily comprise a multi-platform, MTP money transfer system that provides a low-cost suite of financial service products using website, mobile application and retail locations. The platform acts like a clearing house, in that the platform includes components that handle settlement and reconciliation for the point-of-sale activation (POSA) networks and funds transactions using a credit line. The system also provides a mechanism to seamlessly transfer stored value across retail networks and card programs, providing interconnectivity across prepaid retail networks enabling “closed-loop” systems to speak to each other. To utilize the system's platform on the web or mobile application, consumers may link a mobile phone number and a funding source, such as a prepaid debit card, to an account within the system. To utilize the system's platform at a retail location, consumers will be able to use cash and link a phone number to a transaction.

The sender can initiate a transaction online or through a mobile application. In some such implementations, after logging into the website or mobile application, the sender enters the sender's name, phone number, and password. The sender then enters the receiver's name, phone number, amount of funds to transfer, payment method and a transfer pincode. The information is displayed on a confirmation page which the sender approves to submit the transaction.

The sender can also initiate the transaction at a retail location. In some such implementations, the sender goes to a retail location and informs the sales associate that he would like to transfer funds through the system. The sender provides their name, phone number, amount of funds to transfer, receiver's name, receiver's phone number, and transfer pincode. The sender may then use cash or any other form of payment to fund the transaction. The sales associate enters the information into the system and shows the sender the confirmation page. If the information is correct, the sender approves and submits the transaction.

In some implementations, the system generates a money transfer code (MTC) and sends an email or short message service (SMS) message to the sender and the receiver with the transaction information and the MTC. The sender, for security reasons, then contacts the receiver and gives the receiver the transfer pincode.

If the receiver already has a pre-paid card on file, the funds may be automatically loaded onto that card and are immediately accessible by the receiver. If the receiver has multiple cards on file, the receiver may log into the system's website or mobile application and choose the card on which to load the funds. Once the receiver chooses the card, the funds are immediately accessible. If the receiver does not have a pre-paid card, the receiver can go to their preferred retail location or they can use the retailer location map to find a retail location close to him or her. Once at the retail location, the receiver chooses a pre-paid card and presents the card to the sales associate. The receiver informs the sales associate that he wants to load funds from a transfer onto that card and provides the sales associate with their name, phone number, MTC and transfer pincode. The sales associate enters this information into the system and loads the funds transferred onto the card.

In some implementations, a first computer-implemented method includes receiving a funds transfer transaction request for transferring funds from a first location to a receiver in a second location, the funds transfer transaction request associated with a funds pack credited with an amount of funds, requesting, by operation of a computer, validation of a unique identifier associated with the funds pack from a first payment network provider associated with the first location, receiving, by operation of a computer, a validation success notification responsive to the requested validation of a unique identifier from the first payment network provider, generating, by operation of a computer, a termination identifier identifying the funds transfer transaction request, transmitting the termination identifier to the receiver, providing instructions, by operation of a computer, causing funds to be paid to the receiver upon presentation of the termination identifier, and receiving a request for funds from a second payment network provider associated with the second location, the request for funds associated with payment of funds based on presentation of the termination identifier.

In some implementations, a second computer-implemented method includes receiving an indication of an interest in transferring funds from a sender at a first location to a receiver at a second location, receiving an indication of an initial funds transfer amount in a first currency for transfer to a receiver at the second location, receiving a currency exchange rate value for an exchange of a first currency used at the first location and a second currency used at the second location, converting, using the currency exchange rate, the initial funds transfer amount into a whole value initial funds receiving amount as measured in the second currency, determining, by a computer, at least one whole value funds receiving amount associated with the initial funds receiving amount, in a whole value amount lower than the initial funds receiving amount or a whole value amount higher than the initial funds receiving amount, as measured in the second currency, and initiating a display of the whole value initial funds receiving amount and the whole value funds receiving amount.

In some implementations, a third computer-implemented method includes receiving an automatic identification and data capture (AIDC) code from a POS, the AIDC code comprising a particular product identifier, transfer amount, and a unique transfer identifier, transmitting the AIDC code to a MTP transfer service, receiving an activation response from the MTP transfer service, the activation response responsive to the MTP transfer service: validating, by a computer, the identified transfer, activating the transfer, and alerting a receiver uniquely identified by the unique transfer identifier, and transmitting an activation response to the POS.

Other implementations of the first, second, and third method aspects include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination.

First Computer-Implemented Method:

A first aspect, combinable with the general implementation, further comprising initiating a fund-in process for the funds transfer transaction request using the funds pack.

A second aspect, combinable with any of the previous aspects, further comprising transmitting geographic locations that may be used for a fund-in process using the funds pack.

A third aspect, combinable with any of the previous aspects, wherein a mobile software application initiates a display of the transmitted geographic locations.

A fourth aspect, combinable with any of the previous aspects, further comprising storing encrypted data generated from the termination identifier and data associated with the funds transfer transaction request.

A fifth aspect, combinable with any of the previous aspects, further comprising: receiving the unique identifier associated with the funds pack and an amount of funds to credit to the funds pack, and storing the unique identifier and the amount of funds to credit to the funds pack to a database

A sixth aspect, combinable with any of the previous aspects, further comprising initiating a funds transfer process to transfer a particular amount of credited funds from the first location to the second location.

A seventh aspect, combinable with any of the previous aspects, further comprising generating instructions to: convert the particular amount of credited funds into a different currency type, and credit the different currency type to the second payment network provider.

Second Computer-Implemented Method:

A first aspect, combinable with the general implementation, further comprising initiating a request for the currency exchange rate value between funds for the first location and the second location.

A second aspect, combinable with the general implementation, further comprising: determining, by a computer, two whole value funds receiving amounts associated with the whole value initial funds receiving amount, one whole value funds receiving amount lower than the whole value initial funds receiving amount and one whole value funds receiving amount higher than the whole value initial funds receiving amount, as measured in the second currency, and initiating a display of the whole value initial funds receiving amount and the two whole value funds receiving amounts.

A third aspect, combinable with the general implementation, further comprising: receiving withdrawal denominations associated with automatic teller machines proximate to the receiver; and using the withdrawal denominations to determine the two whole value funds receiving amounts.

A fourth aspect, combinable with the general implementation, further comprising initiating a display of a funds transfer history received from a MTP transfer service.

A fifth aspect, combinable with the general implementation, further comprising transmitting a funds transfer transaction request to a MTP transfer service, the funds transfer transaction request associated with a funds pack credited with an amount of funds for transfer from the first location to the receiver.

A sixth aspect, combinable with the general implementation, further comprising initiating a display of geographic locations available for the receiver to receive funds near the second location.

A seventh aspect, combinable with the general implementation, further comprising initiating a display of geographic locations available for the sender to provide funds to be transferred near the first location.

An eighth aspect, combinable with the general implementation, further comprising initiating a funds transfer transaction request for transferring funds from the first location to the receiver.

A ninth aspect, combinable with the general implementation, wherein the first currency is different than the second currency.

A tenth aspect, combinable with the general implementation, wherein the first location is in a country that is different than the country in which the second location is located.

An eleventh aspect, combinable with the general implementation, further comprising receiving an indication of the currency to be used as the second currency transferred to the receiver at the second location.

A twelfth aspect, combinable with the general implementation, wherein fees charged for the electronic funds transfer are subtracted from the initial funds transfer amount prior to converting currencies.

A thirteenth aspect, combinable with the general implementation, wherein fees charged for the electronic funds transfer are obtained by providing the sender an exchange rate different than an exchange rate received by an entity facilitating the electronic funds transfer.

A fourteenth aspect, combinable with the general implementation, wherein fees charged for the electronic funds transfer are denominated in the first currency.

Third Computer-Implemented Method:

A first aspect, combinable with the general implementation, wherein the AIDC code includes one of a linear code or a matrix code.

A second aspect, combinable with the general implementation, wherein the receiver is uniquely identified by at least one of a telephone number, an address, a government issued identifier, or an employer issued identifier.

A third aspect, combinable with the general implementation, further comprising the POS requesting and receiving the transfer amount responsive to receiving the AIDC code.

A fourth aspect, combinable with the general implementation, wherein the POS receives the AIDC code from a mobile computing device.

A fifth aspect, combinable with the general implementation, further comprising the POS processing the received AIDC code.

A sixth aspect, combinable with the general implementation, wherein the MTP transfer service exposes an application programming interface (API) for receiving a request containing the AIDC code.

Certain implementation may provide various advantages. For example, some or all implementations be tailored to enhance the reach and drive the cost of global remittance down by employing scalable software technology that leverages prepaid product activation capabilities across expansive retail networks.

An advantage of some or all implementations is to provide a MTP funds transfer system leveraging existing retail payment systems.

An advantage of some or all implementations is to provide a MTP funds transfer system that supports a convenient, cost-effective, and secure funds transfer service.

An advantage of some or all implementations is to provide a MTP funds transfer system that supports international funds transfer.

An advantage of some or all implementations is to provide a MTP funds transfer system using mobile devices.

An advantage of some or all implementations is to provide a MTP funds transfer system using an Internet map service.

An advantage of some or all implementations is to provide a MTP funds transfer system that displays physical locations of fund-in options on a map for a sender.

An advantage of some or all implementations is to provide a MTP funds transfer system that displays physical locations of fund-out options on a map for a sender.

An advantage of some or all implementations is to provide a MTP funds transfer system that displays physical locations of fund-out options on a map for a receiver.

An advantage of some or all implementations is to provide a MTP funds transfer system that supports multiple fund-in options.

An advantage of some or all implementations is to provide a MTP funds transfer system that supports multiple fund-out options.

An advantage of some or all implementations is to provide a MTP funds transfer system that supports ATMs as fund-out options.

An advantage of some or all implementations is to provide a MTP funds transfer system that supports funds transfer conforming to ATM withdrawal denominations.

An advantage of some or all implementations is to provide seamless software integration into existing retail locations through their existing retail locations through their existing point-of-sale (POS) terminals, allowing these “close loop” systems to communicate with each other and transfer fund between each other.

An advantage of some or all implementations is to provide a platform that acts like a clearing house, in that the platform includes components that handle settlement and a reconciliation for the POSA networks and funds transaction using a credit line.

An advantage of some or all implementations is to deliver convenient, cost-effective, and secure financial service products.

An advantage of some or all implementations is to provide seamless software integration into existing retail locations through their existing point-of-sale terminals, allowing these “closed loop” systems to speak to each other and transfer value between each other.

An advantage of some or all implementations is to provide an “open loop” payment platform that facilitates “open loop” transfer capability across networks and provide anti-money laundering (AML), Office of Foreign Assets Control (OFAC), and compliance support for participating retailers.

An advantage of some or all implementations is to provide a platform that acts like a clearing house, in that the platform includes components that handle settlement and a reconciliation for the POSA networks and funds transactions using a credit line.

An advantage of some or all implementations is to allow a sender to transmit funds to anyone in a few simple steps either online, by SMS message or in person at a retail location.

An advantage of some or all implementations is to allow a recipient to instantaneously redeem the money transfer on a prepaid card.

An advantage of some or all implementations is to provide remote deposit capture that includes the ability to scan an image of a check and deposit funds directly onto a prepaid card, limiting the need to use check cashing locations.

An advantage of some or all implementations is to provide bill pay functionality that supports payments to utilities, water companies, cable providers, department stores, banks, credit card companies and wireless services.

An advantage of some or all implementations is to provide fraud protection and detection services and to deliver convenient, cost-effective, and secure financial service products.

Other advantages of this disclosure will be clear to a person of ordinary skill in the art. It should be understood, however, that a system or method could practice the disclosure while not achieving all of the enumerated advantages, and that the protected disclosure is defined by the claims.

Accordingly, the details of one or more implementations of the subject matter of this specification are set forth in the accompanying drawings and the description below. Other features, aspects, and advantages of the subject matter will become apparent from the description, the drawings, and the claims.

### DESCRIPTION OF THE DRAWINGS

Although the characteristic features of this disclosure will be particularly pointed out in the claims, the detailed description, and the manner in which it may be made and used, may be better understood by referring to the following detailed description taken in connection with the accompanying drawings forming a part hereof, wherein like reference numerals refer to like parts throughout the several views and in which:

FIG. 1 is an example flowchart diagram depicting an example international funds transfer process using a money transfer platform (MTP) and retail payment system.

FIG. 2 is an example flowchart diagram depicting a fund-in process for a MTP funds transfer.

FIG. 3 is an example sequence diagram depicting a process by which a sender provides funds for a MTP funds transfer.

FIG. 4 is an example sequence diagram depicting a process by which a sender provides funds for a MTP funds transfer.

FIG. 5 is an example flow chart depicting a currency exchange process by which a MTP funds transfer is performed across border between two countries.

FIG. 6 is an example sequence diagram depicting a process by which a receiver in a MTP funds transfer obtains the transferred funds.

FIG. 7 is an example sequence diagram depicting a process by which a receiver in a MTP funds transfer obtains the transferred funds.

FIG. 8 is an example flow chart depicting a process by which a receiver in a MTP funds transfer obtains the transferred funds.

FIG. 9 is an example screenshot displayed on a sender's mobile device that allows the sender to login or create a new account for a MTP funds transfer.

FIG. 10 is an example screenshot displayed on a sender's mobile device that allows the sender to create a new account for a MTP funds transfer.

FIG. 11A is an example screenshot displayed on a sender's mobile device that displays a transfer history.

FIG. 11B is an example screenshot displayed on a sender's mobile device that displays a menu.

FIG. 12 is an example screenshot displayed on a sender's mobile device that allows a sender to edit a contact for MTP funds transfer.

FIG. 13 is an example screenshot displayed on a sender's mobile device that allows a sender to edit a contact for MTP funds transfer.

FIG. 14 is an example screenshot displayed on a sender's mobile device that allows the sender to initiate a MTP funds transfer.

FIG. 15 is an example screenshot displayed on a sender's mobile device that allows the sender to select a receiver for a MTP funds transfer.

FIG. 16 is an example screenshot displayed on a sender's mobile device that allows the sender to enter an amount for a MTP funds transfer.

FIG. 17 is an example screenshot displayed on a sender's mobile device that displays details of a MTP funds transfer.

FIG. 18 is an example screenshot displayed on a sender's mobile device that allows the sender to select a drop-off location for a MTP funds transfer.

FIG. 19 is an example screenshot displayed on a sender's mobile device that depicts a map and nearby retail locations for a MTP funds transfer.

FIG. 20 is an example screenshot displayed on a sender's mobile device that depicts a map and nearby retail locations with a selected location for a MTP funds transfer.

FIG. 21 is an example screenshot displayed on a sender's mobile device that allows the sender to enter a money pack number.

FIG. 22 is an example screenshot displayed on a sender's mobile device that displays details of a MTP funds transfer.

FIG. 23 is an example screenshot displayed on a sender's mobile device that displays a barcode for paying for a MTP funds transfer.

FIG. 24 is an example screenshot displayed on a sender's mobile device that displays an alternative barcode for paying for a MTP funds transfer.

FIG. 25 is an example screenshot displayed on a sender's mobile device that displays whole receiving amounts for a MTP funds transfer.

FIG. 26 is an example flowchart diagram depicting a process by which whole receiving amounts are determined for a MTP funds transfer.

FIG. 27 is an example simplified block diagram depicting various fund-in, fund-out, and currency conversion options.

FIG. 28A illustrates an example of an API definition.

FIG. 28B illustrates an example of an API authentication.

FIG. 28C illustrates an example of a request signing.

FIG. 28D illustrates an example method of signing a request.

FIG. 28E illustrates an example of a request after signing.

FIG. 28F illustrates an example of endpoints.

FIG. 28G illustrates an example of a response format.

FIG. 28H illustrates an example of a /transfer.

FIG. 28I illustrates an example of a withdrawal authorization.

FIG. 28J illustrates an example of a withdrawal definition.

FIG. 28K illustrates an example of a transfer test definition.

FIG. 29 is an example flowchart illustrating the communications within a MTP funds transfer system; and

FIG. 30 is an example flowchart diagram showing a high-level example funds flow from a sender to a receiver.

FIG. 31 is an example fund flow diagram depicting an example MTP fund transfer from one retail location to another retail location.

FIG. 32 is an example fund flow diagram depicting a different example of a MTP transfer process from a sender's computer to a retail location.

FIG. 33 is an example flow chart depicting an example process by which an example MTP fund transfer is originated.

FIG. 34 is an example sequence diagram depicting an example process by which an example MTP fund transfer is originated.

FIG. 35 is an example flow chart illustrating an exemplary fund pickup process.

FIG. 36 is an example sequence diagram depicting an exemplary process by which an example MTP fund transfer is received and terminated.

FIG. 37 is an example depiction of various computers or devices that can be used by senders and receivers.

FIG. 38 is an example screenshot displayed on a sender's mobile device that displays MTP fund transfer logs.

FIG. 39 is an example screenshot displayed on a sender's mobile device that allows the sender to select a receiver for an example MTP fund transfer.

FIG. 40 is an example screenshot displayed on a sender's mobile device that allows the sender to select a receiver for an example MTP fund transfer.

FIG. 41 is an example screenshot displayed on a sender's mobile device that allows the sender to specify an amount for an example MTP fund transfer.

FIG. 42 is an example screenshot displayed on a sender's mobile device that shows an example MTP fund transfer status.

FIG. 43 is an example screenshot displayed on a sender's mobile device that depicts a map and nearby retail locations for an example MTP fund transfer.

FIG. 44 is an example screenshot displayed on a sender's mobile device that depicts a map and nearby retail locations with one location selected for an example MTP fund transfer.

FIG. 45 is an example screenshot displayed on a sender's mobile device that depicts a barcode generated for an example MTP fund transfer.

FIG. 46 is an example screenshot displayed on a sender's mobile device that displays an example MTP fund transfer status.

FIG. 47 is an example screenshot displayed on a receiver's mobile device that indicates a fund has been transferred to her.

FIG. 48 is an example screenshot displayed on a receiver's mobile device that indicates a fund has been transferred to the receiver.

FIG. 49 is an example screenshot displayed on a receiver's mobile device that allows the receiver to choose a prepaid card to receive a transferred fund.

FIG. 50 is an example screenshot displayed on a receiver's mobile device that depicts a map and nearby retail locations where the receiver can pick up a transferred fund.

FIG. 51 is an example screenshot displayed on a receiver's mobile device that depicts a map and nearby retail locations with one location selected for picking up a transferred fund.

FIG. 52 is an example screenshot displayed on a receiver's mobile device that displays a selected retail location and a barcode for picking up a transferred fund.

FIG. 53 is an example screenshot displayed on a receiver's mobile device that displays a status when a transferred fund has been picked up.

FIG. 54 is an example screenshot displayed on a sender's mobile device that displays a status when an example MTP fund transfer has been completed.

FIG. 55 is an example flow diagram of the components of an illustrated implementation of a system and method for a MTP funds transfer.

FIG. 56 is an example flow diagram of a general overview of an illustrated implementation of the system and method for a MTP funds transfer.

FIG. 57 is an example flow diagram of the retail location to retail application flow, using a stored value reloadable pack, of an illustrated implementation of the system and method for a MTP funds transfer.

FIG. 58 is an example flow diagram of the website to existing prepaid card flow of an illustrated implementation of the system and method for a MTP funds transfer.

FIG. 59 illustrates an example walkthrough of a cash-in (fund-in) process.

### DETAILED DESCRIPTION

The present disclosure relates to electronic funds transfer, and more particularly relates to a system and method that provides intra-national and/or international electronic funds transfer. More particularly still, the present disclosure relates to a system and method that provides intra-country and/or international electronic funds transfer supporting multiple fund-in (“cash-in”) and fund-out (“cash-out”) options using a money transfer platform (MTP). A MTP can be, in some implementations, a peer-to-peer (P2P) or other decentralized and distributed network. In other implementations, a MTP can be any network structure and/or configuration capable of performing functionality described in the present disclosure.

In some implementations, the present disclosure also provides a system and method for providing a MTP money transfer over an existing retail payment system. The method may include indicating a receiver for a MTP money transfer using a sending mobile device, and specifying a MTP money transfer amount using the sending mobile device. The method may also include determining a set of nearby retail locations based on a GPS location of the sending mobile device, and selecting a retail location from the set of retail locations shown on a map that is displayed on the sending mobile device. Additionally, the method may include generating a sending barcode for the transfer using the sending mobile device, wherein the barcode indicates a MTP money transfer request, and displaying the sending barcode on the sending mobile device. Moreover, the method may include scanning the sending barcode by a point-of-sale (POS) in the selected retail location, and sending the MTP money transfer request to a prepaid network server. The method may further include sending the MTP money transfer request from the prepaid network server to a MTP money transfer server, validating the MTP money transfer request, and sending a notification message to a receiving mobile device indicating the MTP money transfer.

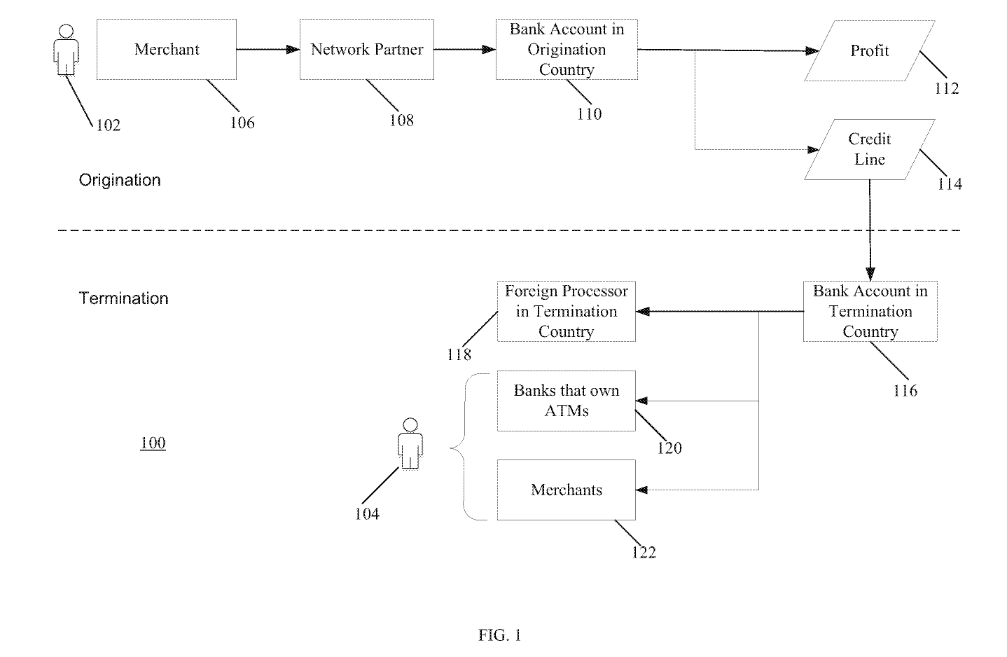

Turning to FIG. 1; FIG. 1 is an example flowchart diagram depicting an example international funds transfer process 100 using a MTP and retail payment system is shown. For example, in one implementation, a sender 102 can reside in the United States of America while a receiver 104 can reside in Mexico. In the example shown in FIG. 1, the sender 102 sends certain amount of funds to the receiver 104 using an international MTP funds transfer service empowered by an international MTP funds transfer system. To transfer the funds, the sender 102 uses one of a number of fund-in options, such as a money pack (e.g., a funds pack, credit pack, value pack, etc.) purchased from a merchant or retail store 106. For example, the sender 102 goes to a store, such as a Jewel Osco or another store, to purchase a prepaid money pack (e.g., a RELOADIT PACK or other prepaid money pack), which is a card with an identification number or a serial number and a barcode that can be loaded with an amount of money tendered by the sender 102. At the store, the sender 102 tenders, for example, $103.95 to a clerk. A network partner 108, such as a prepaid payment network provider (e.g., Blackhawk Network managing RELOADIT PACKs and/or other prepaid payment network provider(s)), authorizes the money pack. The network partner 108 then credits or transfers the value on the money pack to a bank account 110 of the international MTP funds transfer service provider. Additionally, the network partner 108 may keep a portion of the value on the money pack as a fee or pass along the entire amount and receive a reimbursement of a portion of the fee at a later date. The bank account 110 is within the origination country, such as U.S.

In one implementation, a portion of the value on the money pack is allocated as profit 112 to the service provider. Part or all of the value on the money pack is held in a regular bank account or a for-the-benefit-of (FBO)/trust account within a bank in the origination country. The credit line 114 is held in a bank in the origination country. For each step of the transaction within the origination country, the currency is the origination country's currency, such as the U.S. Dollar within the U.S.

In certain implementations, a portion of the credit line 114 is transferred to a bank account 116 of the MTP funds transfer service provider held within a bank in the termination country for the funds transfer. Within the termination country, the transaction is typically conducted in the currency of the termination country, such as Mexican Peso. However, the transaction within the termination country (which could be the same as the origination country) may be conducted in the currency of the origination country, or some other currency. A foreign payment processor 118 in the termination country assists the funds transfer, and receives a processing fee from the bank account 116. The receiver 104 has a number of fund-out options. For example, the receiver 104 accesses an ATM 120 to withdraw the funds transferred to him from the sender 102. To access the ATM 120, the receiver 104 needs to enter his access credentials, such as a termination code and pin number. Alternatively, the receiver 104 visits a local retail store 122 to cash out the transferred fund.

Fees for a transaction may be recovered in a number of ways. The funds amount to be provided by the sender as part of a fund-in transaction may be determined by adding transaction fees to the amount of funds being transferred. For example, for a transfer involving the transfer of $200.00 to a receiver in Mexico, fees of $5.00 may be added for a fund-in amount of $205.00. Alternatively, the currency exchange rate provided to the sender may be adjusted to provide fees. For example, for a transfer involving a transfer of $200.00 to a receiver in Mexico at a time when the bank exchange rate between the US dollar and the Mexican peso (MXN) is 1:13, an exchange rate of $1:12.68 MXN may be provided to the sender. At the bank exchange rate, $200 would convert to 2600 Mexican pesos. At the exchange rate provided to the user of $1:12.68 MXN, the sender would need to fund-in approximately $205.00 to convert to the same 2600 Mexican pesos, resulting in an additional $5.00 to be retained as a fee. In another embodiment, instead of having the sender fund-in $205.00, the sender could fund-in $200.00, but only 2536 (or a rounded 2540) Mexican pesos would be provided to the receiver.

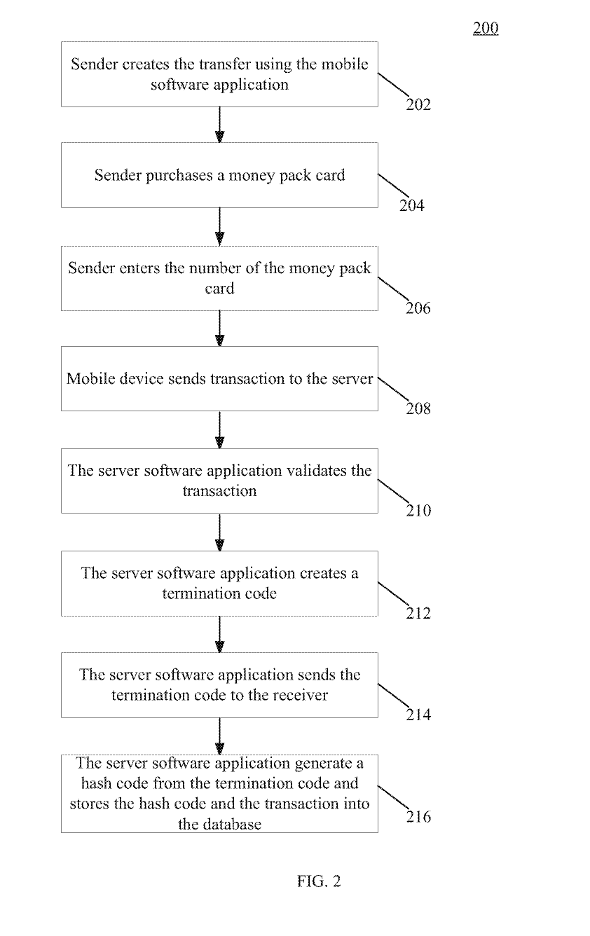

An example fund-in process by which the sender 102 pays for the transfer is further illustrated by reference to FIG. 2. A fund-in process 200 starts at 202, where the sender 102 creates the transfer using a mobile software application running on a mobile device, such as IPHONE, IPAD, and/or other mobile device. Alternatively, the sender 102 can use a laptop computer or a desktop computer to initiate the funds transfer. At 204, the sender 102 visits a retail store to purchase a money pack card. At 206, the sender 102 enters the number of the money pack card into the mobile software application.

In one implementation, the mobile software application is a software program written in Objective-C computer programming language, and runs in an IOS operating system within IPHONE smartphones. In a different implementation, the mobile software application is a software program written in C# computer programming language, and runs in a .NET environment on WINDOWS mobile devices. In a further different implementation, the mobile software application is a software program written in the JAVA computer programming language, and runs on an ANDROID smartphone. In yet a further implementation, the mobile software application is a web application usable by any internet connected device with a web browser, including mobile devices and computers.

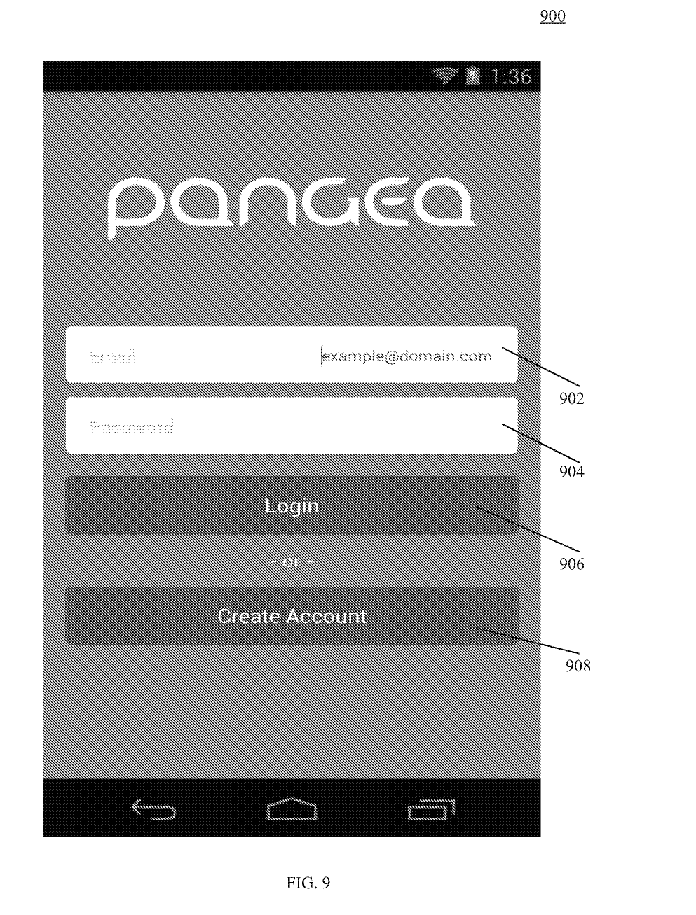

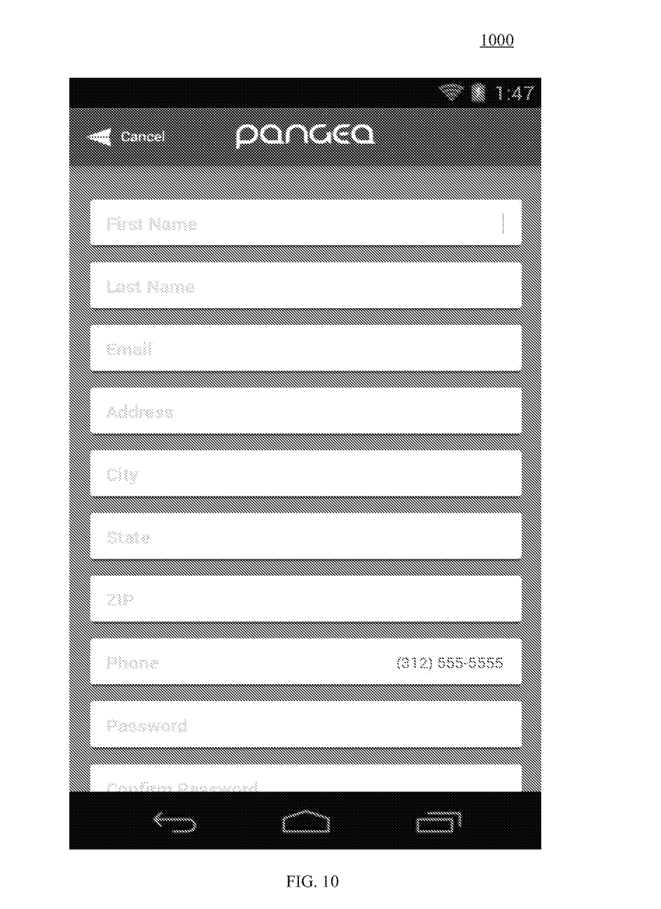

In some implementations, the mobile software application displays a start screen 900, an example screenshot of which is shown in FIG. 9, to allow a user (such as the sender 102) to create an account with the MTP funds transfer service by clicking a Create Account button 908. An example account creation screen screenshot is shown at 1000 in FIG. 10. The account creation screen allows the sender 102 to enter his first name, last name, Email, address, city, state, zip code, phone number, password, etc. The entered personal information is then sent to a server software application running on a server for creating an account for the sender 102.

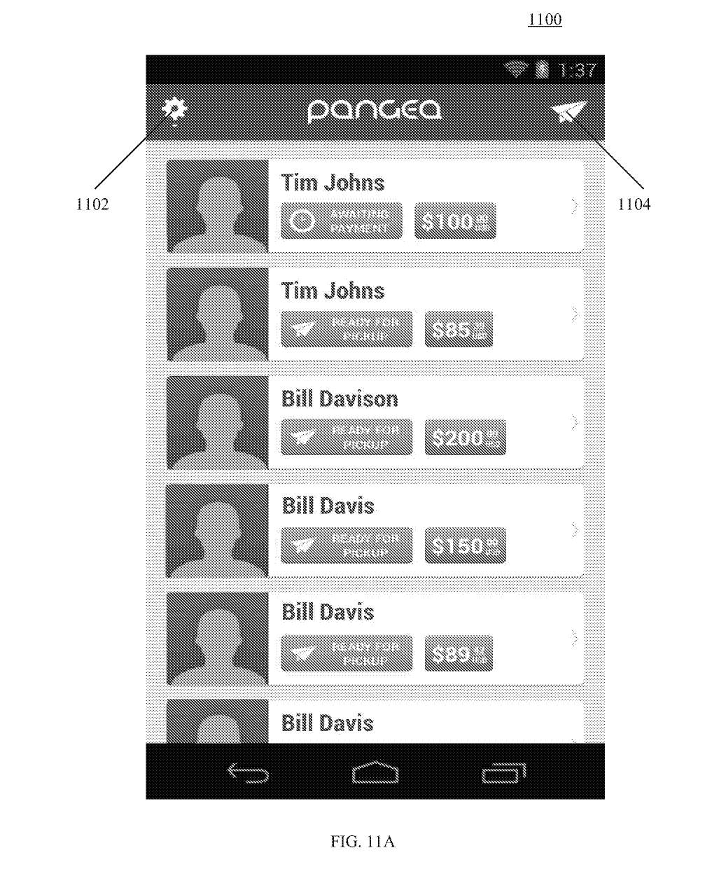

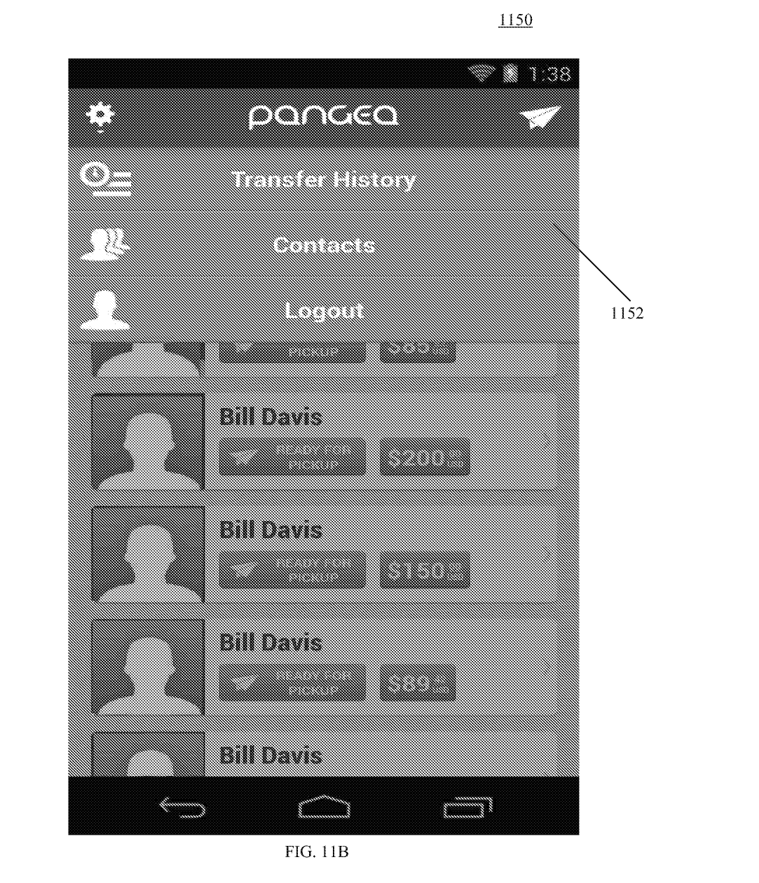

The start screen 900 further allows the sender 102 to login the MTP funds transfer service by typing in his Email address 902 and password 904 before clicking a Login button 906. Responsive to the click, the mobile software application retrieves the login credentials and sends them to the server software application. The server software application authenticates login credentials and authorizes the sender 102 to access the MTP funds transfer service. In one implementation, upon successful login by the sender 102, the server software application sends a funds transfer history list to the mobile software application, which displays the list on the mobile device. An example screenshot of the funds transfer history is shown at 1100 in FIG. 11A. The screen 1100 includes a menu button 1102 and a transfer button 1104. Responsive to a click on the menu button 1102, the mobile software application can display a menu, an example of which is shown at 1150 in FIG. 11B. The screen 1150 shows a menu 1152 that allows the sender 102 to view a transfer history, view and edit contacts, and log out from the MTP funds transfer service.

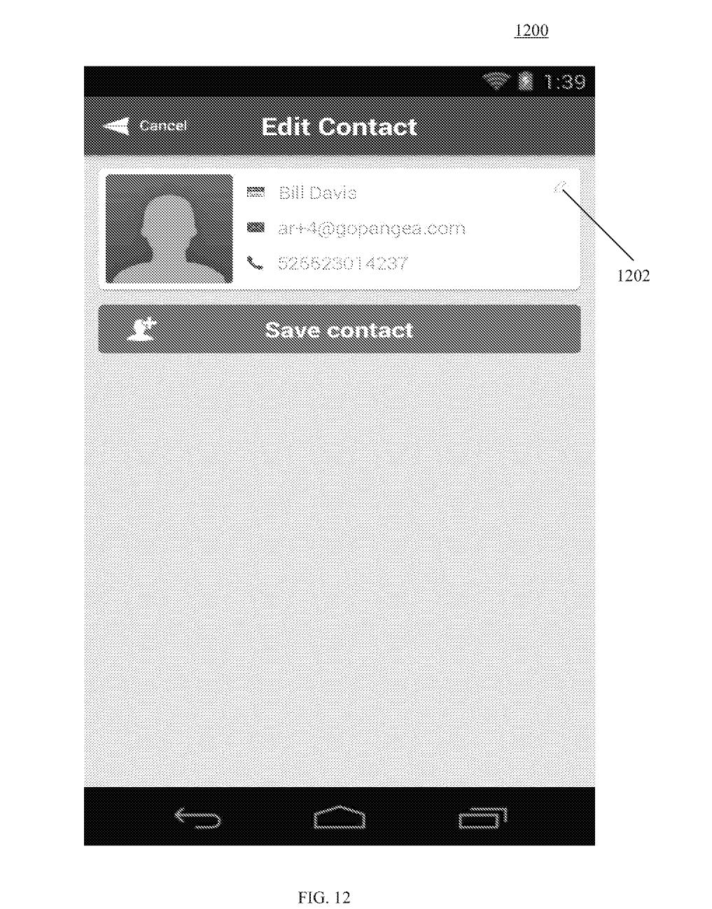

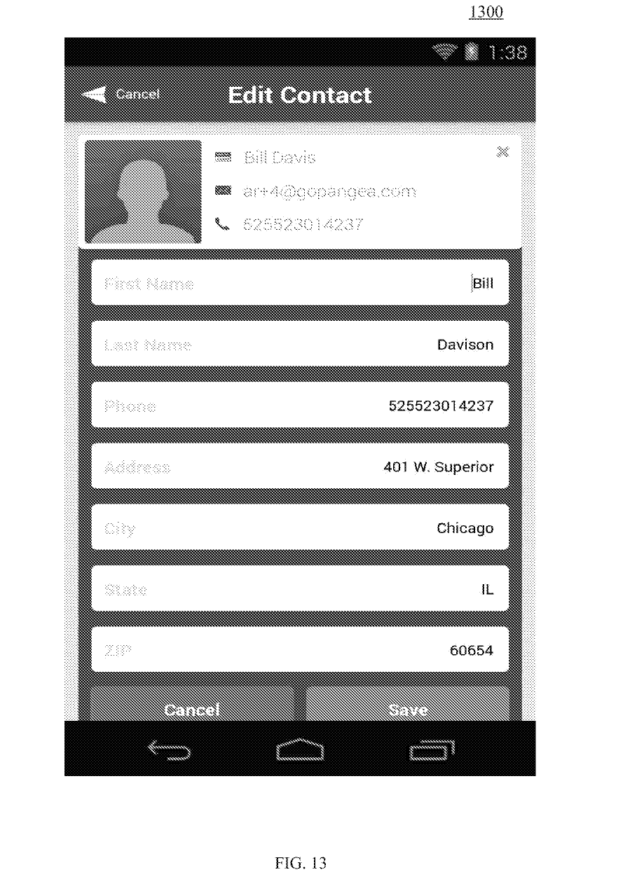

For example, an example contact editing screen 1200 is shown in FIG. 12. The details of a contact can be viewed and edited by clicking an edit button 1202. Responsive to a click on the edit button 1202, the mobile software application displays details of the contact for editing, an example screen of which is shown at 1300 in FIG. 13.

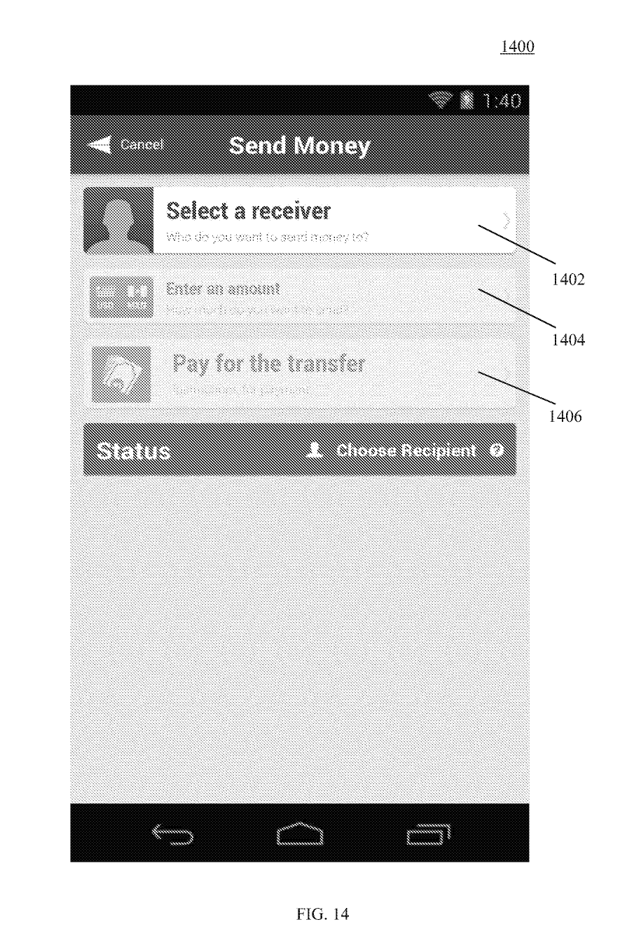

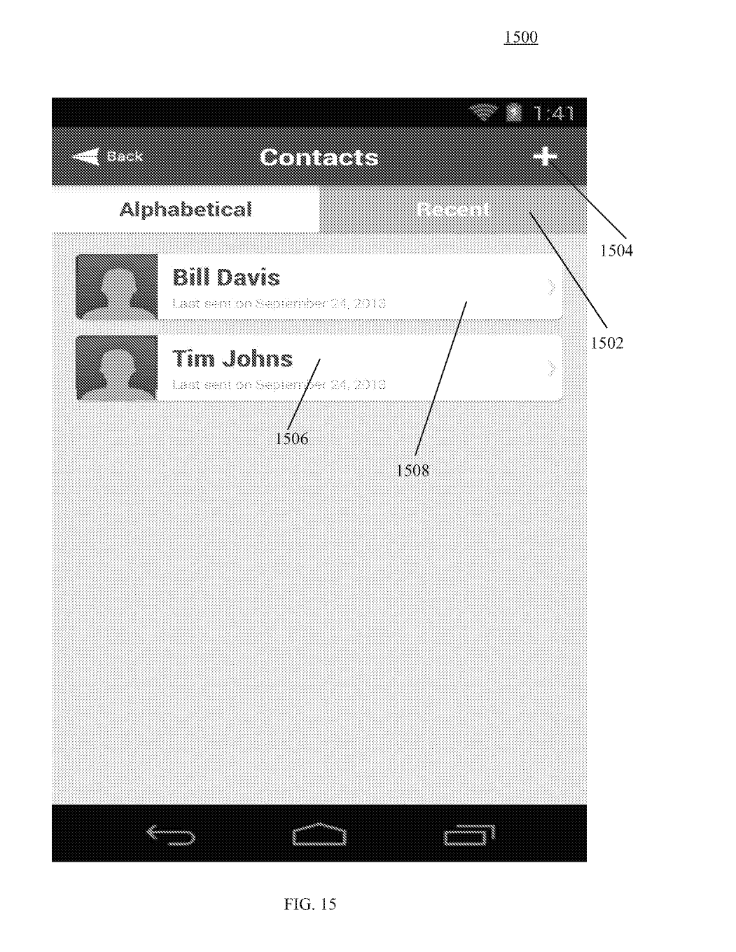

In some implementations, to initiate and create a funds transfer, the sender 102 clicks the transfer button 1104. In response, the mobile software application displays a funds transfer initiation screen, an example of which is shown at 1400 in FIG. 14. The screen 1400, as shown, includes three action buttons 1402, 1404, and 1406. Button 1402 allows the sender 102 to select a receiver of the funds to whom the sender 102 is trying to transfer. Button 1404 allows the sender 102 to specify the transfer amount, while button 1406 assists the sender 102 in establishing payment for the transfer. Responsive to a click on the button 1402, the mobile software application displays a contact list for the sender 102 to select the desired receiver. An example screenshot of the receiver selection screen is shown at 1500 in FIG. 15. The screen 1500 displays a list of contacts ordered alphabetically. Moreover, the screen 1500 allows the sender 102 to view the recent receivers of funds transfer by clicking a tab 1502. The tab 1502 allows the sender 102 to quickly select the desired receiver. The screen 1500 further includes an account creation button 1504, which causes the mobile software application to display an account creation screen, such as the screen 1000.

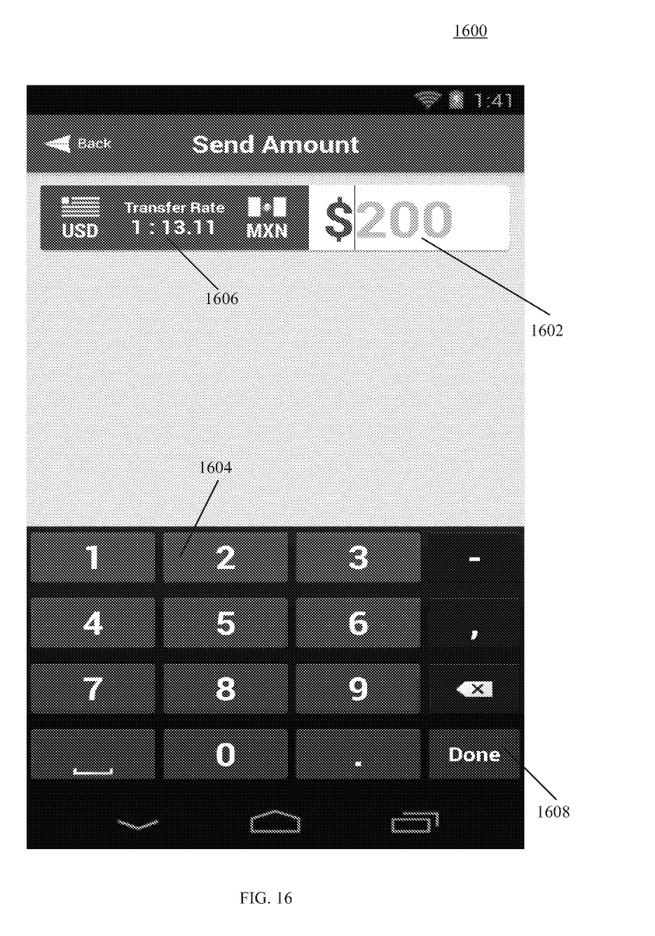

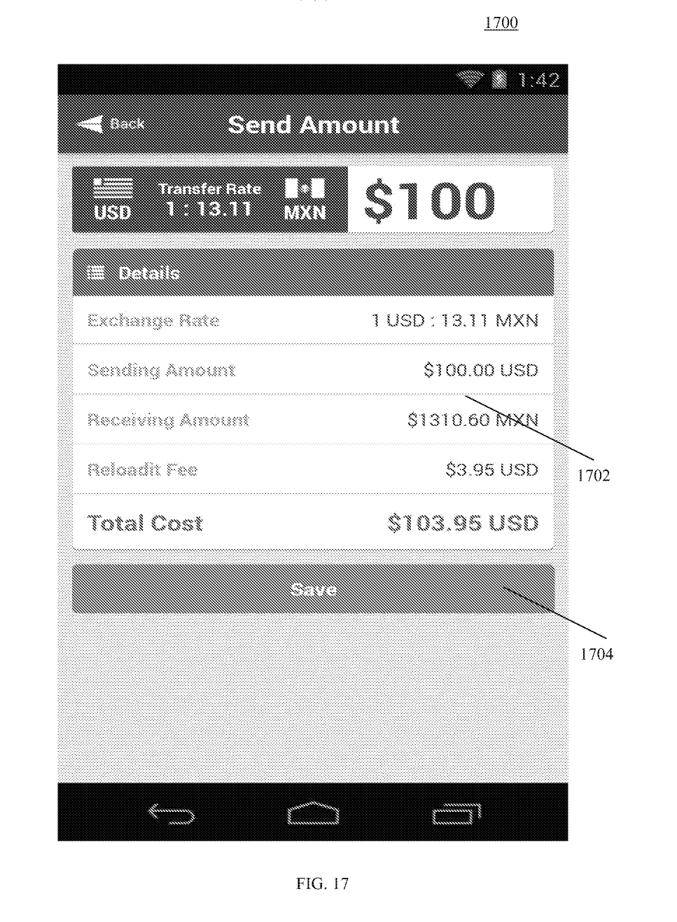

To select a receiver in accordance with the implementation shown in FIG. 15, the sender 102 clicks the receiver (such as contact 1506 or 1508) in the list. Responsive to the click, the mobile software application switches back to the screen 1400, and displays the selected receiver on the button 1402. Subsequently, the sender 102 clicks the button 1404 to bring up an input screen for the sender 102 to enter the desired transfer amount, an example screenshot of which is shown as 1600 in FIG. 16. The example screen 1600 includes a transfer amount field 1602 and a numeric keypad 1604. Additionally, the screen 1600 displays a currency exchange rate 1606. For example, on a certain day, the exchange rate between the U.S. Dollar and the Mexican Peso is 1 to 13.11. After the sender 102 enters the desired transfer amount, the sender 102 clicks a Done button 1608 which causes the mobile software application to display a transfer amount confirmation screen. A sample transfer amount confirmation screen is shown at 1700 in example screenshot FIG. 17. At 1702, the mobile software application displays the transfer amount, transfer cost, exchange rate, receiving amount, and other information of the transfer.

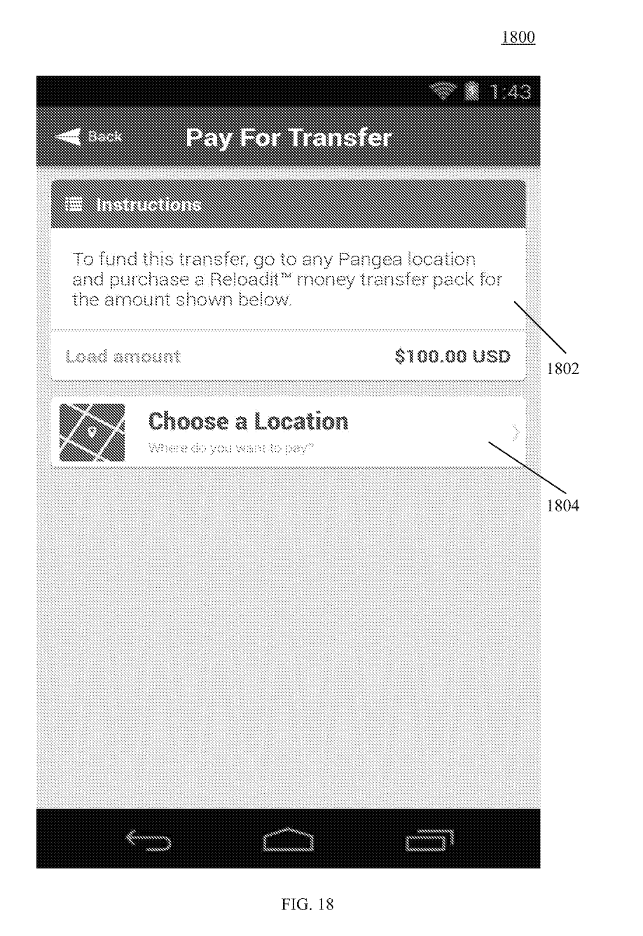

In response to a click on a Save button 1704, the mobile software application switches to the screen 1400. The mobile software application then displays the transfer amount at 1404. To pay for the transfer, the sender 102 clicks the button 1406, which causes the mobile software application to display a transfer payment screen, an example of which is shown at 1800 in FIG. 18.

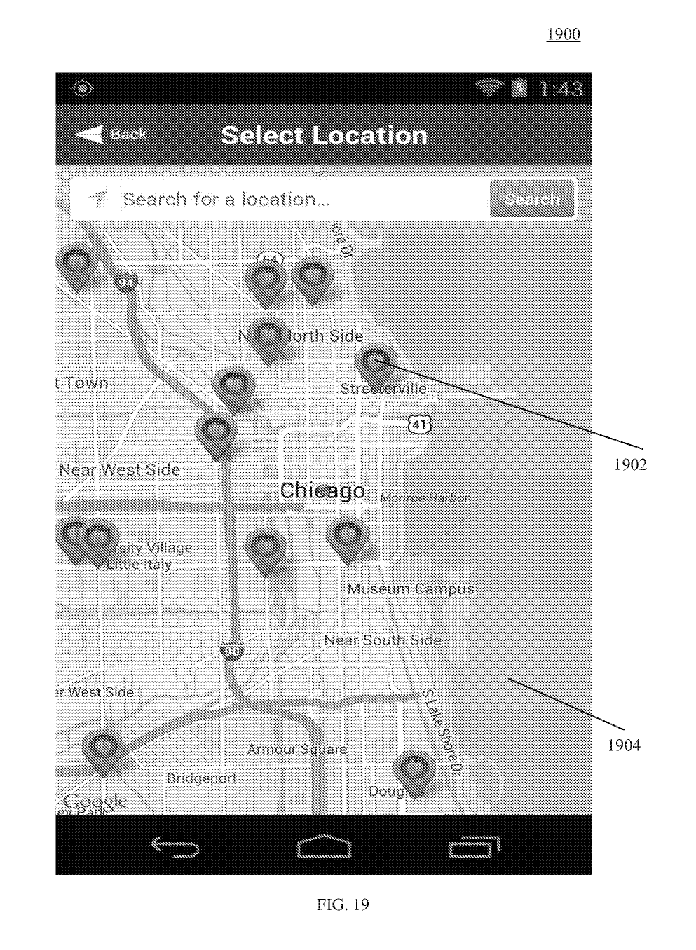

The example screen 1800 displays instructions 1802, and a Choose Location button 1804. In response to a click on the button 1804, the mobile software application displays retail stores or merchants where the sender 102 can pay for the transfer. An example screenshot showing a list of retail stores or merchants is shown at 1900 in FIG. 19. A list of retail stores or merchants 1902 are marked and displayed on the screen 1900. The mobile software application retrieves the current Global Positioning System (GPS) location of the sender 102 mobile device, and then displays a map around the GPS location using, for example, APPLE MAPS service.

In some implementations, to display the merchants 1902, the mobile software application sends the GPS location and, for example, the fund-in option of the transfer to the server software application. In response, the server software application queries a database operatively coupled to the server to retrieve a list of retail stores or merchants within a radius of the GPS location. Additionally, each entry in the list matches the fund-in option selected by the sender and sent from the mobile software application. For example, when the fund-in option is money pack cards, then only merchants that offers sale of money pack cards are returned from the database.

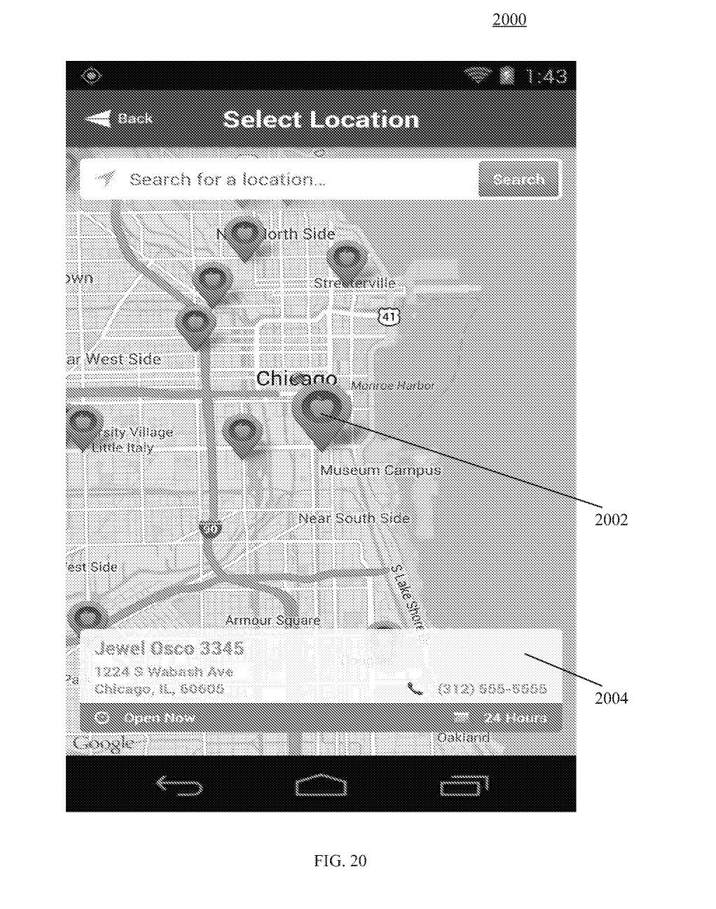

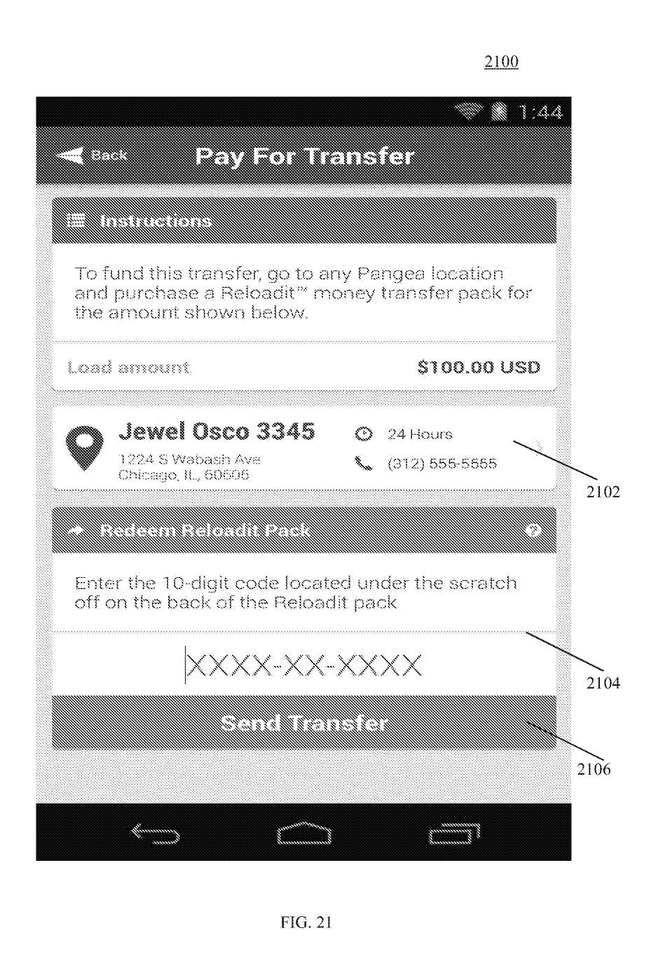

In some implementations, each retail store or merchant is represented by a data structure that can include, among other things, the merchant's name, address, city, state, zip code, GPS location, phone number, open hours, etc. The list of stores or merchants is then sent to the mobile software application. Subsequently, the mobile software application displays the list on the screen 1900. The sender 102 is then allowed to select one specific store 1902 by clicking it on the screen 1900. Accordingly, a screen showing the selected store is displayed by the mobile software application. A sample of the selected store screen is shown at 2000 in FIG. 20. The selected store is highlighted at 2002, while the details of the selected store are shown at 2004. After the retail store is selected, the mobile software application displays a screen for completing the transfer payment, an example screenshot of which is shown at 2100 in FIG. 21. In the screen 2100, the details of the selected merchant are shown at 2102.

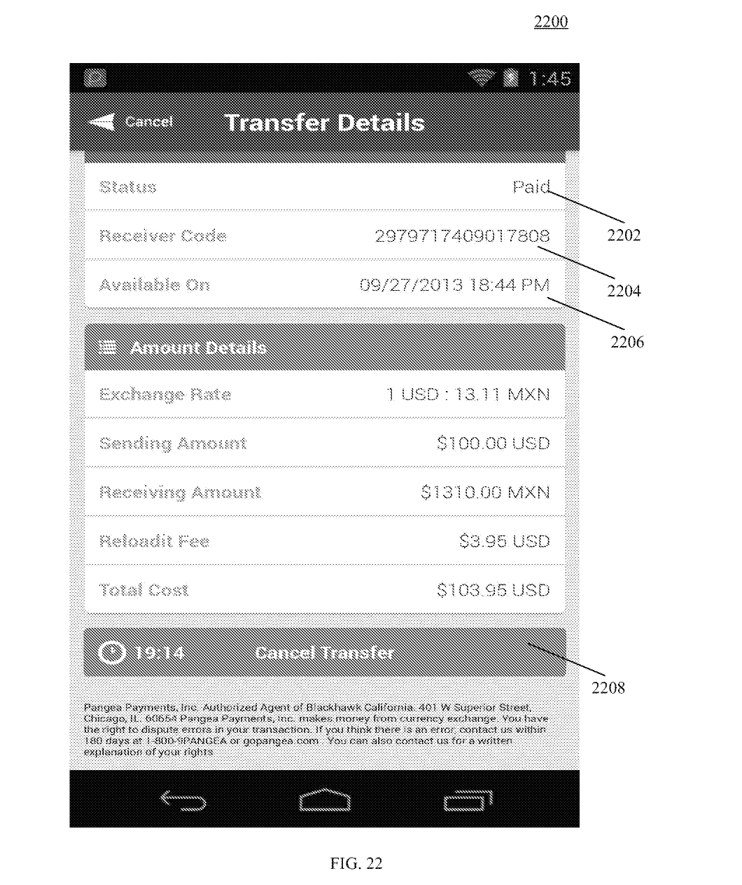

In some implementations, after the store is selected, the sender 102 then physically visits the retail store or merchant 2102 and pays for the transfer by purchasing a money pack card. At 2106, in one implementation, the sender 102 then enters the number of the money pack. Responsive to a click on the button 2106 by the sender 102, the mobile software application sends the transaction data, including the number of the money pack number and other user identification information of the receiver 104, to the server software application. In one implementation, the communication between the mobile software application and the server software application is carried out over a secure HTTPS connection. Additionally, the mobile software application displays a transfer detail screen on the mobile device, an example screenshot of which is shown at 2200 in FIG. 22. The screen 2200, as shown in FIG. 22, includes a paid status 2202, a receiver code 2204 (also referred to herein as a termination code), available time 2206, etc. The screen 2200 also allows the sender to cancel the transfer by clicking a Cancel Transfer button 2208.

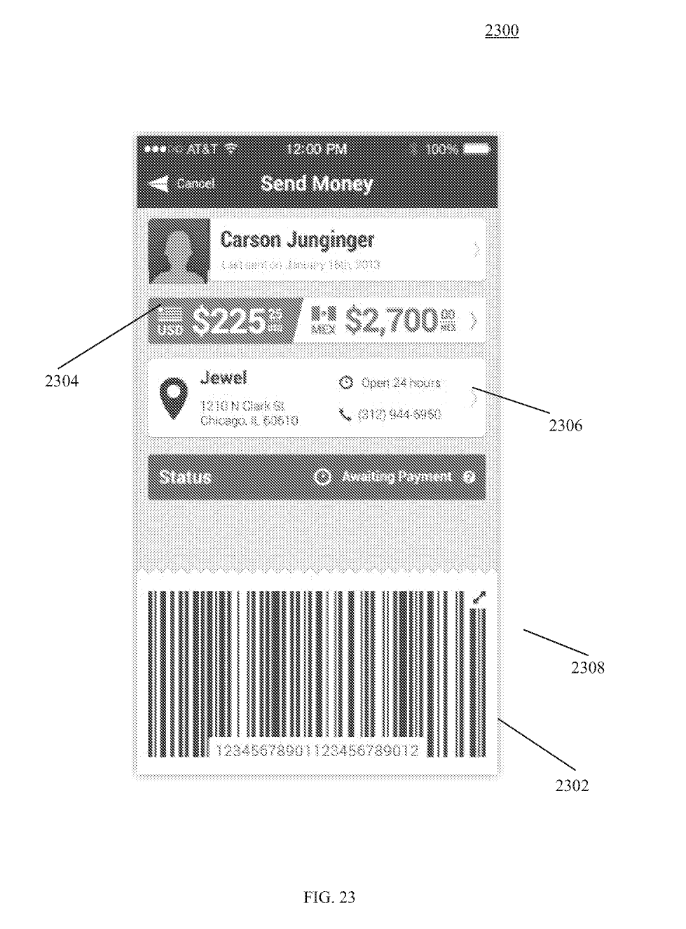

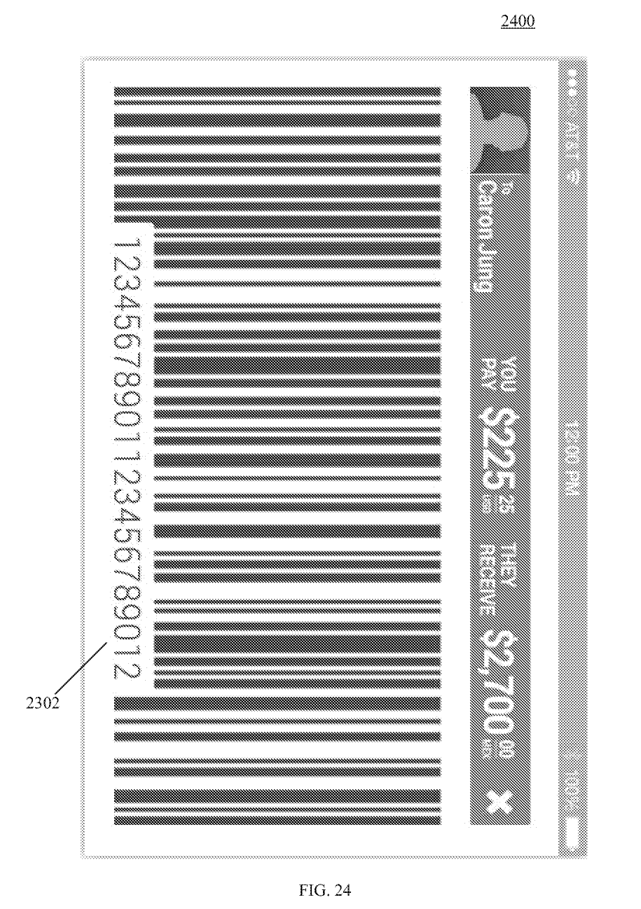

In an alternative implementation, the sender 102 uses an online payment solution, such as CASHTIE or other online payment solution, as a fund-in option. In such a case, the mobile software application displays a payment processing barcode on the mobile device, an example screenshot of which is shown at 2300 in FIG. 23. The screen 2300, as shown in FIG. 23, includes a barcode 2302. The barcode 2302 contains information identifying the transfer, and the MTP funds transfer service provider as the intermediary recipient of the funds that the sender 102 will pay at the retail store 2306. An expansion button 2308 allows the sender 102 to view a larger image of the barcode 2302. Responsive to a click on the button 2308, the mobile software application displays the larger image of the barcode 2302, an example screenshot of which is shown at 2400 in FIG. 24. In some implementations, the barcode number of the barcode 2302 is generated by the server software application in response to a request from the mobile software application. The mobile software application then generates the barcode 2302 matching the barcode number, and displays the barcode 2302 in the screens 2300 and 2400. The server software application further stores the barcode number in the database. The sender 102 takes the mobile device to the store 2306, has the barcode 2302 scanned, and pays for the funds transfer using, for example, cash.

Typically, sender 102 transfers an amount that is a multiple of ten, twenty, fifty or hundred. After currency conversion, the receiver 104 often receives an amount with fractions. For example, when the exchange rate from U.S. Dollar to Mexican Peso is 1 to 12.59, 150 U.S. Dollars will be converted to 1888.5 Mexican Pesos. In such a case, if the receiver 104 desires to withdraw the 1888.5 Mexican Pesos from an ATM machine, he is likely not able to obtain the full amount because ATM machines usually have withdrawal denominations of ten, twenty, fifty, or a hundred.

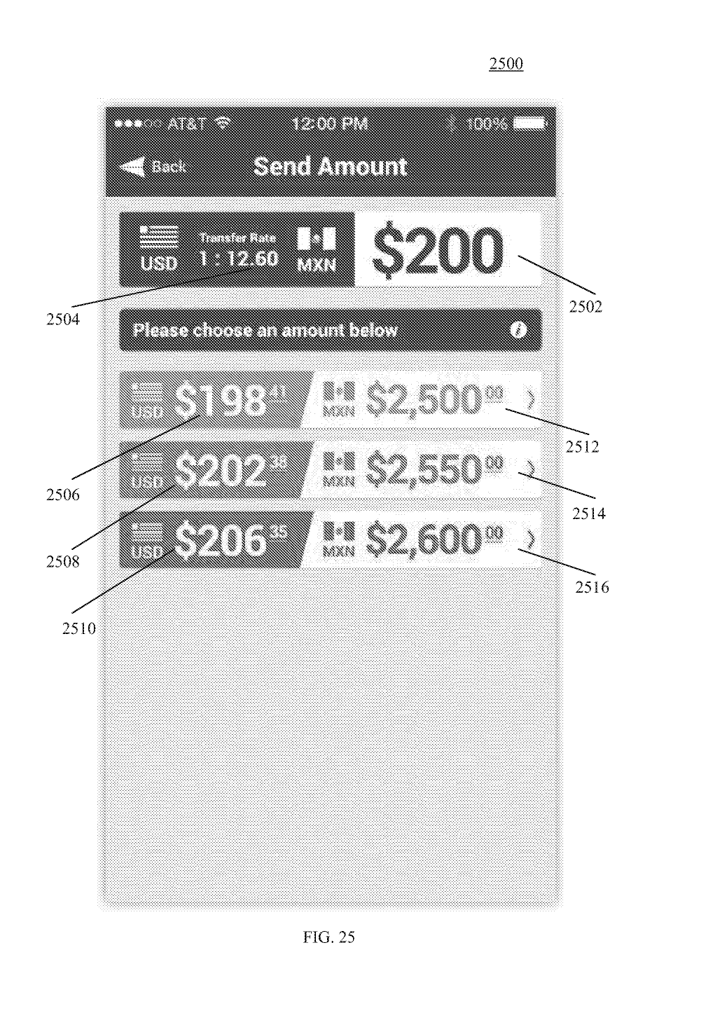

In one implementation, the mobile software application allows the sender 102 to specify or select a receiving amount that is a multiple of, for example, ten, twenty, fifty, or a hundred. An example screenshot showing one such implementation is shown at 2500 in FIG. 25. When the sender 102 enters a transfer amount of $200 U.S. Dollars at 2502, the mobile software application displays one or more receiving amounts 2512, 2514, and 2516 that are multiples of, for example, ten, twenty, fifty or hundred. The receiving amounts 2512, 2514, and 2516 in Mexican Pesos correspond to potential transfer amounts 2506, 2508, and 2510 in U.S. Dollars. The amounts 2506, 2508, and 2510 are slightly lower than, the same as, and slightly higher than the entered amount 2502, respectively. As used herein, the amounts 2512, 2514, and 2516 are also referred to as whole receiving amounts. If the sender 102 prefers the receiver 104 to receive 2,550 Mexican Pesos, he then transfers $202.38 U.S. Dollars instead of his initial intended transfer amount of $200 U.S. Dollars. Similarly, if the sender 102 desires the receiver 104 to receive 2,500 Mexican Pesos, he then transfers $198.41 U.S. Dollars instead of his initial intended transfer amount of $200 U.S.

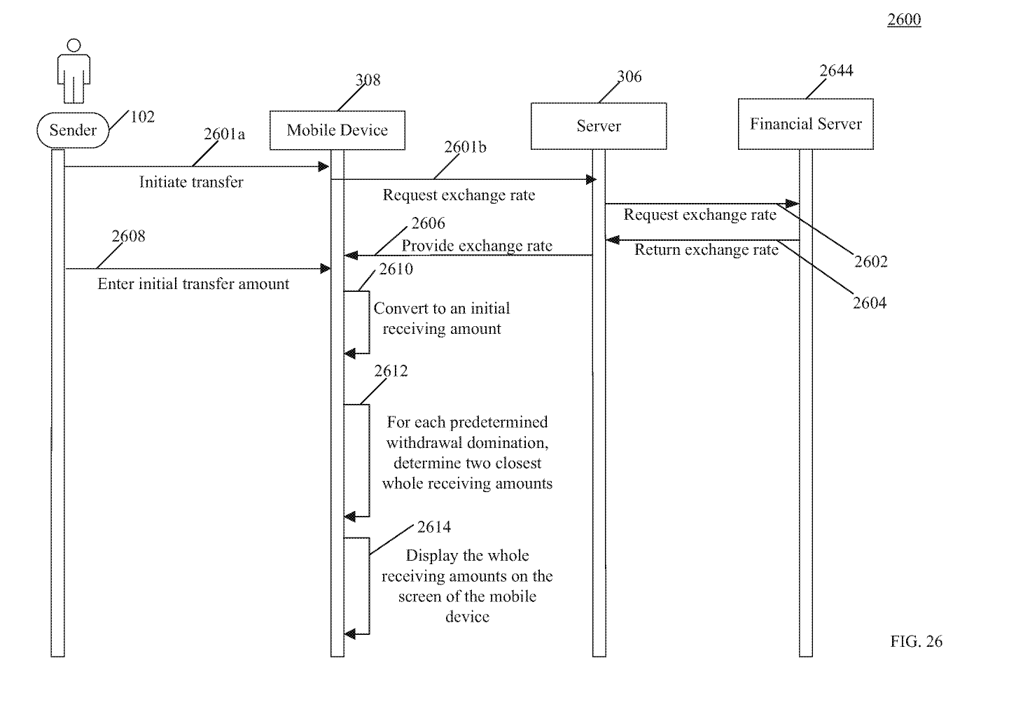

The withdrawal denomination oriented transfer amount adjustment is further illustrated by reference to FIG. 26. Turning now to FIG. 26, a sequence diagram depicting an example process 2600 for determining the withdrawal denomination oriented transfer amounts (i.e., whole receiving amounts) is shown. At 2601a, a transfer is initiated by the sender 102. For example, the sender 102 indicates a desire on a mobile software application executing on the mobile device 308 to perform a money transfer from the sender 102 to a receiver. At 2601b, the mobile software application executing on the mobile device 308 initiates a request to a server software application running on a MTP funds transfer service server 306. At 2602, the server software application initiates a request for a current exchange rate between two or more predetermined currencies from a financial service server 2644, which can be hosted by a private entity or a governmental entity. In some implementations, the two or more predetermined currencies can be the same currency. For example, if a sender 102 wishes to send money to a receiver in the same country, the predetermined currencies can be the single currency of the country in which the sender is located. In such a case, the exchange rate may be 1:1, or some other exchange rate in the event that the fees to be charged are obtained by altering the exchange rate. At 2604, the server software application receives the exchange rate. At 2606, the exchange rate is provided (for example, as a response to a request) to the mobile software application running on the mobile device 308. At 2608, the sender 102 enters an initial transfer amount, such as $200 in U.S. Dollars. At 2610, the mobile software application converts the initial transfer amount into the second currency, thereby creating the initial receiving amount, based on the retrieved exchange rate.

At 2612, for each predetermined withdrawal denomination (such as fifty and hundred), the mobile software application determines two of the closest whole receiving amounts to the initial receiving amount. The two whole receiving amounts need not be the closest whole receiving amounts in an absolute sense, but are selected from among a group of whole receiving amounts close in amount to the initial receiving amount. For example, a determined whole receiving amount could be based on a requirement and/or preference of a fund-out mechanism such as an ATM, retail store, and/or other fund-out mechanism. As just a few examples, if the initial receiving amount is 2427.3 Mexican Pesos (MXN), the two determined whole receiving amounts may be 2427 and 2428, or 2420 and 2430, or 2400 and 2500, or 2400 and 2440, or some other combination of whole value amounts close to the initial receiving amount. In the example of an ATM or retail store as a fund-out mechanism, two determined whole receiving amounts could be based on the particular dispensed denomination requirement and/or preference of the ATM or retail store (e.g., 50 Peso minimum amount, 100 Peso increment, etc.). In the implementation shown, one receiving amount is higher than the initial receiving amount, while the other one is lower than the initial receiving amount. However, if the initial receiving amount is already a whole receiving amount corresponding to the predetermined withdrawal denomination, such determination is no longer needed. At 2614, the mobile software application displays the whole receiving amounts on the screen of the mobile device 308. The screen 2500 in FIG. 25 is an example screenshot displaying the whole receiving amounts.

In a further implementation, the server software application determines the withdrawal denominations of ATM machines in the physical location of the receiver 104. For example, the server software application retrieves such information from a third party server. The withdrawal denominations are then provided to the mobile software application. In a different implementation, the mobile software application applies a fixed withdrawal denomination, such as hundred.

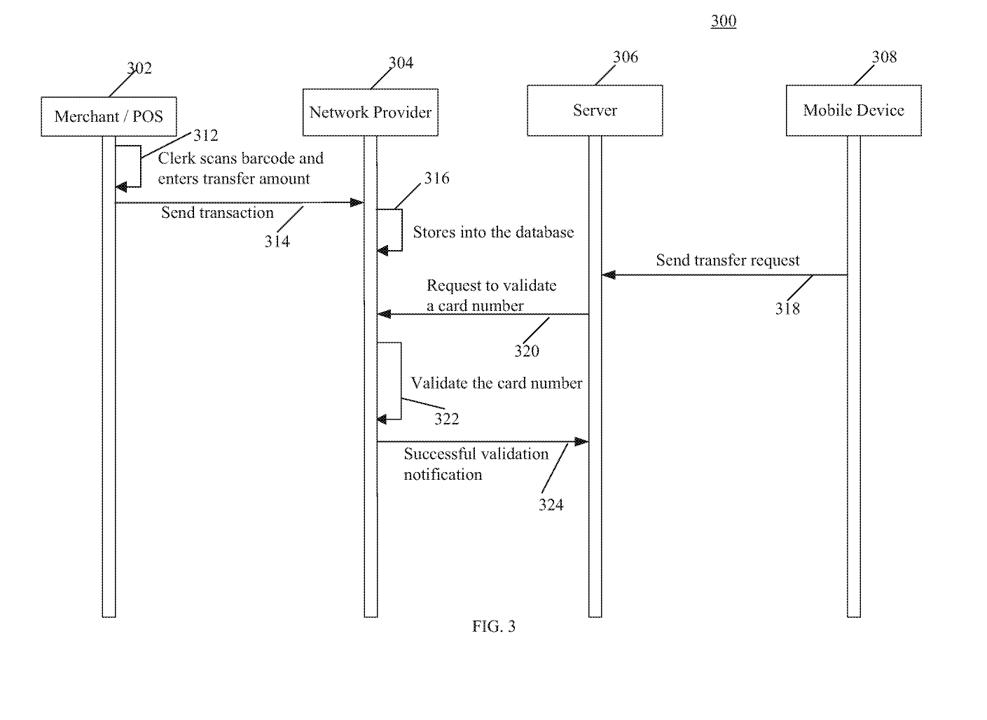

Turning back to the example process shown in FIG. 2, at 208, the mobile software application sends the transaction or transfer information to the server software application over, for example, an HTTPS connection. The transaction includes, for example, the transfer amount, information regarding the fund-in option (such as a money pack number of a barcode), the phone number of the receiver 104, etc. At 210, the server software application validates the transaction. The validation is further illustrated by reference to the example process shown in FIG. 3. FIG. 3 is a sequence diagram depicting a process 300 by which the server software application validates a transfer. When the sender 102 purchases a money pack at the merchant 106, at 312, a clerk therein uses a POS system 302 to scan the barcode of the money pack card and enter the transfer amount.

At 314, the POS system 302 sends the POS transaction to a payment network provider server 304, such as a Blackhawk Network server, supporting the service provided by the network provider 108. At 316, the server 304 validates the transaction and stores it into a database, such as an Oracle database or Microsoft SQL database. The database can be a distributed database. At 318, when the sender 102 enters the number of the money pack card into the mobile software application (screen 2100 of FIG. 21), and requests transfer of the funds, the mobile application sends the transfer request to the server software application running on the server 306. The server 306 is a MTP funds transfer service server.

At 320 of the example process shown in FIG. 3, the server software application sends the money pack number to the payment network provider server 304 for validation. At 322, the payment network provider server 304 validates the money pack number. At 324, the payment network provider server 304 sends a successful validation notification to the server 306. In one implementation, the communication between the servers 304 and 306 is an API (Application Programing Interface) based communication. For example, the APIs provided by the servers 304 and 306 are REST APIs over HTTPS that accept JSON as payloads.

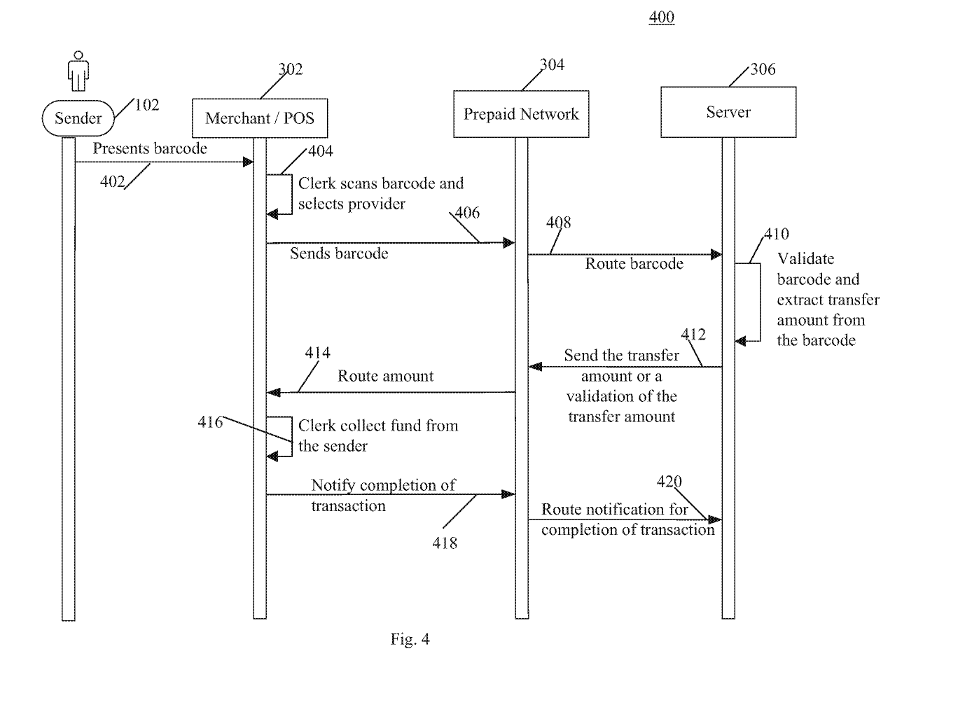

When the sender 102 initiates the transfer by generating a barcode, such as the barcodes shown in FIGS. 23 and 24, a different process 400 (shown in FIG. 4) is used to validate the transaction. Turning to the example process shown in FIG. 4, at 402 the sender 102 presents the barcode 2302 to a clerk at the merchant 106. At 404 the clerk scans the barcode 2302 and enters the transfer amount. At 406 the POS 302 sends the barcode number to the payment network provider server 304 with the entered amount. In one implementation, the barcode is generated with a barcode schema that is agreed upon between the prepaid network partner and the MTP funds transfer service provider. At 408 the payment network provider server 304 determines which provider is handling the funds transfer before routing the barcode to the server 306. At 410 the server software application running on the server 306 validates the barcode, and extracts the transfer identification information contained in the barcode.

At 412, the server software application sends either the transfer amount or a validation of the transfer amount that was entered by the cashier/clerk at the POS to the payment network provider server 304. At 414, the payment network provider server 304 routes the validation response to the POS 302. Routing the transfer also indicates that the barcode has been validated. At 416, the clerk collects funds, such as cash, from the sender 102. When the clerk marks completion of the transaction at the merchant 106, at 418, the POS 302 notifies the server 304 such completion. Subsequently, at 420, the server 304 routes the notification to the server 306. When the sender 102 makes a payment at the merchant 106, the payment network provider partner 304, such as Blackhawk Network, credits the MTP funds transfer service provider with the transfer amount. Periodically, the payment network provider partner 304 and the MTP funds transfer service provider perform settlements. The provider 304 then electronically transfers funds to a bank account (such as the bank account 110) of the MTP funds transfer service provider.

Turning back to the example process shown in FIG. 2, at 212, the server software application generates a termination code, such as a 16-digit code, identifying the funds transfer. At 214, the server software application sends the termination code to the receiver 104 using, for example, a text message. At 216, the server software application generates a hash code from the termination code and stores the hash code and the transaction into the database.

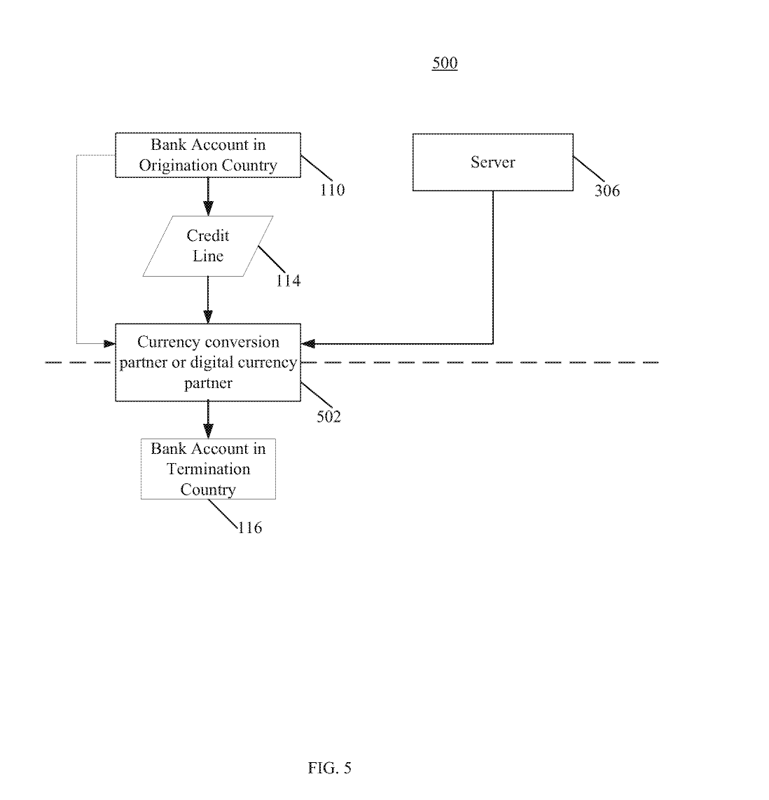

Further in accordance with the example process of FIG. 2, after the transfer has been validated by the server software application, the server software application initiates a process to transfer the funds from the origination country, where the sender 102 resides, to the termination country, where the receiver 104 resides. The cross border transfer process is further illustrated by reference to FIG. 5. In one implementation, the server software application communicates with a foreign currency exchange partner 502, such as Fintrax Group or other foreign currency exchange partner, to transfer and convert the transfer amount from the credit line 114 into the foreign currency. The converted funds are then credited into the bank account 116 in the termination country held by the MTP funds transfer service provider. Alternatively, the foreign currency exchange partner 502 transfers and converts the transfer amount from the bank account 110 into the foreign currency. The converted funds are then credited into the bank account 116.

In a different implementation, the server software application initiates a transfer from the bank account 110 or credit line 114 to the bank account 116 directly. In such a case, the bank where the bank account 116 is held receives the transfer amount in the currency of the origination country, and credits the bank account with an amount in the currency of the termination country. In yet another different implementation, a digital currency partner 502 facilitates the transfer. The server software application initiates a purchase of some amount of digital currency with the transfer amount in the currency of the origination country. The server software application then initiates a sale of the purchased digital currency in the termination country for some amount of receiving funds in the currency of the termination country.

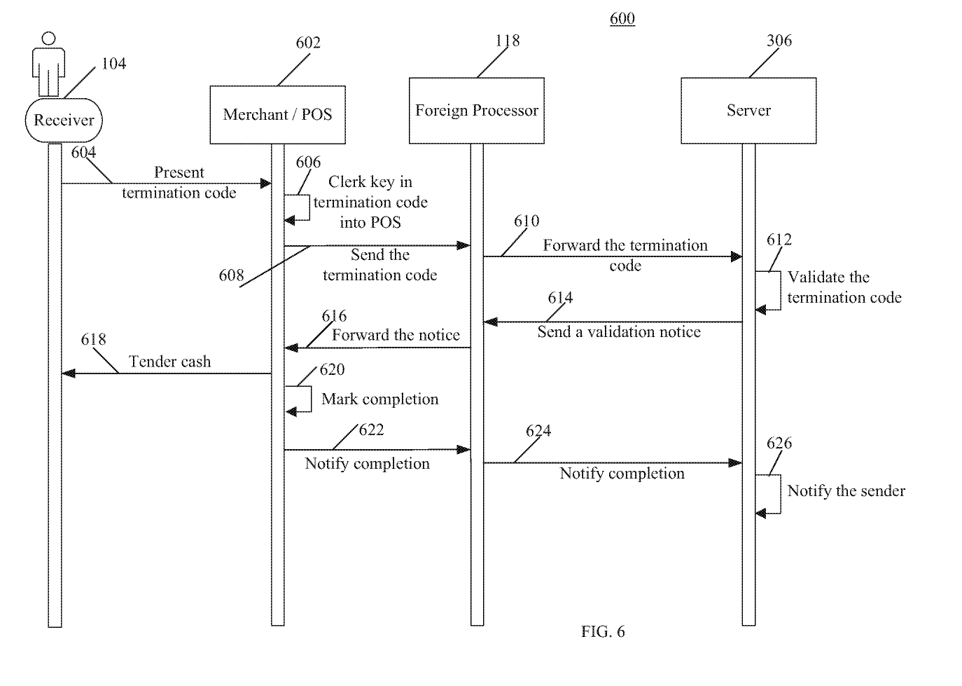

In some implementations, after the receiver 104 receives the termination code, he visits a local retail store or merchant 122 to obtain the transferred funds. This fund-out process is further illustrated by reference to the example process shown in FIG. 6, a sequence diagram illustrating a fund-out process 600. At 604, the receiver 104 presents the termination code sent from the server 306 to a clerk at the merchant or retail store 122. At 606, the clerk keys in the termination code into a POS 602. Alternatively, the termination code is a barcode that is scanned by barcode scanner. At 608, the POS sends the termination code to a server of the foreign processor 118. At 610, the server 118 forwards the termination code to the server 306. Responsively, at 612, the server software application running on the server 306 validates the termination code.

In some implementations, the termination code is hashed using an algorithm, such as HMAC-SHA256, to generate a hash code. This hash code is then compared to the hash code generated at 216. Where a match is made, the termination code is validated. Accordingly, at 614, the server software application sends a validation notice to the server 118. At 616, the server 118 forwards the notice to the POS 602. At 618, the clerk then tenders cash (i.e., receiving fund) to the receiver 104. At 620, the clerk marks the completion of the transaction at the merchant 106 in the POS 602. At 622, the POS 602 notifies the server 118 that the transaction has completed. At 624, the server 118 notifies the server 306 of the completion. At 626, the server software application notifies the sender 102 of the completion of the transaction using, for example, an Email, text message, push notification, proprietary application message, phone call, etc. Additionally, at 626, the server software application logs the completion status and other transaction information into the database.

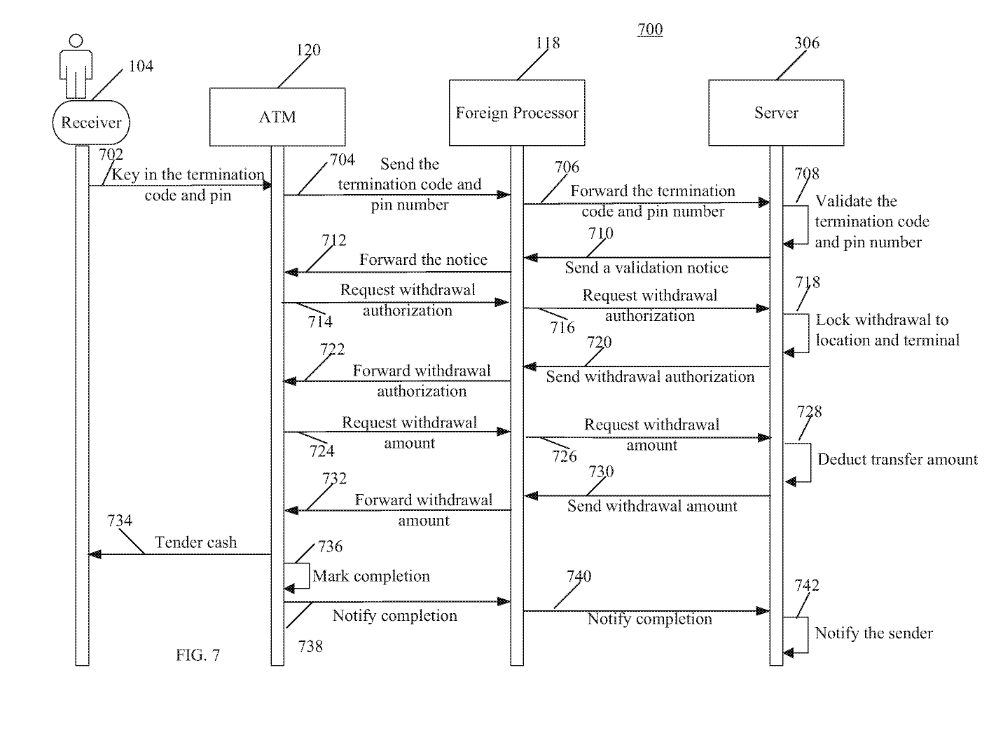

Alternatively, the receiver 104 accesses an ATM 120 to withdraw the transferred funds. A sequence diagram illustrating an example ATM-based fund-out option is shown at 700 in FIG. 7. At 702, the receiver 104 keys in the termination code into the ATM 120. In a further implementation, the server software application receives a personal identification number (“pin number”) (such as a 4-digit number) from the mobile software application when the sender 102 initiates the funds transfer. The server software application stores the pin number or a hash pin derived from the pin number into the database when it stores the hash code derived from the termination code. The pin number can be entered using a screen, such as the screen 2100, with an additional input field. Moreover, the pin number is sent directly by the sender 102 to the receiver 104 using, for example, a text message. In some implementations, when the receiver 104 withdraws the funds, he keys in the pin number as well. In such a case, at 702, the receiver 104 enters the pin number as well.

At 704 of FIG. 7, the ATM 120 sends the termination code and the pin number (if it is entered at 702) to the server 118. At 706, the server 118 forwards the termination code and the pin number (if it is entered at 702) to the server 306. Responsively, at 708, the server software application running on the server 306 validates the termination code. Where a match is made, the termination code is successfully validated. When the pin number is available, at 708, the server software application further checks to determine whether the stored pin number matches the pin number entered by the receiver 104 as well. It should be noted that the process 600 may verify the pin number as well, when it is present.

Accordingly, at 710 of the example process shown in FIG. 7, the server software application sends a successful validation notice to the server 118. At 712, the server 118 forwards the notice to the ATM 120. At 714, the ATM 120 requests withdrawal authorization. At 716, the server 118 forwards the withdrawal authorization request to the server 306. At 718, the server software application grants withdrawal authorization and locks the authorization to the specific location and terminal identifier of the ATM 120. At 720, the server software application sends the withdrawal authorization to the server 118. At 722, the server 118 forwards the authorization to the ATM 120. At 724, the ATM 120 requests the withdrawal amount from the server 118. At 726, the server 118 forwards the request to the server 306. At 728, the server software application authorizes the withdrawal and the withdrawal amount. Additionally, at 728, the server software application deducts the transfer amount from the sender's 102 account.

At 730, the server software application sends the withdrawal amount to the server 118. At 732, the server 118 forwards the amount to the ATM 120. At 734, the ATM 120 tenders cash (i.e., receiving funds) to the receiver 104. At 736, the ATM 120 marks the completion of the transaction. At 738, the ATM 120 notifies the server 118 that the transaction has completed. At 740, the server 118 notifies the server 306 of the completion. At 742, the server software application notifies the sender 102 of the completion of the transaction using, for example, an Email, text message, push notification, proprietary application message, phone call, etc. Additionally, the server software application logs the completion status and other transaction information into the database. It should be noted that a further implementation of the process 600 performs the steps 714 through 732 as well.

In a different implementation, the receiver 104 loads the transferred funds into a mobile money account, which is associated with the receiver's 104 phone number. The phone number can be provided to the server 306 when the receiver 104 attempts to cash out the funds transfer using, for example, a mobile software application.

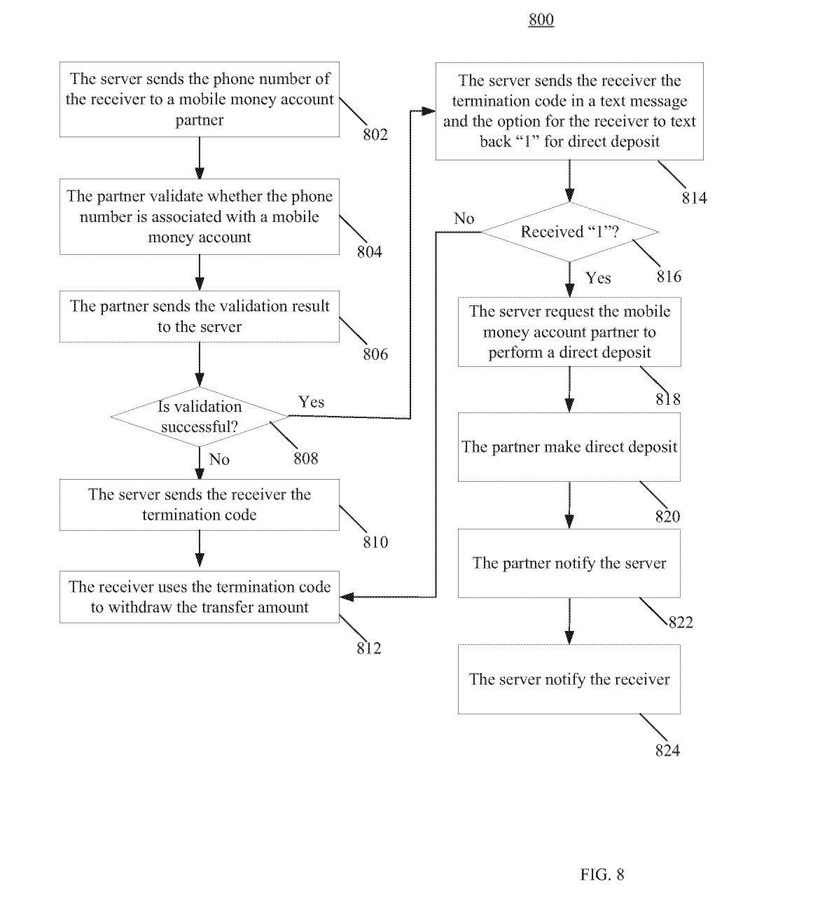

The fund-out option using the mobile money account is further illustrated at 800 in the example process shown in FIG. 8. At 802, the server software application running on the server 306 sends the phone number of the receiver 104 to a mobile money account partner. At 804, the partner validates whether the phone number is associated with a mobile money account. At 806, the partner sends the validation result to the server 306. At 808, the server software application determines whether the validation is successful or not. If no, at 810, the server software application sends the termination code to the receiver 104. At 812, the receiver 104 uses the termination code to withdraw the transferred funds. For example, the process 600 or 700 is performed for the receiver 104 to acquire the transferred funds.

Turning back to 808 of the example process shown in FIG. 8, if the validation is successful, at 814, the server software application sends the receiver 104 the termination code in a text message. Additionally, the text message provides an option for the receiver 104 to text back a single character or numeral, such as “1,” for direct deposit. At 816, the server software application determines whether the character “1” has been received. If not, the server software application does not initiate a direct deposit. The receiver 104 has the option to withdraw the transferred funds from a retail store or ATM. If the server software application receives the character “1,” at 818, the server software application requests that the mobile money account partner perform a direct deposit. Accordingly, at 820, the transferred funds are transferred from the bank account 116 to the mobile money account held with the partner for the receiver 104. At 822, the partner notifies the server 306 that the direct deposit has been performed. At 824, the server software application notifies the receiver 104 that the direct deposit has been performed using, for example, an Email, text message, phone call, etc.

In a further implementation, the mobile software application provides a list of fund-in options. The sender 102 selects his desired fund-in option. When the sender 102 selects self-service cash kiosk as the fund-in option, he deposits the transfer amount after he initiates the transfer using the mobile software application. The kiosk communicates with a payment network provider, such as the provider 304, to complete the funds transfer. When the selected fund-in option is a mobile wallet, the sender 102 enters his mobile wallet login information in the mobile software application, selects a payment method from the mobile wallet, and the transfer amount. The server 306 then communicates with the mobile wallet provider to conduct funds transfer.

When the sender 102 selects digital currency as the fund-in option, he further selects a specific digital currency. The sender 102 enters his login credentials to the selected digital currency in the mobile software application. The server software application then purchases the digital currency, and sends the funds to the receiver 104. A different fund-in option is a bank account. In this case, the sender 102 enters his bank routing number and bank account number for the server software application to complete the funds transfer. Similarly, the sender 102 can select credit card as his fund-in option. In a further implementation, the sender 102 can select remote deposit capture as his fund-in option. For example, the sender 102 uses the mobile device 308 to scan a signed check. The check image is sent to the server software application, which communicates with the corresponding bank to withdraw the transfer fund. Additional fund-in options are gift card, stored credit card, and reward program. The reward program allows the sender 102 to load rewards or points as credit for funds transfer.

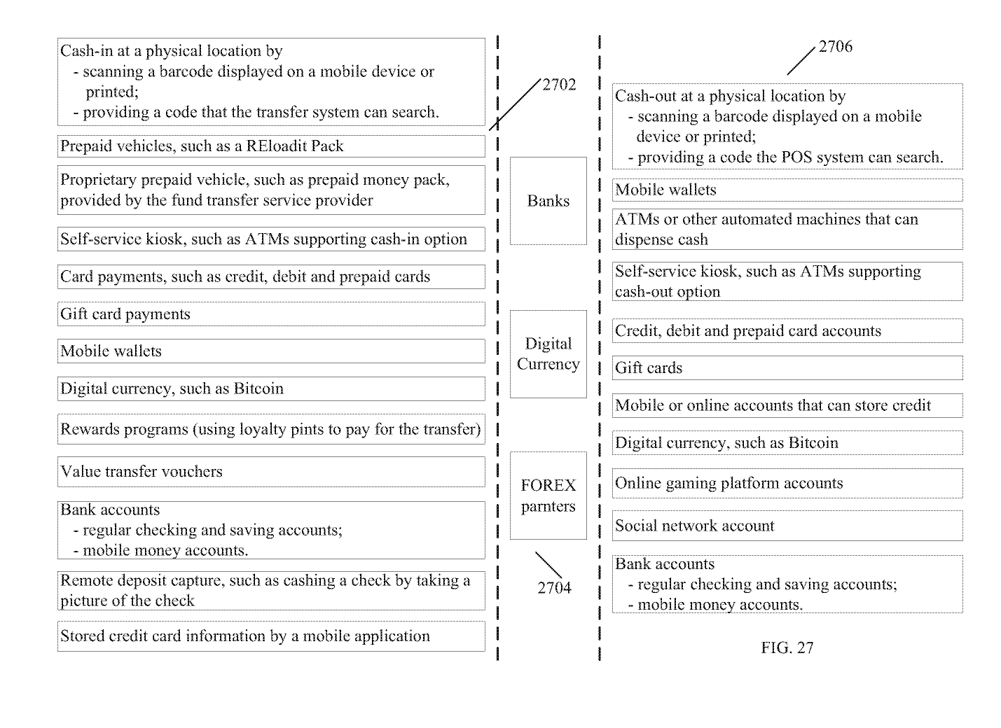

Similarly, various fund-out options are supported. For example, the receiver 104 can select a bank account, mobile wallet, credit card, debit card, prepaid card, bill payment, online gaming account or social network account. The fund-in and fund-out options are further illustrated by reference to FIG. 27. Turning now to FIG. 27, example fund-in options supported by the international MTP fund transfer service are indicated at 2702, while example supported fund-out options are indicated at 2706. A plurality of currency conversion systems are indicated at 2706.

Money transfer demands a high level of consideration for security and regulatory compliance. In some implementations, the identities of the sender 102 and receiver 104 are checked with Office of Foreign Assets Control (OFAC) list to determine whether the funds transfer between the sender 102 and the receiver 104 should be allowed or not. Depending on the accuracy rate returned from the OFAC checking, additional checking may be performed. For example, the server software application may communicate with a third party security service (such as Idology and/or other security service) to conduct an additional security check. Additionally, the server software application may conduct funds transfer velocity controls. A velocity control check determines whether the sender 102 and/or receiver 104 have reached a limit of funds transfer during a fixed period of time, such as a day, week, month, etc. Additionally, the server software application can detect suspicious activities by establishing a baseline behavior by senders and receivers. The baseline behavior considers factors, for example, daily, weekly, monthly averages and/or sums, transfer frequencies, transfer locations, etc. The baseline behavior is then referenced to establish deviations to detect suspicious activities.

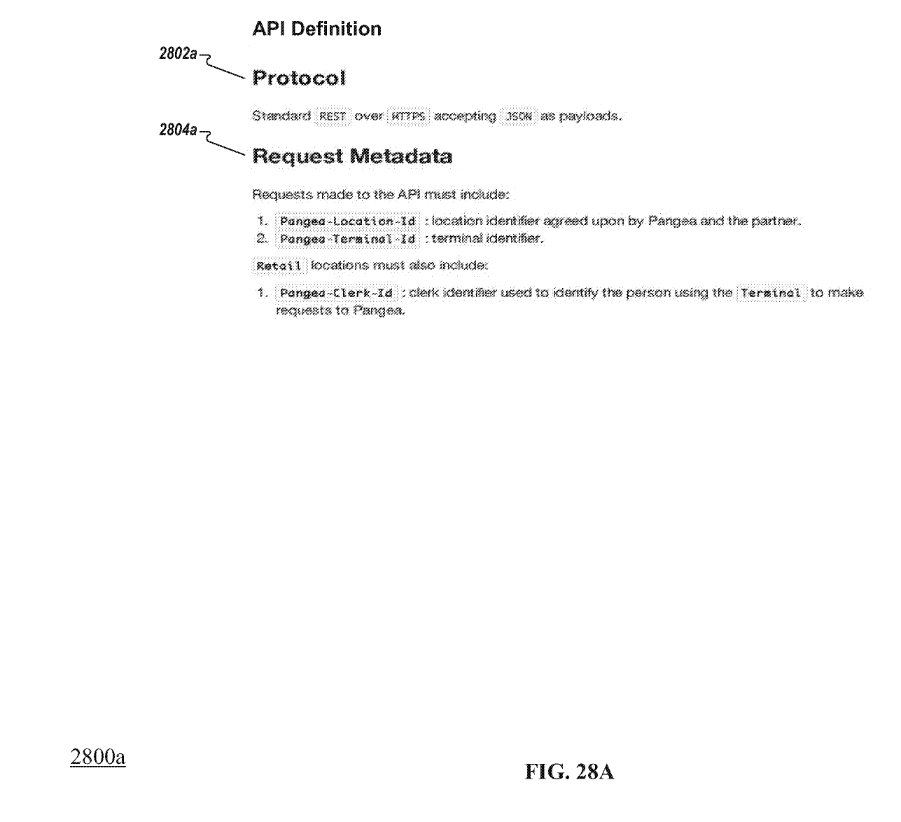

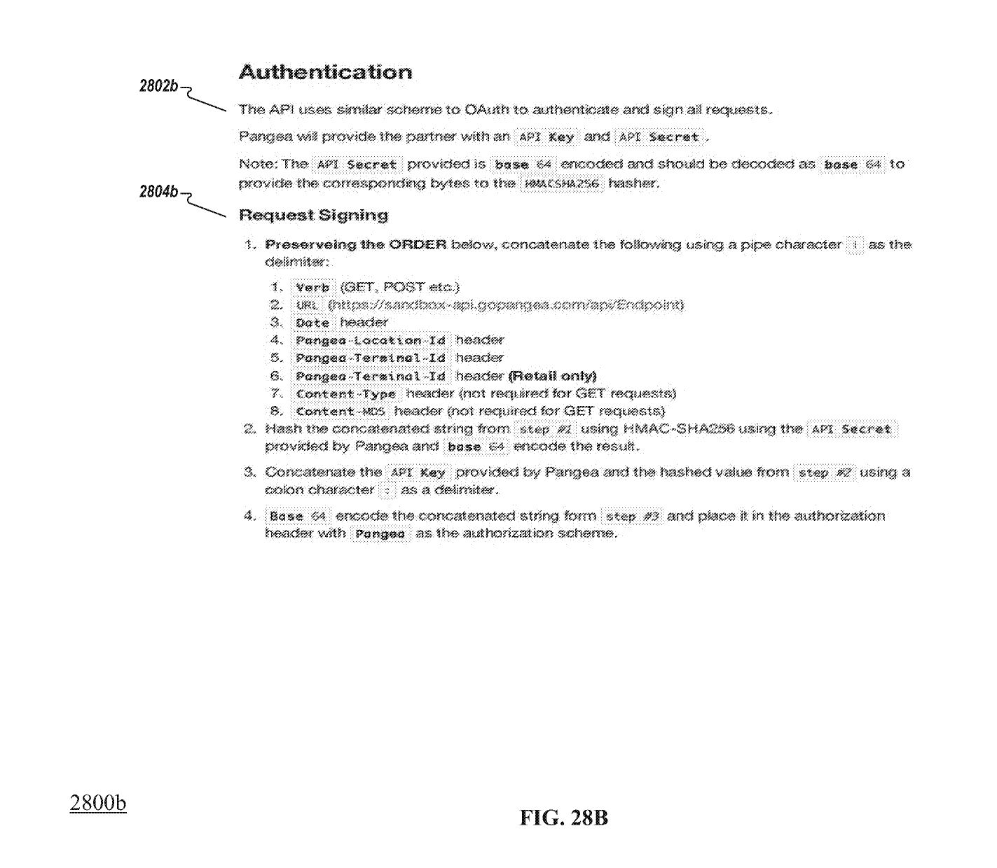

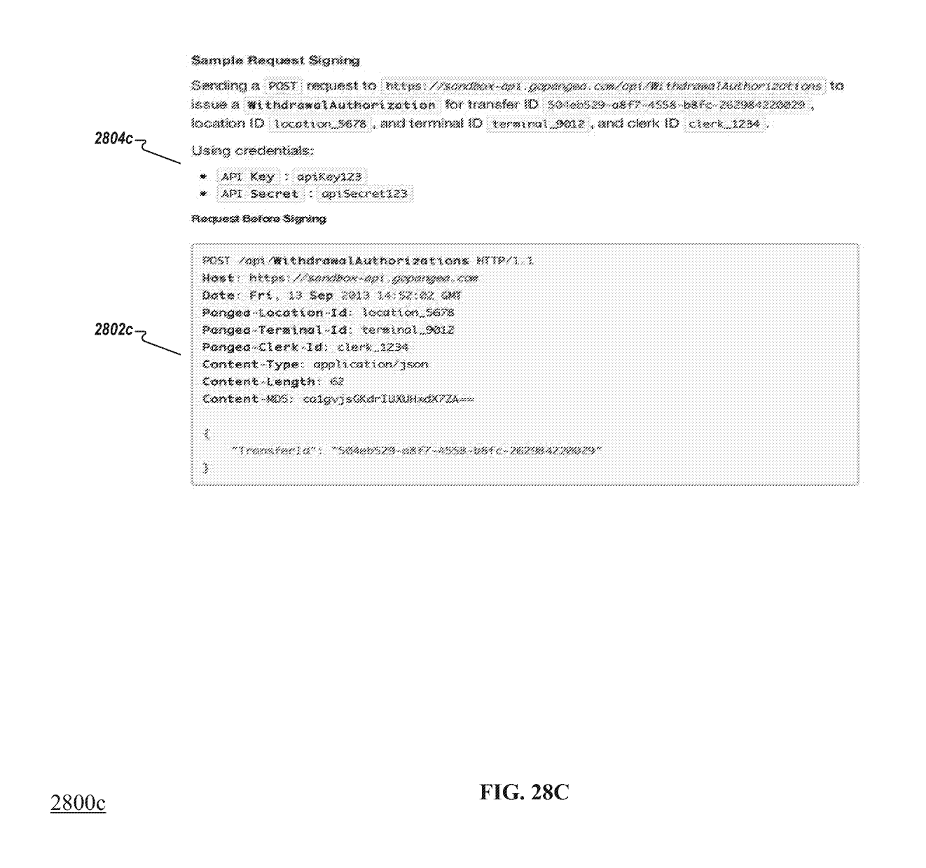

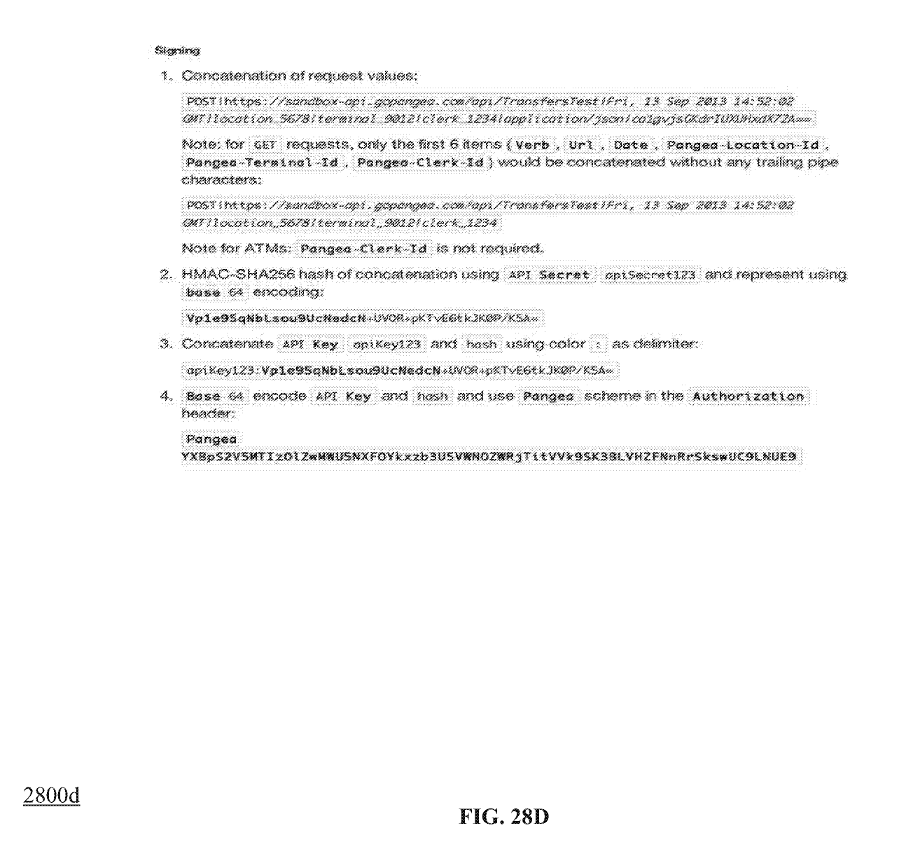

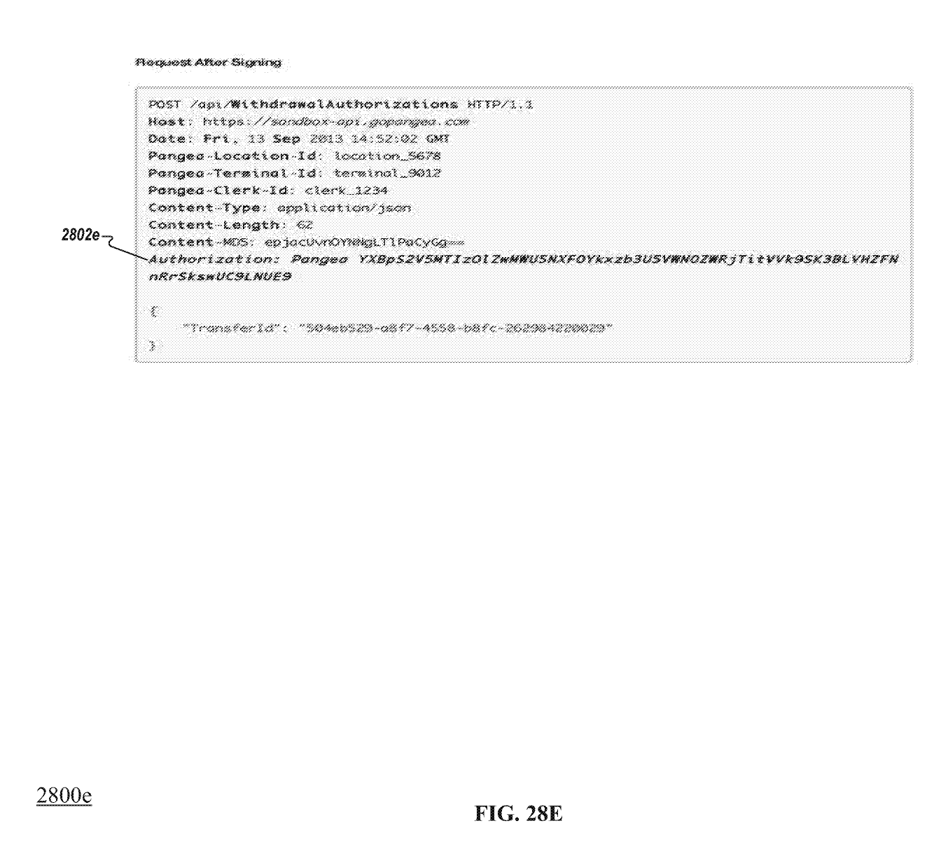

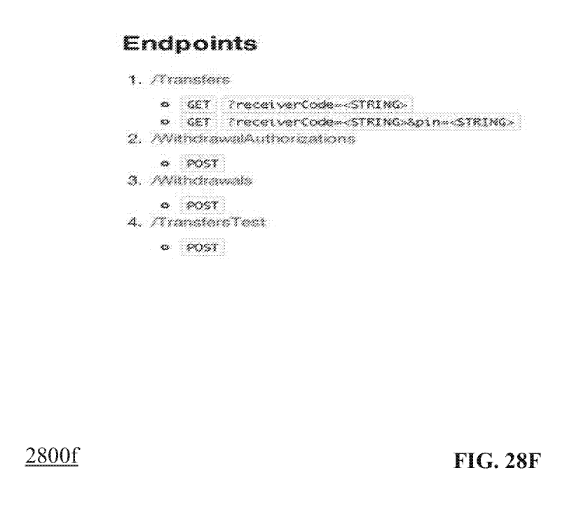

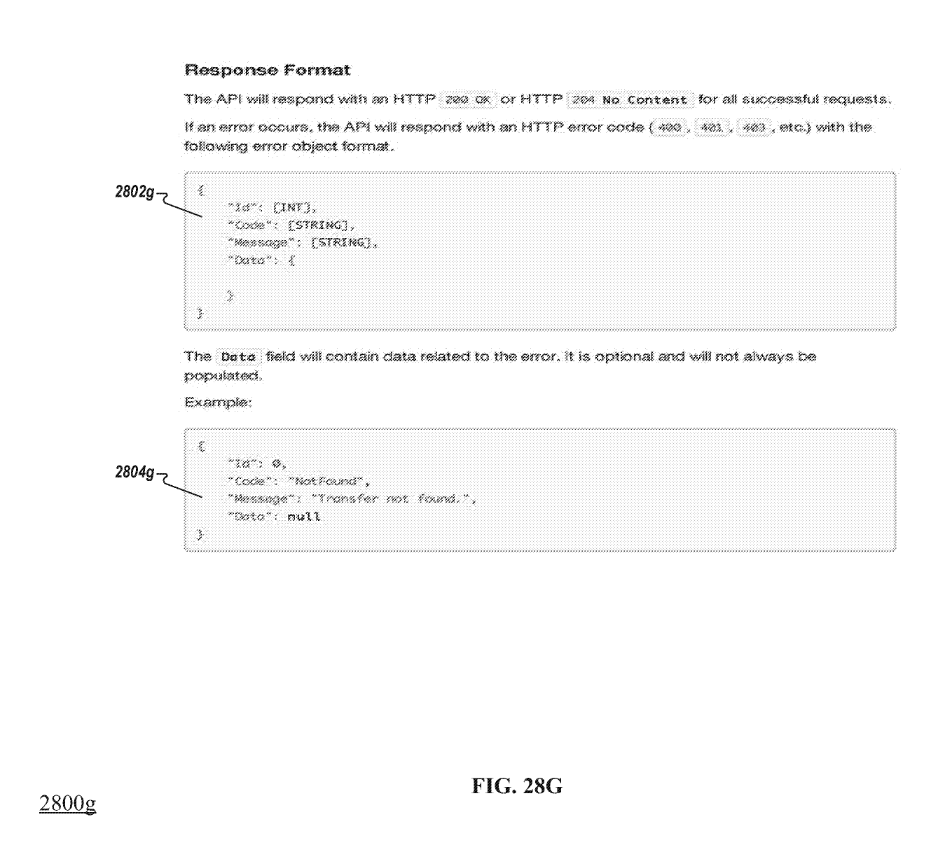

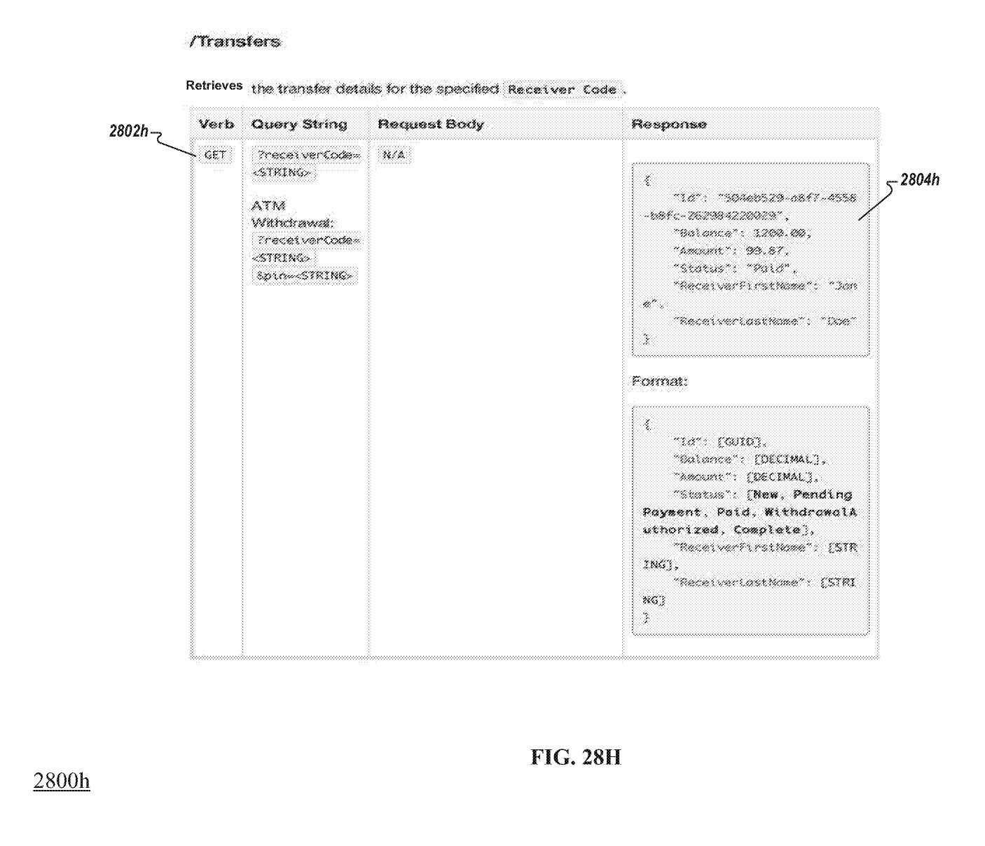

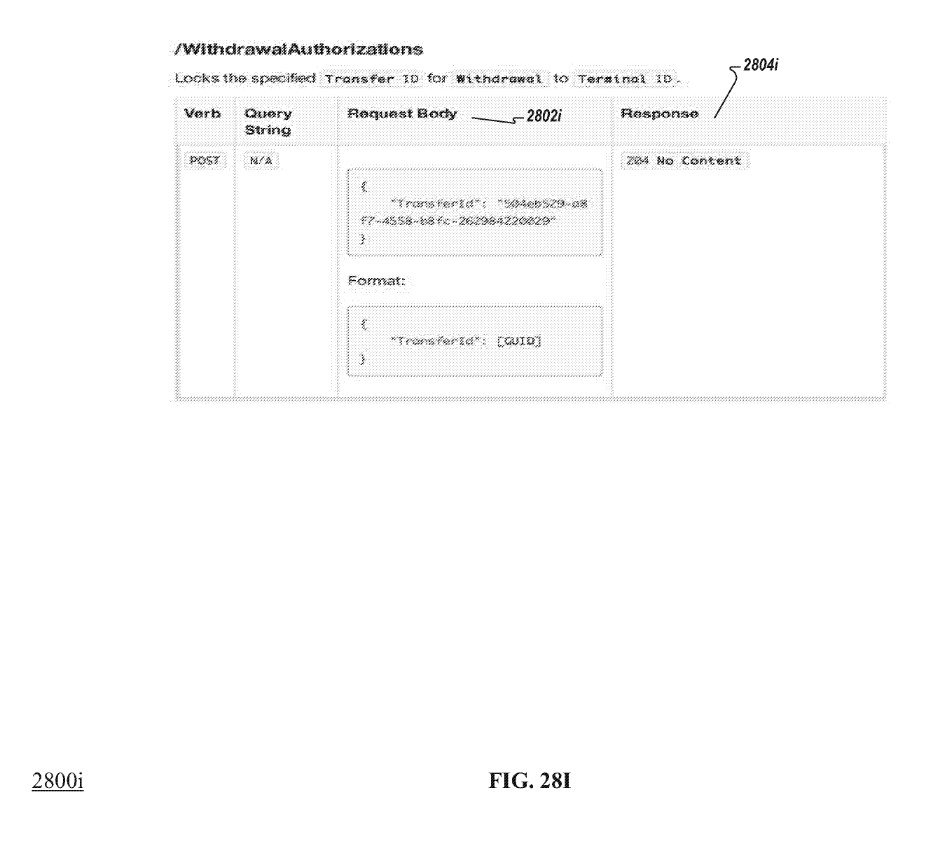

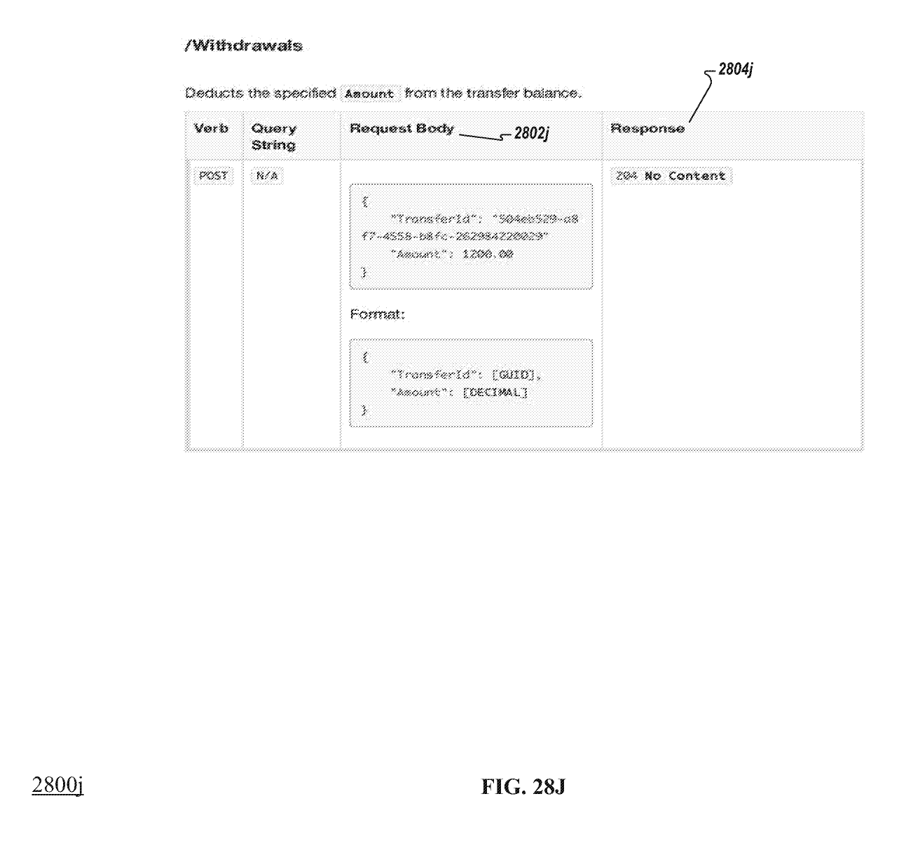

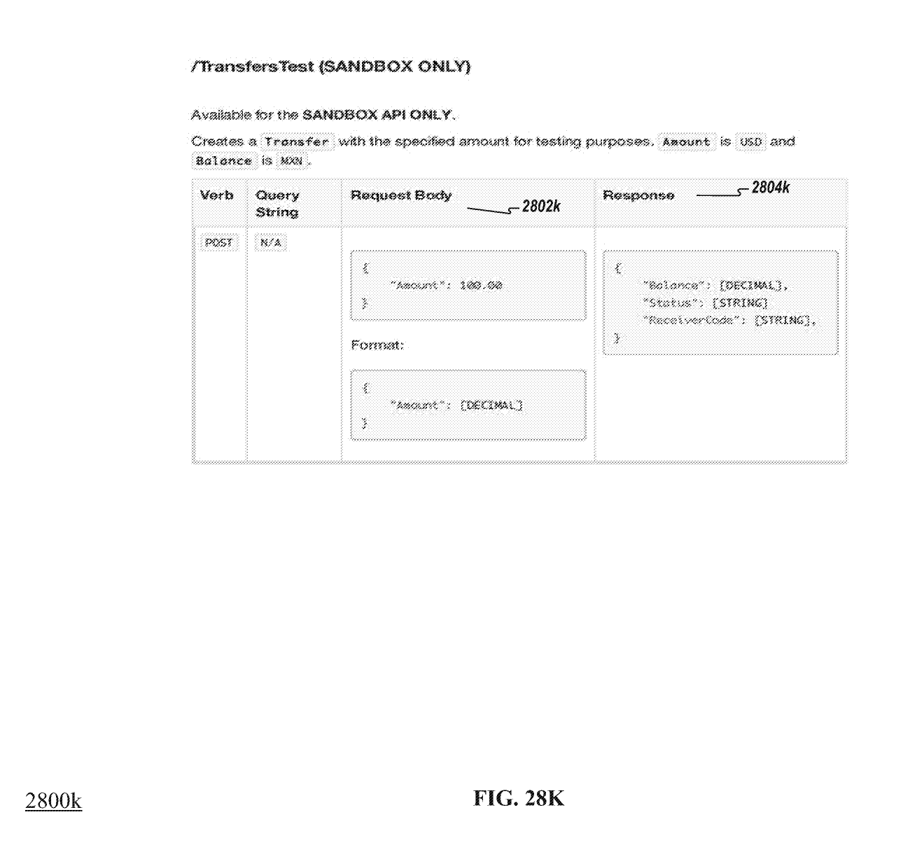

The server software application provides a set of APIs for communication with partners, the mobile software application, and/or other elements of the system(s) disclosed in this disclosure. In some implementations, the communication APIs can resemble those illustrated in FIGS. 28A-28K. As will be appreciated by those of ordinary skill in the art, the examples provided in 28A-28K represent one possible implementation/use of APIs. Other protocols, standards, data types/structures, and/or usages can also be used depending upon the particular needs and desires of the methods and systems described in this disclosure. Other protocols, standards, and data types/structures, and/or usages are also considered to be within the scope of this disclosure.

FIG. 28A illustrates an example 2800a of an API definition. The API definition includes a protocol 2802a. In some implementations, the standard protocol is standard representational state transfer (REST) over hypertext transfer protocol/secure (HTTPS) accepting JAVASCRIPT object notation (JSON) as payloads. Requesting metadata 2804a includes requirements of what data is required to make requests to an API. For example, a terminal identifier can be required to be included for requests made to the API, and for retail locations, a clerk identifier can be required to be included to identify a person using a terminal to make requests to the MTP network provider.

FIG. 28B illustrates an example 2800b of an API authentication. For example, in some implementations, the API can use a scheme 2802b similar to OAUTH to authenticate and sign all requests. A method of request signing 2804b can, in some implementations, be performed as illustrated. In some implementations, various steps of method 2804b can be run in parallel, in combination, in loops, or in any order.

FIG. 28C illustrates an example 2800c of an example request signing. 2802c illustrates an example of a request without signing. In some implementations, credentials 2804c, such as API key and API secret (as described in FIG. 28B) can be used to sign a request.

FIG. 28D illustrates an example method 2800d of signing a request. In some implementations, various steps of method 2800d can be run in parallel, in combination, in loops, or in any order.

FIG. 28E illustrates an example 2800e of a request after signing. For example, the request contains authorization value 2802e.

FIG. 28F illustrates an example 2800f of endpoints. In some implementations, the endpoints are used by cash-out partners in a recipient/termination country/location. In some implementations, endpoints similar to those illustrated in FIG. 28F are used in FIGS. 6 and/or 7. For example, 608/704—“GetTransfers” endpoint, used to retrieve a transfer from the transfer identifier when the receiver goes to cash out a transfer; 620/714 (which goes all the way to the server similar to 714)—“WithdrawalAuthorizations” endpoint, used to lock a transfer while the transfer is in the process of cashing out; 622/738—Withdrawal endpoint, used to mark a transfer complete and notify the sender that the transfer has been received.

FIG. 28G illustrates an example 2800g of a response format. The illustrated example 2802g shows an example HTTP error code object format. In some implementations, the data field 2804g can contain data related to the error. In other implementations, the data field is optional.

FIG. 28H illustrates an example 2800h of a /transfer. A /transfer retrieves transfer details for a specified receiver code. For example, for a HTTP GET command with a “receiverCode” value, the response, in some implementations, can resemble that of 2804h.

FIG. 28I illustrates an example 2800i of a withdrawal authorization. In some implementations, the “/withdrawalAuthorizations” request locks a specified transfer ID value for a withdrawal for a specified terminal ID. 2802i is an example of a request body for a /withdrawal authorization in some implementations. In some implementations, 2804i is an example of a response to the request body of 2802i.

FIG. 28J illustrates an example 2800j of a withdrawal definition. In some implementations, the “/withdrawal” request deducts a specified amount from a transfer balance. 2802j is an example of a request body for a /withdrawal in some implementations. In some implementations, 2804j is an example of a response to the request body of 2802j.

FIG. 28K illustrates an example 2800k of a transfer test definition. In some implementations, the “/TransfersTest” request (available in a “sandbox” type test environment only) creates a transfer with a specified type amount for testing purposes. In the example 2800k, amount is in USD (e.g., dollars) and balance is in MXN (e.g., Pesos). 2802k is an example of a request body for a “/TransfersTest” in some implementations. In some implementations, 2804k is an example of a response to the request body of 2802k.

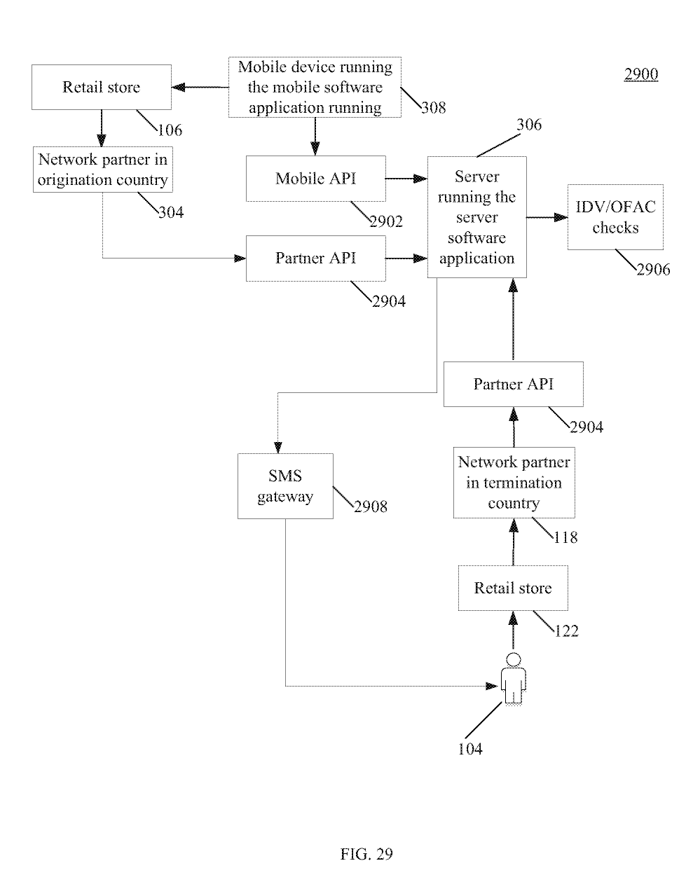

FIG. 29 is an example flowchart 2900 illustrating example communications within a MTP funds transfer system. The mobile software application running on the mobile device 308 communicates with the server software application running on the server 306 using a set of mobile APIs 2902 supported by the server 306. The server 304 communicates with the server 306 using a set of partner APIs 2904 supported by the server 306. The server 118 also uses the set of partner APIs 2904 to communicate with the server 306. OFAC checks and IDV (“ID Verification”) checks are performed at 2906. A short message service (SMS) gateway 2908 is used by the server 306 to send text messages to the receiver 104.

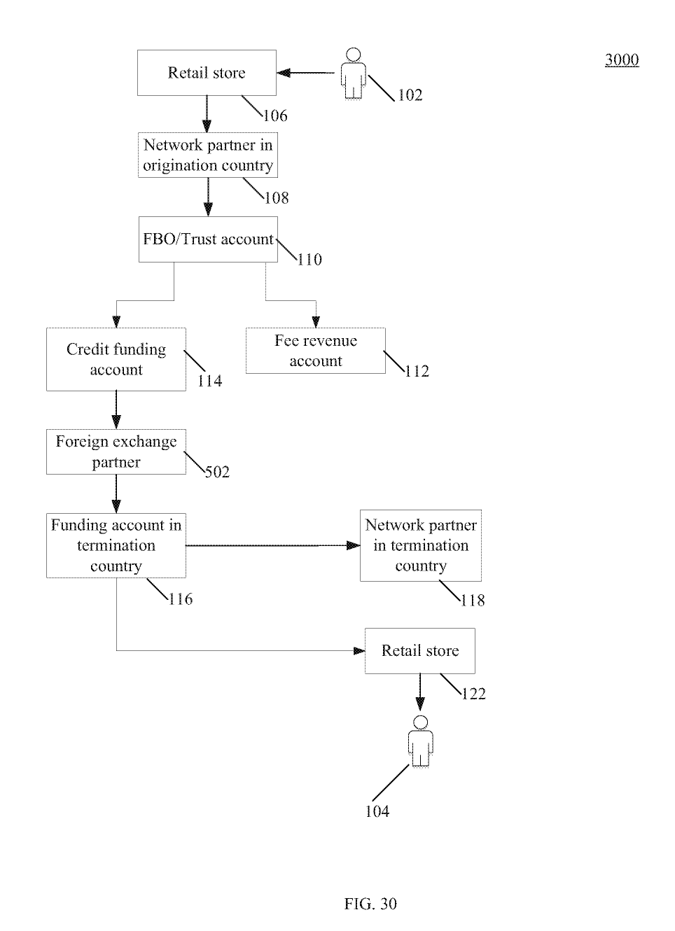

FIG. 30 is an example flowchart diagram 3000 showing a high-level example funds flow from a sender 102 to a receiver 104. At 106, money is received by the retail store as a payment for the transfer from the sender 102. At 108, the received money is settled with a network partner. At 110, the network partner settles with the MTP when a funds pack is redeemed/barcode is scanned and paid for in retail and funds have settled. At 112, the MTP's portion of a fee charged on funds packs is delivered on a separate schedule to a different account. At 114, when funds have settled, the funds are used to replenish a pre-funding credit account that has already funded an account in the destination country through the foreign exchange partner (F/X) provider. At 502, when the transfer is funded (e.g., a reload pack is redeemed and/or a barcode is paid for in retail), at a certain point in a day, the MTP creates a transaction with the F/X for all transfer amounts made aggregated, funded from the credit line. At 116, the account is used to receive transfers from the F/X partner and to pay cash-out and network partners in the destination country. At 118, the network partner routes requests to and from retail stores in the destination country to the MTP. At 122, retail stores accept receiver codes from receivers in the destination country and pay out the transfer amounts.

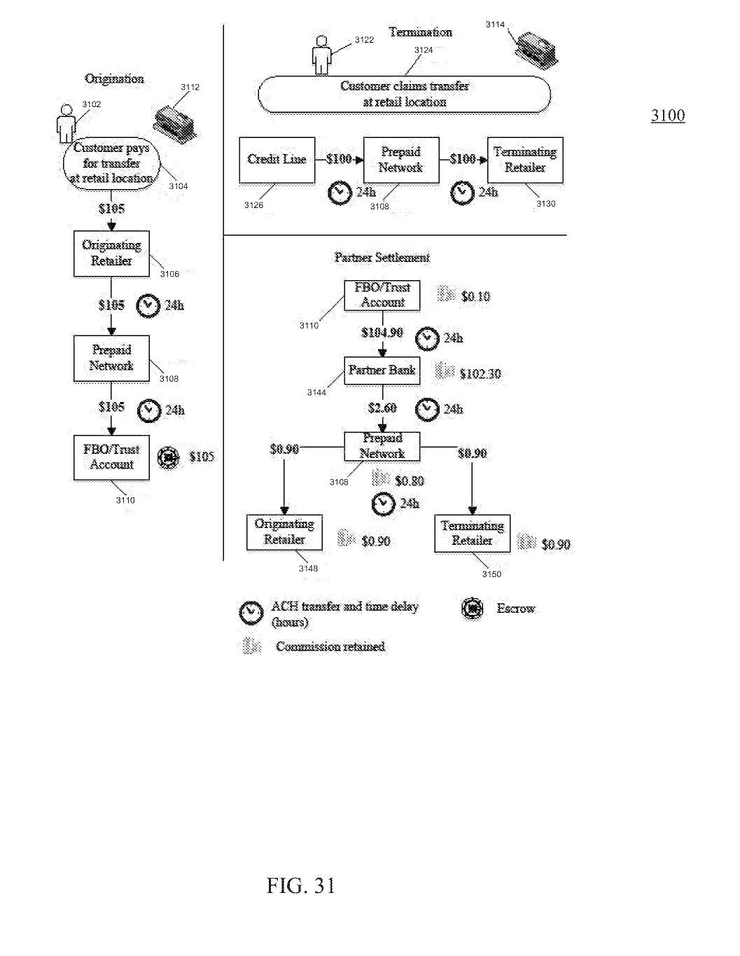

FIG. 31 is an example fund flow diagram depicting an example MTP fund transfer 3100 from one retail location to another retail location. In the illustrative implementation, $105 is transferred using a MTP fund transfer system. A sender 3102 visits a retail location 3112, such as a 7-Eleven retail store, and pays $105 to a clerk at the retail location 3112. At 3106, the retailer 3112 originates the MTP transfer by transferring the $105 to the underlying prepaid network 3108, such as Blackhawk Network. The prepaid network 3108 generally maintains a plurality of servers and databases to enable and facilitate transactions with numerous retail locations. Each retail location 3112 operates one or more POS devices to communicate with the servers to carry out transactions.

The prepaid network 3108 then sends the fund to a FBO or trust account for the fund. After a receiver 3122 for the fund receives a notice of the fund transfer and availability of the fund, she claims the transferred fund at a retail location 3114. The claiming process is shown at 3126, 3108, and/or 3130. At 3126, the receiver 3122 claims her fund of $100. The prepaid network 3108 authorizes the retail location 3114 to disburse $100 to the receiver 3122. At 3130, the retail location 3130 disburses $100 to the receiver 3122.

In this example, since the sender 3102 pays $105 and the receiver 3122 receives $100, the difference in the amount of $5 is paid to various partners as a fee. The FBO/Trust account partner receives a fee of, for example, $0.10. A partner bank receives $102.30, $2.30 of which is a fee for the sender 3102 and the receiver 3122 to use the MTP transfer system. The partner bank 3144 further credits the prepaid network with a fee of $2.60. At 3148 and 3150, the retailers 3112 and 3114 each receive, or are credited with, a fee of $0.90 respectively.

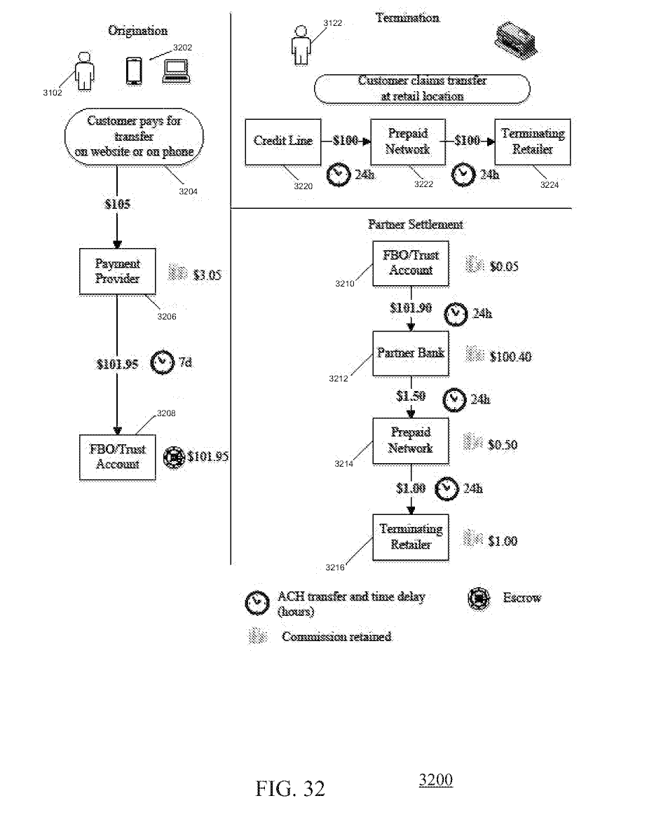

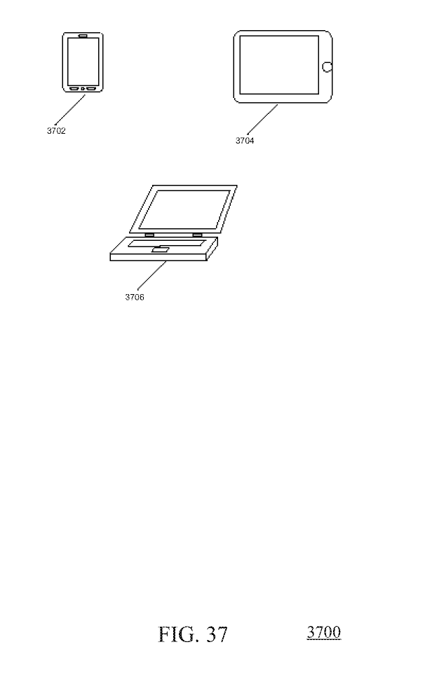

FIG. 32 illustrates a flow diagram depicting a different example of a MTP transfer process 3200 that is originated by the sender 3102 using a computer 3202, which can be one of the devices pictured in FIG. 37. While FIG. 37 illustrates examples 3700 of mobile devices, such as a smart phone 3702, table computer 3704, and laptop computer 3706, any computing device can be used to initiate the described MTP transfer process. At 3204, through a website or on a mobile phone, the sender 3102 pays $105 using her credit card. At 3206, a payment provider, implementing a MTP transfer system and method, receives a fee of $3.05. At 3110, a FBO/trust account providers receives $101.95. During the partner settlement process, at the 3210, FBO/trust account provider receives a fee of $0.05. At 3212, the partner bank receives $100.40, $0.40 of which is a fee. At 3214, the prepaid network receives a fee of $0.50. At 3216, the terminating retailer, where the receiver 3122 receives the transferred fund from, receives a fee of $1.00.

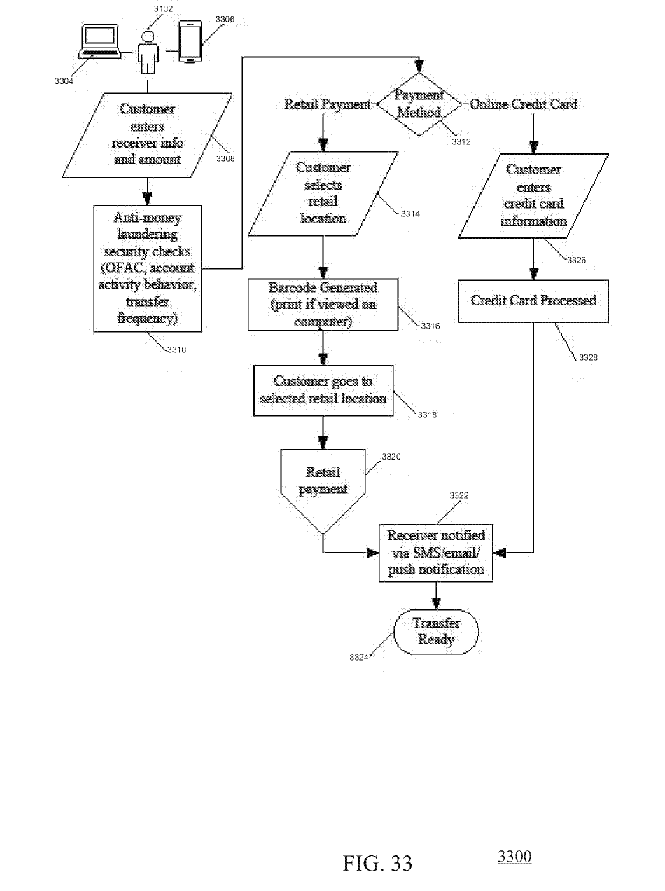

FIG. 33 is an example flow chart depicting an example process 3300 by which an example MTP fund transfer is originated using a web interface or a retail store. The sender 3102 uses a computer 3304 or mobile device 3306 to originate the MTP fund transfer. At 3308, the sender 3102 enters information of the receiver 3122. At 3310, one or more security checks (such as OFAC, account activity behavior, transfer frequency, etc.) are performed to validate the transfer request. At 3312, a payment method is determined. If the sender 3102 pays the fund at a retail store, at 3314, the sender 3102 selects a retail location. At 3316, a barcode, such as a Universal Product Code (UPC) or other code is generated. The barcode indicates the receiver 3122, the originating retail location, etc. At 3318, the sender 3102 visits the selected retail store to pay for the transfer and has the barcode scanned. At 3320, the payment is processed. At 3322, the sender 3102 receives a notification, such as an email message, a text message, a push notification, etc., indicating the fund has been sent to the receiver 3122 successfully. Where the sender 3102 funds the transfer by a credit card payment, at 3326, the sender 3102 enters the credit card information and/or other information. At 3328, the credit card payment is processed.

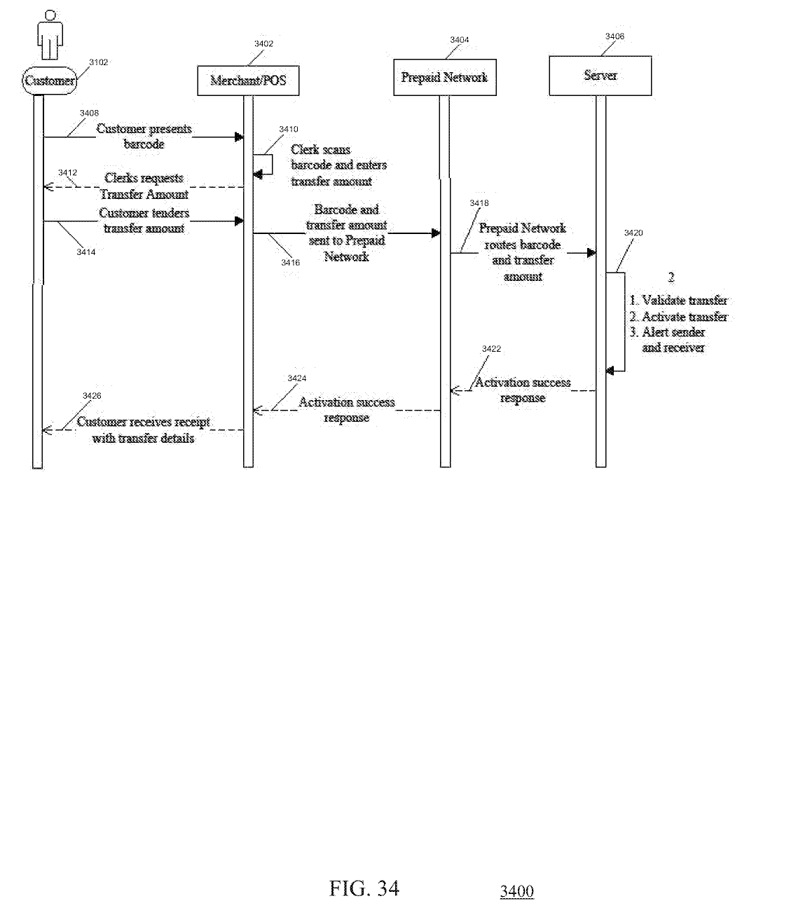

The payment process 3320 is further illustrated by reference to FIG. 34. FIG. 34 is an example sequence diagram depicting an example process 3400 by which an example MTP fund transfer is originated. At 3408, the sender 3102 presents the barcode to be scanned at a retail location operating a POS 3402. At 3410, a clerk scans the barcode and enters the transfer amount. At 3412, a clerk requests the funds from the sender 3102. At 3414, the sender 3102 tenders the funds. At 3416, the POS 3402 sends barcode and the transfer amount to a prepaid network server 3404. At 3418, the server 3404 routes the barcode and transfer amount to a server 3406 of a MTP transfer system. At 3420, the server 3406 validates the transfer, activates the transfer and alerts the sender 3102 and the receiver 3122 of transfer statuses. At 3422, the server 3406 notifies the server 3404 of the successful activation of transfer. At 3424, the server 3404 notifies the POS 3402 of the successful activation of transfer. At 3426, the POS 3402 prints or shows a receipt of the transfer for the sender 3102.

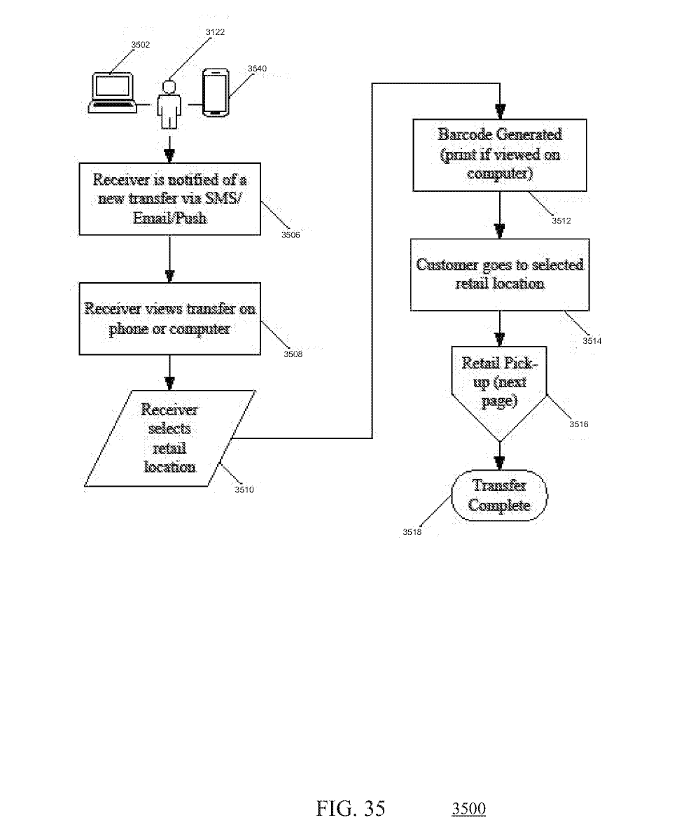

FIG. 35 is a flow chart illustrating an exemplary fund pickup process 3500 is shown. At 3506, the receiver 3122, using a computer 3502 or a mobile device 3540 to initiate the pickup process, receives a notification (such as an Email, text message, push notification and/or proprietary application message) that funds are available for pickup. At 3508, the receiver views the transfer on the phone (such as a smartphone) 3540 or computer 3502. At 3510, the receiver selects a retail location, such as nearby retail locations shown on a digital map. At 3512, a barcode (e.g., a UPC) is generated for the pickup and is displayed on the mobile phone 3540 or printed out from the computer 3502. The barcode indicates the transfer amount, the pickup retail location, etc. At 3514, the receiver 3122 goes to the selected retail location. Moreover, at 3514, the receiver 3122 has the barcode scanned by a POS at the retail location to initiate a retail pickup transaction process 3516. The process 3516 is further illustrated by reference to FIG. 6.

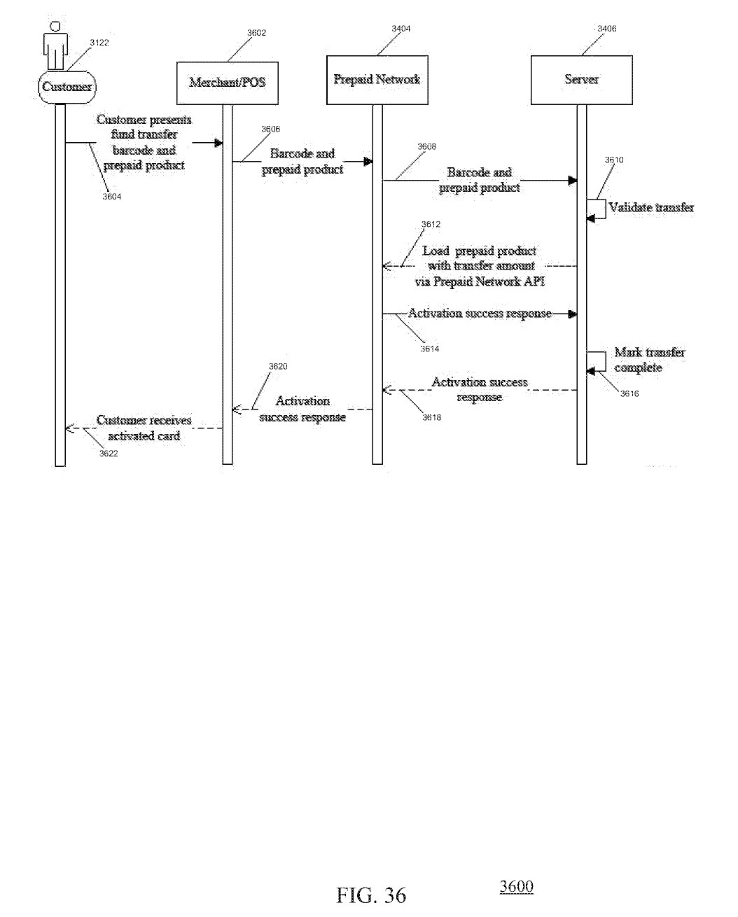

FIG. 36 is an example sequence diagram depicting an exemplary process 3600 by which an example MTP fund transfer is received and terminated. At 3604, the receiver 3122 presents the fund transfer barcode and a prepaid product (e.g., a prepaid magnetic card) to a clerk at the selected retail location hosting a POS 3602. At 3606, the POS 3602 sends information of the barcode and the prepaid product to the server 3404. At 3608, the server 3404 sends information of the barcode and the prepaid product to the server 3406. At 3610, the server 3406 validates the transfer. At 3612, the server 3406 directs the server 3404 to load the prepaid product with the transfer amount using prepaid network API (Application Programming Interface). At 3614, the server 3404 notifies the server 3406 of successful activation of the transfer. At 3616, the server 3406 marks the transfer as complete. At 3618, the server 3406 notifies the server 3404 of successful activation of the transfer. At 3620, the server 3404 notifies the POS 3602 of the successful activation of the transfer. At 3622, the clerk tenders the prepaid card, a new or existing one to the receiver 3122.

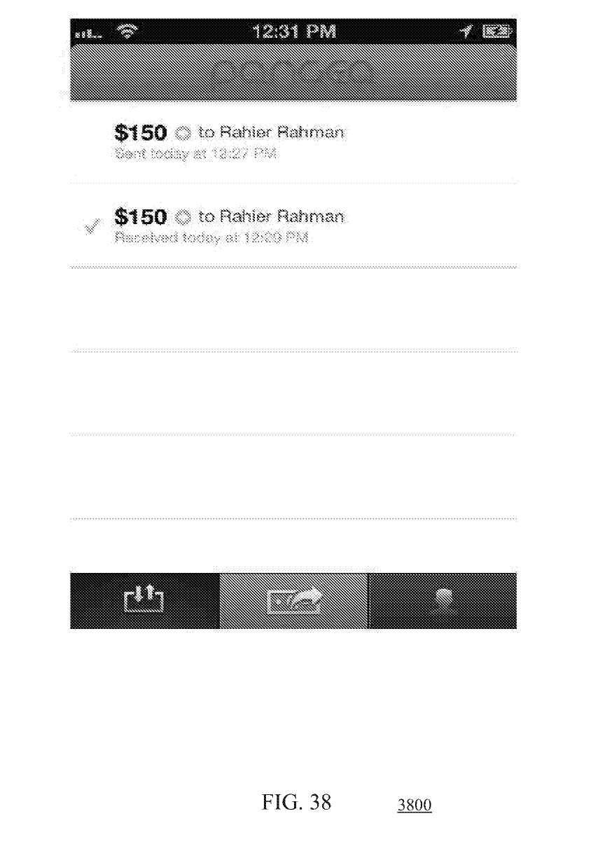

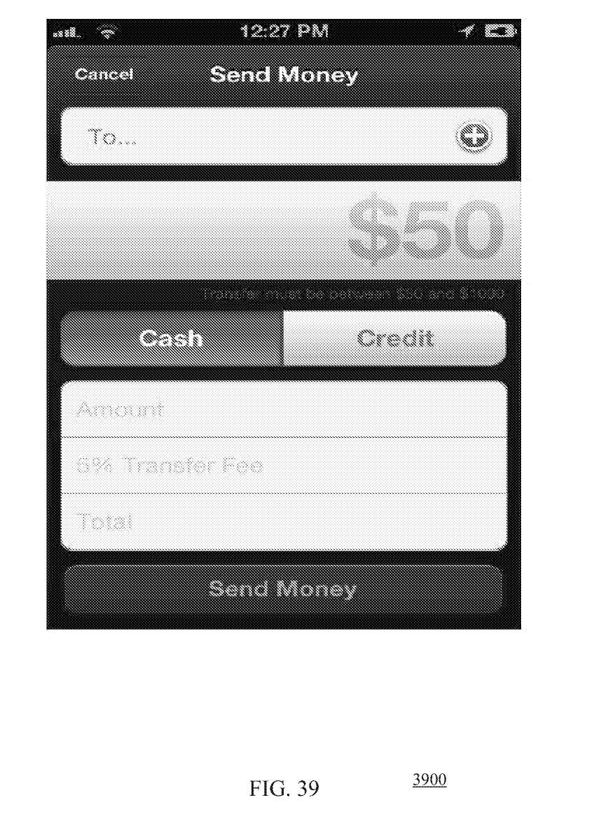

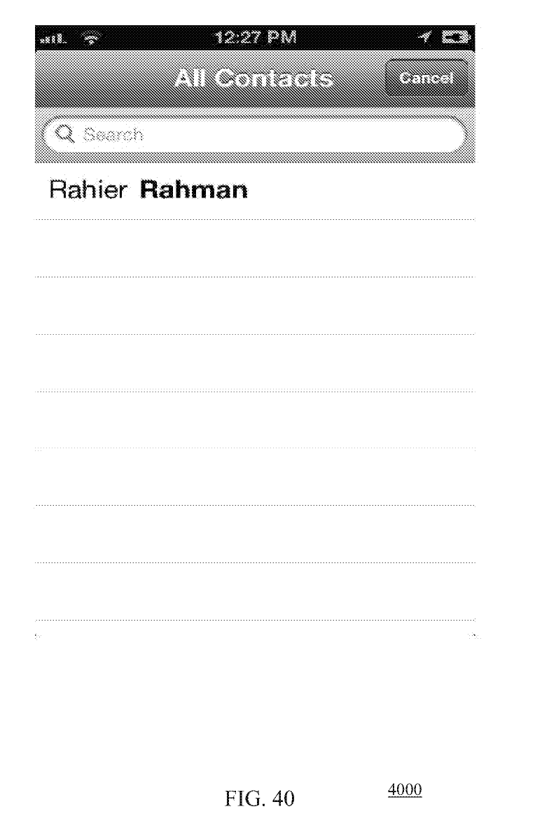

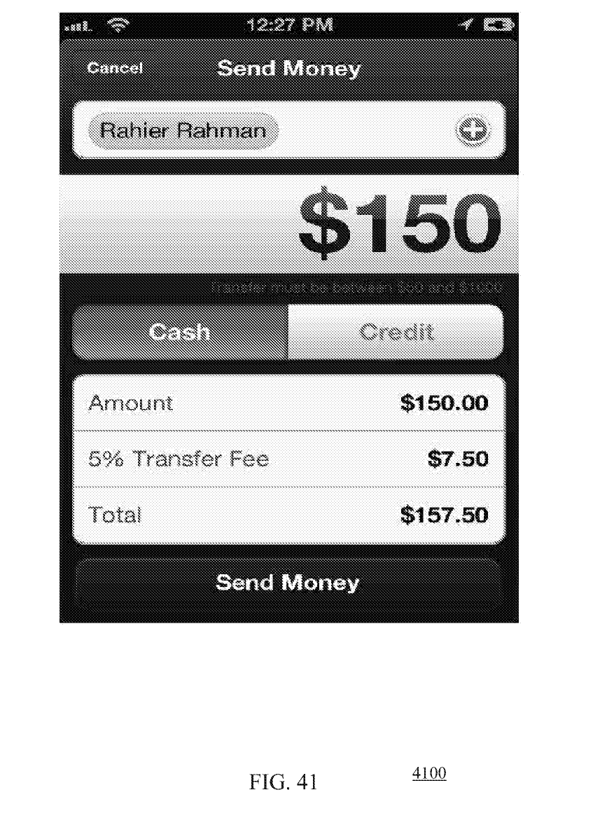

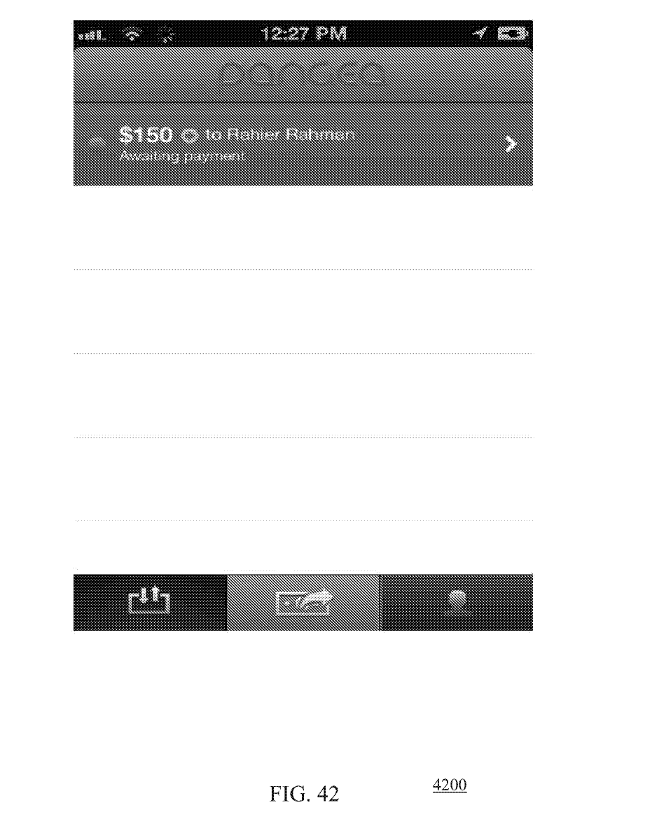

The MTP money transfer system and method are further illustrated by reference to example screenshots of mobile devices (e.g., an IPHONE) used by the sender 3102 and the receiver 3122 in one implementation. The example screenshots are shown in FIGS. 38, 39, 40, 41, 42, 43, 44, 45, 46, 47, 48, 49, 50, 51, 52, 53, and 54. The screen of FIG. 38 displays a list of MTP money transfers made by the sender 3102. Using the screen of FIG. 39, the sender 3102 can initiate a transfer by selecting a receiver, specifying transfer amount and clicking a Send Money button. The screen of FIG. 40 shows a list of contacts for the sender 3102 to select a receiver from. The screen of FIG. 41 is the screen of FIG. 39 with transfer information shown, such as the transfer amount, receiver and transfer fee. The screen of FIG. 42 shows that the next step of the funds transfer is for the sender 3102's pay for the transfer funds, such as tendering cash at a retail location.

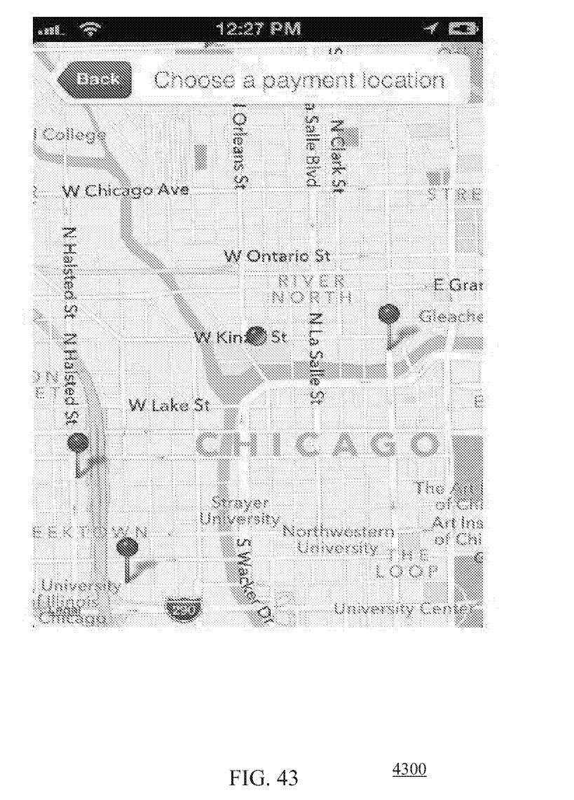

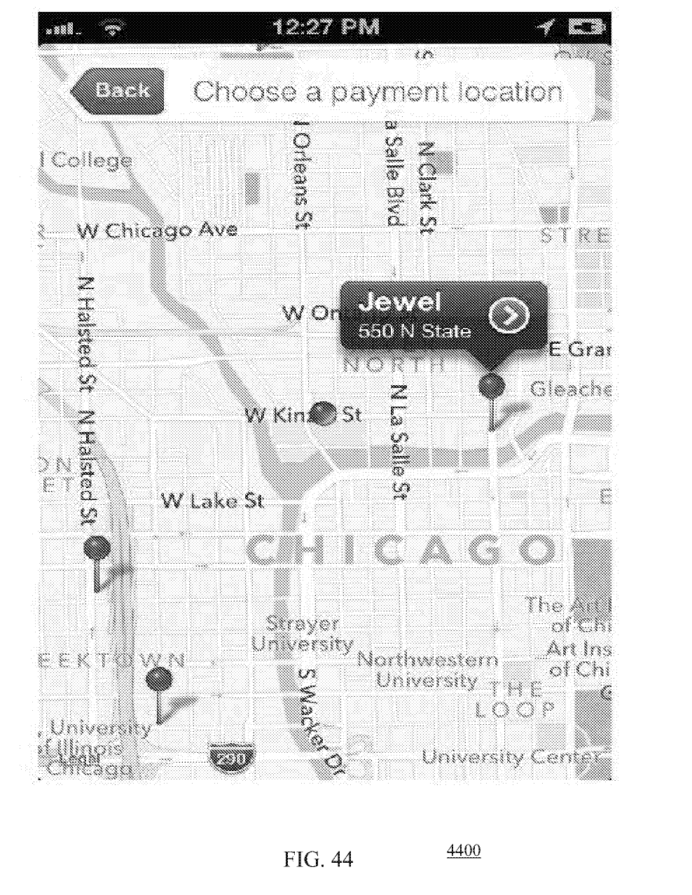

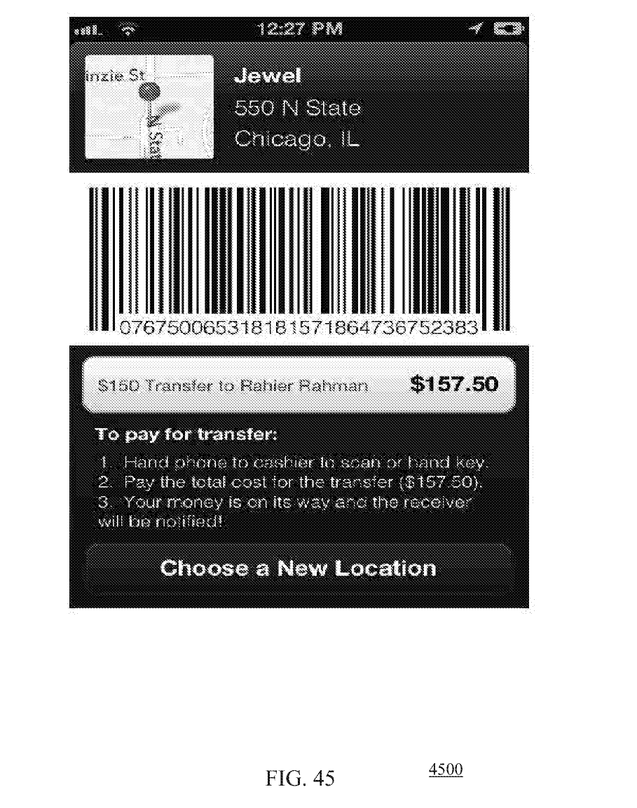

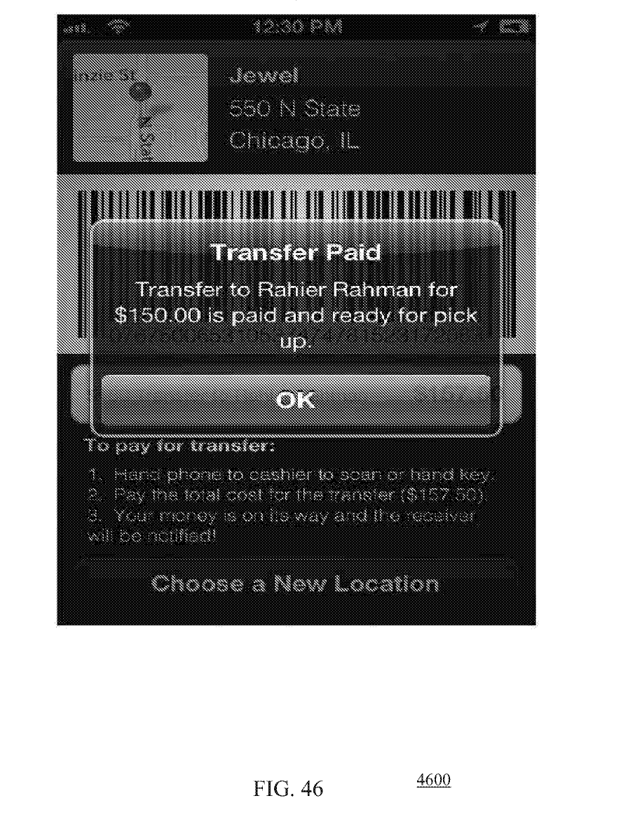

The screen of FIG. 43 displays a map around the current GPS of the sender 3102's mobile phone. Moreover, a number of nearby retail stores are indicates as bubble pins. In the screen of FIG. 44, one retail store is clicked and the retail store's detailed information is shown. In some implementations, the map is displayed using APPLE MAPS service or other map-type service. A mobile application program retrieves the current GPS location, retrieves nearby retail stores from a database or memory cache and indicates the retail stores when the map is rendered on the mobile phone's screen. Each retail store is associated with a prepaid network. The screen of FIG. 45 displays an example barcode generated for this transfer. After the barcode is scanned by a POS at the selected retail location, and the funds are paid by the sender 3102, the screen of FIG. 46 is shown.

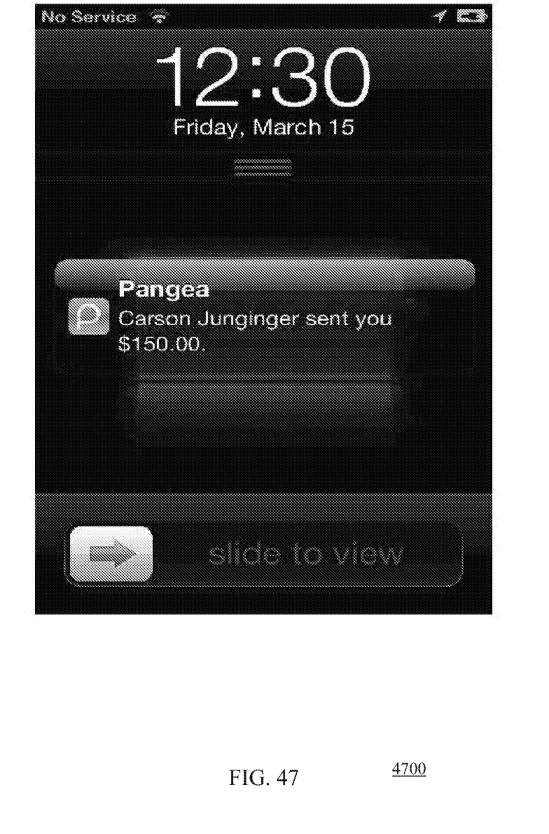

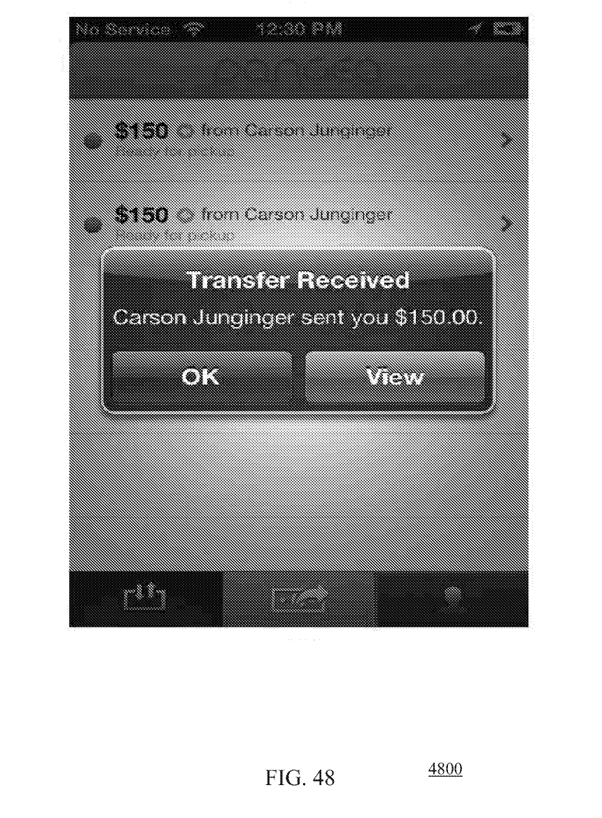

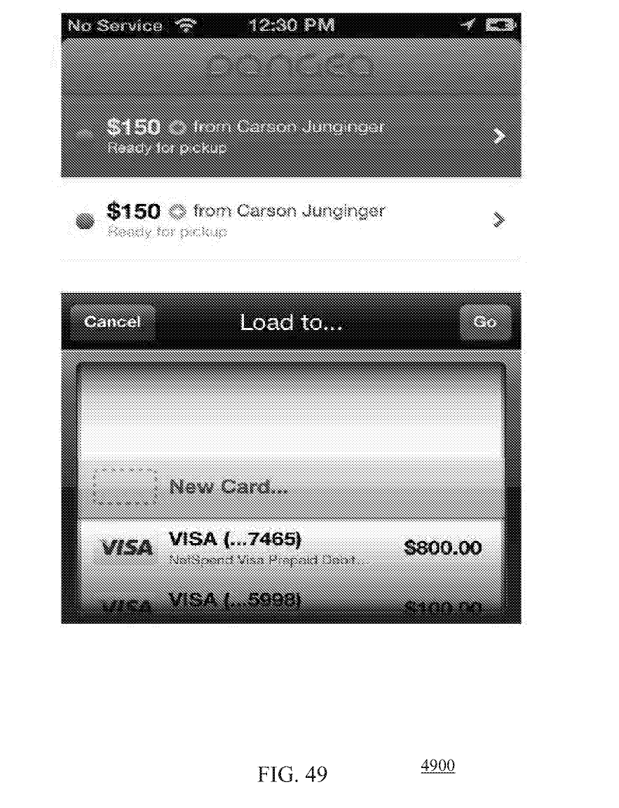

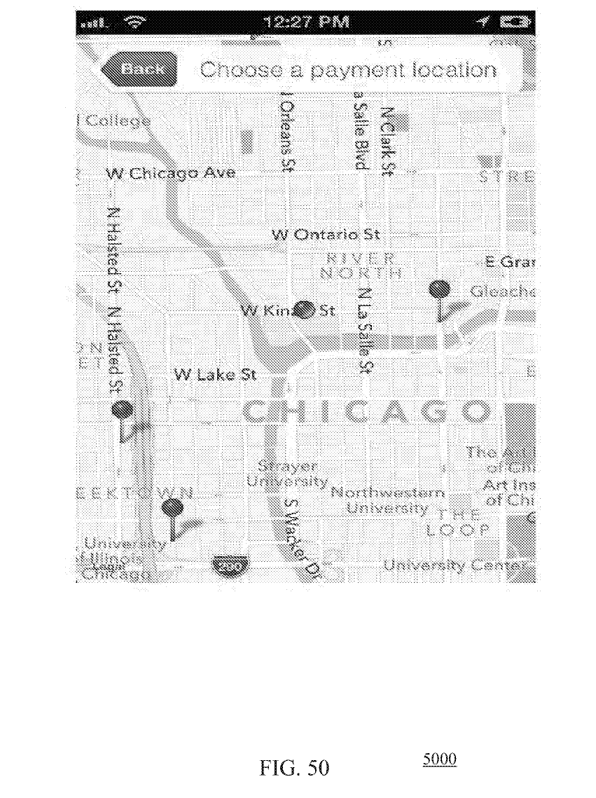

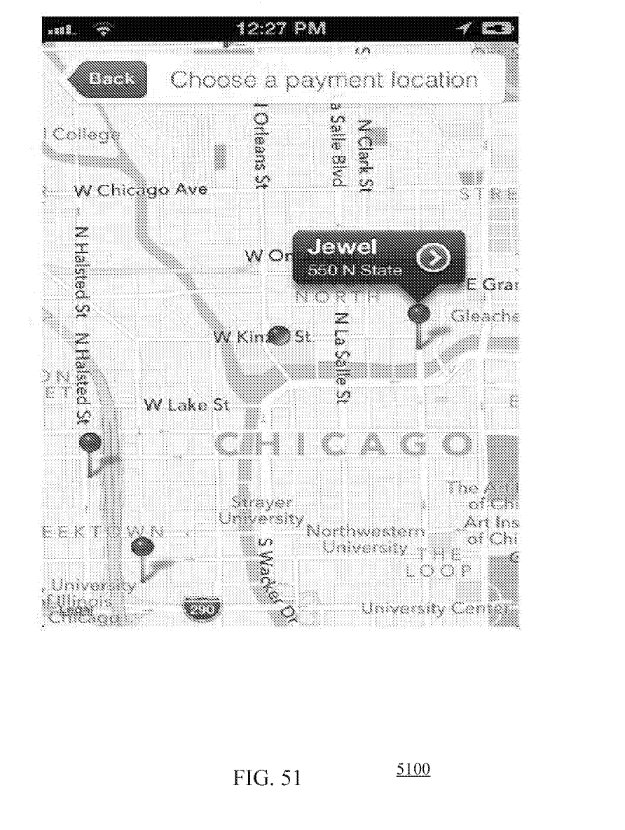

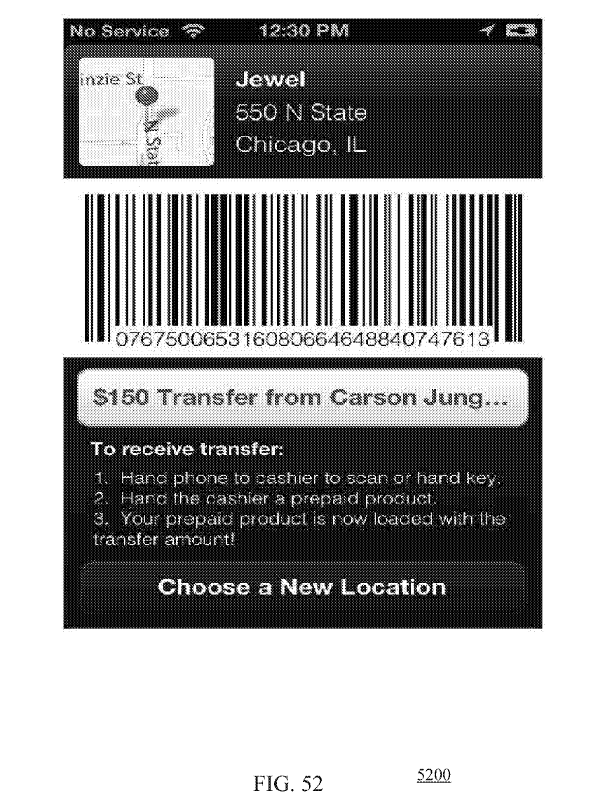

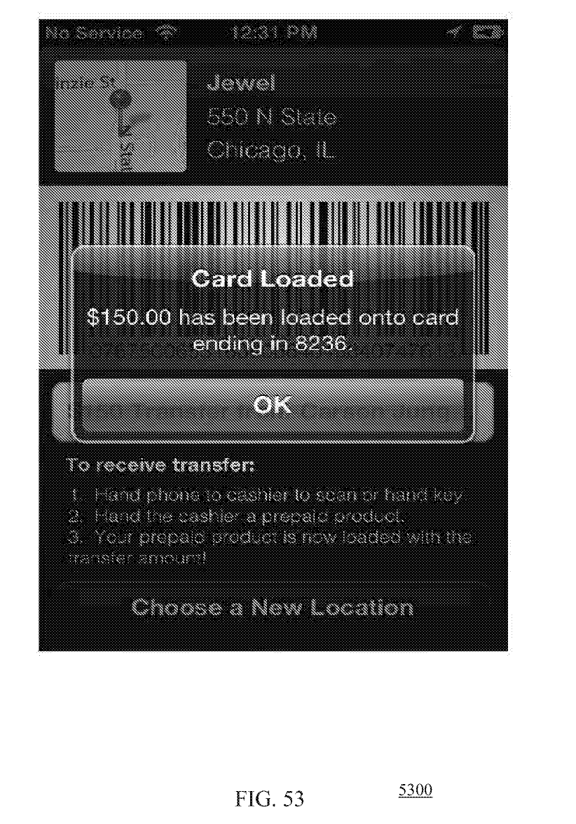

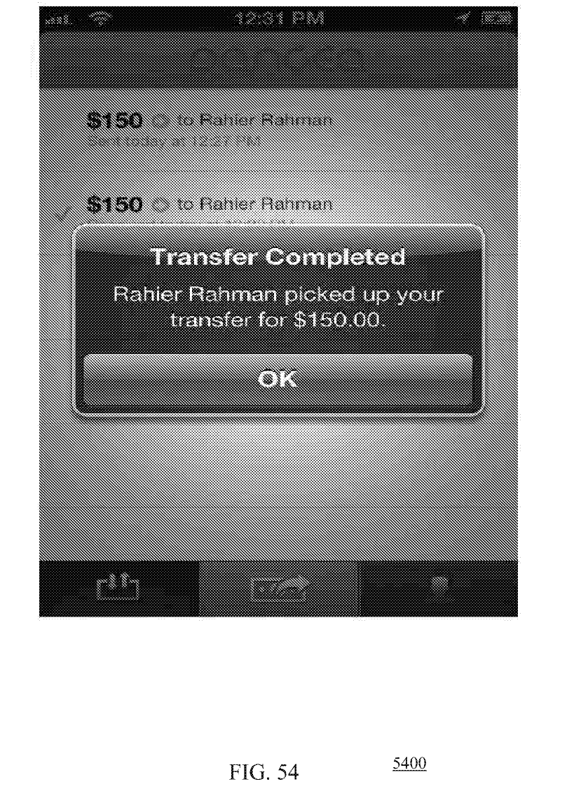

The screen of FIG. 47 shows an example notification on the receiver 3122's mobile phone. After the receiver 3122 unlocks the screen, the screen of FIG. 48 is shown. The receiver 3122 can view the details of the transfer, or accept the transfer. In the screen of FIG. 49, the receiver 3122 can select an existing prepaid card or a new card to receive the transfer amount. Then, the screen of FIG. 50 displays a map based on the receiver 3122's mobile phone's GPS location. Further, one or more nearby retail locations are shown on the map. The screen of FIG. 51 shows the selected retail store by the receiver 3122. The screen of FIG. 52 then displays a barcode generated for the transfer pickup. The barcode indicates the transfer amount, the pickup retail store, etc. Then the receiver 3122 visits the selected retail store, has the barcode scanned by a POS at the retail store and received the prepaid card loaded with the transferred amount. A confirmation of the reception of transferred fund is shown in the screen of FIG. 53. Thereafter, a transfer complete confirmation message is shown in the screen of FIG. 54 on the sender 3102's mobile phone.

Many additional modifications and variations of the present disclosure are possible in light of the above teachings. Thus, it is to be understood that, within the scope of the appended claims, the disclosure may be practiced otherwise than is specifically described above. For example, the functionality of the server 3404 or 3406 can be performed by more than one server. As an additional example, the servers 3404 and 3406 each access on or more databases to perform a MTP money transfer.

The foregoing description of the disclosure has been presented for purposes of illustration and description, and is not intended to be exhaustive or to limit the disclosure to the precise form disclosed. The description was selected to best explain the principles of the present teachings and practical application of these principles to enable others skilled in the art to best utilize the disclosure in various implementations and various modifications as are suited to the particular use contemplated. It is intended that the scope of the disclosure not be limited by the specification, but be defined by the claims set forth below.

As will be apparent to those of ordinary skill in the art, elements of FIGS. 31-54 are, in some implementations, consistent with elements of FIGS. 1-30. For example, receiver 104 of FIG. 1 can, in some implementations, be the same as receiver 3122 of FIG. 31. In other implementations, receiver 104 and receiver 3122 can be different. In some implementations, other elements of FIGS. 31-54 are considered to be the same as corresponding elements of FIGS. 1-30 in a manner consistent with this disclosure.

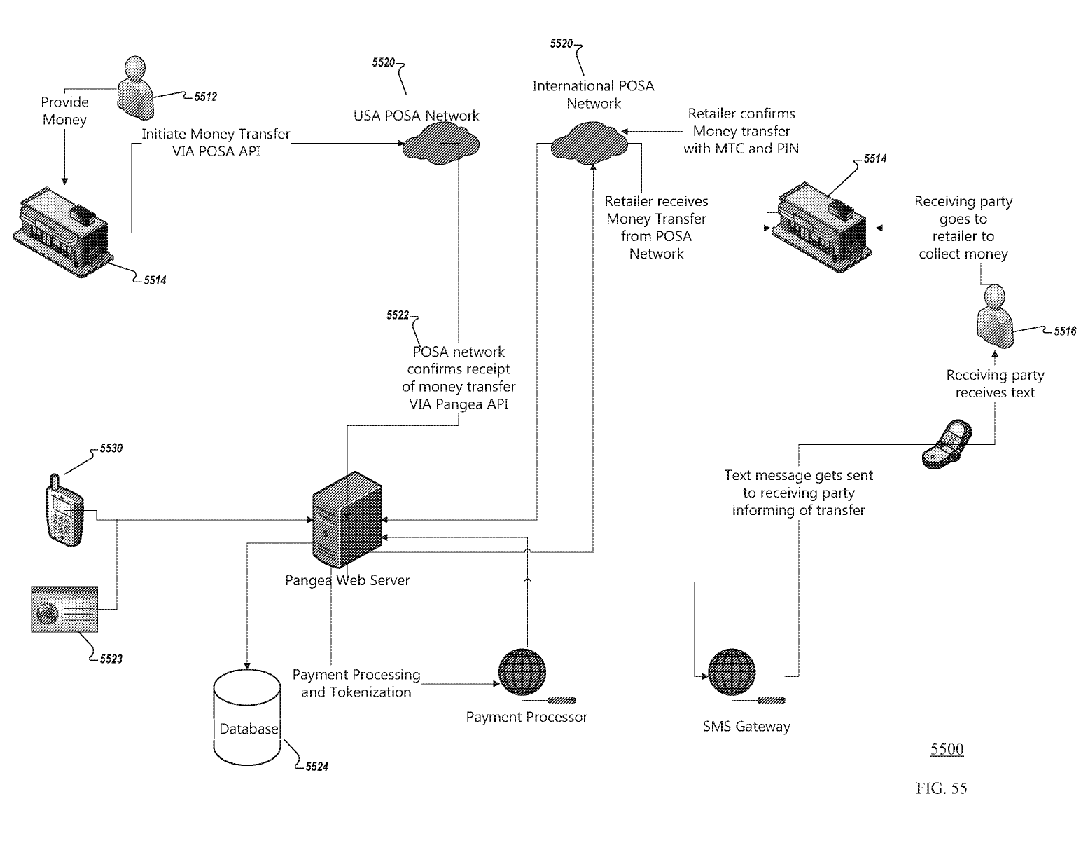

The system and method for a MTP funds transfer may comprise a MTP system that provides a low-cost suite of financial service products using a website, mobile application, and/or retail locations. Example system 5500, shown in FIG. 55, provides a mechanism to seamlessly transfer stored value across retail networks and card programs. The example system 5500 platform acts like a clearing house in that the platform includes components that handle settlement and reconciliation for the point-of-sale activation (POSA) networks and funds transactions using a credit line. To utilize the example system 5500 platform on a web application 5526 and/or a mobile application 5530, consumers can, in some implementations, link a mobile phone number and a funding source, such as a prepaid debit card, to an example system 5500 account. In these implementations, consumers wanting to fund a transaction with cash use the example system 5500 platform at a retail location, and then link a mobile phone number to a transaction.

One or more implementations of example system 5500 also provides basic consumer functionality, such as account creation and management, provides the ability to interact with third party fraud detection services, as well as the system's own fraud prevention service, to validate transactions in real-time, provides merchant processing, provides SMS and voice confirmation once services are completed, provides consumer transaction tracking and customer support, provides settlement with consumer accounts and merchant accounts, provides data storage of know-your-customer (KYC) information and compliance (e.g., anti-money laundering (AML) and OFAC requirements), and provides a mobile software application that will provide a code (e.g., 2D, 3D, QR, barcode, or other type of digital code) that can be read by POS terminals to facilitate quicker transactions at retail locations and that will also be backward compatible with the a phone number or other identifier associated with the customer account. Example system 5500 also has the ability to interface with many external application programming interfaces (API) of channel partners, such as POSA networks and prepaid processors, to facilitate the transfer of value across networks.

Example system 5500 uses the POSA network 5520 within the retail payment ecosystem by integrating into the retail payment ecosystem, such as POS terminals and processors, through existing prepaid activation rails. Prepaid activation rails include, in some implementations, prepaid cards, for example those at retail stores. The prepaid cards, when not purchased, are essentially un-activated debit card accounts. When purchased, the cards are activated by a prepaid network. The system used to activate the card from the POS system in retail all the way to the database of record from the card issuer would be a “prepaid activation rail.” Example system 5500 provides software interconnectivity across prepaid retail networks enabling “closed loop” systems to speak to each other. In some implementations, “closed loop” refers to a stored value card (e.g., gift cards) that is only spendable at a particular retailer (e.g., Wal-Mart gift card, etc.). Example system 5500 can also facilitate “open loop” transfer capability across the networks and will provide AML, OFAC, and compliance support for participating retailers. “Open loop,” in some implementations, is a reference to a stored value card that can be spent at any merchant processing agreement (e.g., through Visa, MasterCard, American Express, etc.). Retail locations can use their existing POS terminals, such as those provided by Ingenico, Verifone, and the like.

In some implementations, example system 5500 additionally offers remote deposit capture that includes the ability, among others, to scan an image of a check online or through the mobile application and deposit funds directly onto a prepaid card, limiting the need to use check cashing locations. Example system 5500 can also offer bill-pay functionality that supports payments to utility companies, water companies, cable providers, department stores, banks, credit card companies, wireless service providers, or any other payee. In some implementations, the bill-pay feature is available through the mobile application and online user interface.

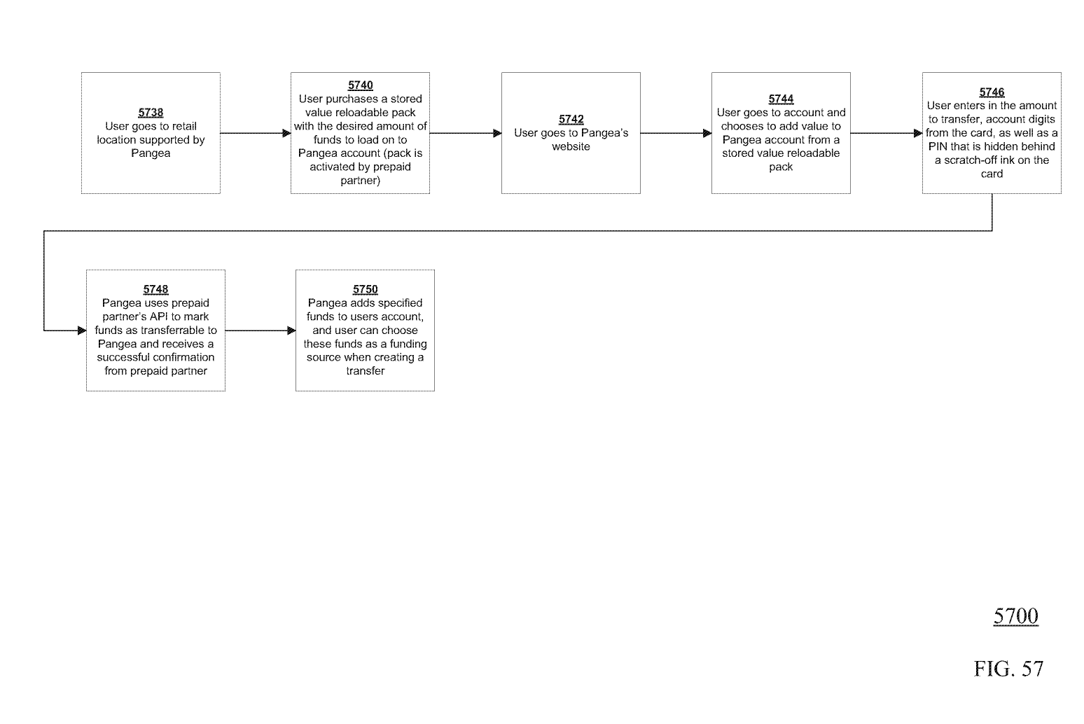

In some implementations, a customer can transmit funds to anyone in a few steps either online, through the mobile application, or in-person at a retail location. The sender 5512 can initiate a funds transfer through interactions with a sales associate at a retail location 5514 (also shown in FIG. 57), and a custom example system 5500 graphical user interface on the POSA software or through an example system 5500 webpage on the POS hardware. The sender 5512 will then provide the sales associate with the sender's name, phone number, receiver's 5516 name, receiver's 5516 phone number, the amount of funds to transfer, cash or any other form of payment, and/or a transfer pincode (e.g., a “PIN” transferred between retailer 5514 to an international POSA network 5520). In some implementations, the transfer pincode can be communicated to a receiver by a sender directly and displayed to (and in some instances chosen by) the sender in a mobile application). The sales associate will enter the data into an example system 5500 user interface on their POS device, show the sender 5512 the confirmation screen showing the transfer detail and if the sender 5512 approves the transaction, the sales associate may charge the sender 5512 the appropriate amount to fund the transfer and the fees associated with the transaction. In certain implementations, the POS device will communicate with the POSA network 5520 that is integrated with the system's 5500 external API 5522. The POSA network 5520 will make a request to the example system 5500 and the example system 5500 may create an active transfer in the example system 5500, record all data necessary to orchestrate a transfer of funds from the POSA network 5520 to the example system 5500, and/or return the POSA network 5520 with the data necessary for the retailer 5514 to give the sender 5512 the transaction identifier, the money transfer code (MTC) 26 (or receiver code/transfer identifier—e.g., sent to a receiver 5516 using a SMS message), the transfer pincode, the transaction amount in originating and terminating currencies (which may be the same currency), the conversion rate, and/or the fee amount. The sales associate will give the sender 5512 a receipt and the example system 5500 will then send an SMS message and/or email to the sender 12 and the receiver 16, notifying them that the money transfer is active in the system 10 and can be retrieved.

In some implementations, if the receiver 5516 is getting a new card, the sender's 5512 funding source is charged the amount of the transfer and fees. If this is an instant transfer from a bank, the funds will be deposited into the system's 5500 settlement account. If this is a credit card charge, the funds will be processed by a payment processor, and when released will enter the system's 5500 settlement account. After the transfer is successfully processed, the transfer will become live in the system's 5500 database 5524 and is accessible by any POSA network 5520 partner that is integrated with the system's 5500 external API 5522. To reload a receiver's 5516 existing account, the sender's 5512 funding source is charged and the example system 5500 contacts the API of the POSA network 5520 to reload the general purpose reloadable (GPR) card by the amount charged.

In some implementations, the sender 5512 contacts the receiver 5516 and gives them the transfer pincode. Sending the receiver 5516 the MTC 26 and the transfer pincode in two separate communications prevents an unintended recipient from receiving the funds. When the receiver 5516 goes to a retail store 5514 that uses a POSA network 5520 integrated with the example system 5500, the receiver will instruct the sales associate that they are receiving a payment and will need to provide the sales associate with the receiver's 5516 name, phone number, the MTC 26 and the transfer pincode. The sales associate will enter this data into the POS device using an example system 5500 user interface. Once submitted, the example system 5500 will make a request to the POSA network's 5520 API, which is integrated with the example system's 5500 external API 5522. The POSA network 5520 will make a request to the example system 5500 to determine if there is an active transfer matching the data entered into the example system 5500. If so, the example system 5500 will return the necessary data and coordinate the transfer of money and fees to the POSA network 5520 and the POSA network 5520 will activate a GPR card or a one-time use card at the retail location 5514. If a GPR card is used, data regarding this account, including a token for referencing the account in future transactions, may be provided to the example system 5500 using the API 5522. The receiver 5516 can then receive an activated pre-paid card with the amount of the transfer loaded onto it.

In some implementations, the sender 5512 can initiate a funds transfer by scanning an example system 5500 one-time activation gift card at the retail location 5514, where the sender 5512 will purchase the gift card with fees at the time of sale and use the gift card to initiate a web or mobile application transfer with credit from the gift card. In some implementations, the sender 5512 can also initiate the transfer by scanning a code (e.g., 2D, 3D, QR, barcode, or other type of digital code), or entering a number from a native/web mobile application and loading value to the sender's 5512 example system 5500 account. The sender 5512 will then use this value to initiate a web or mobile funds transfer.

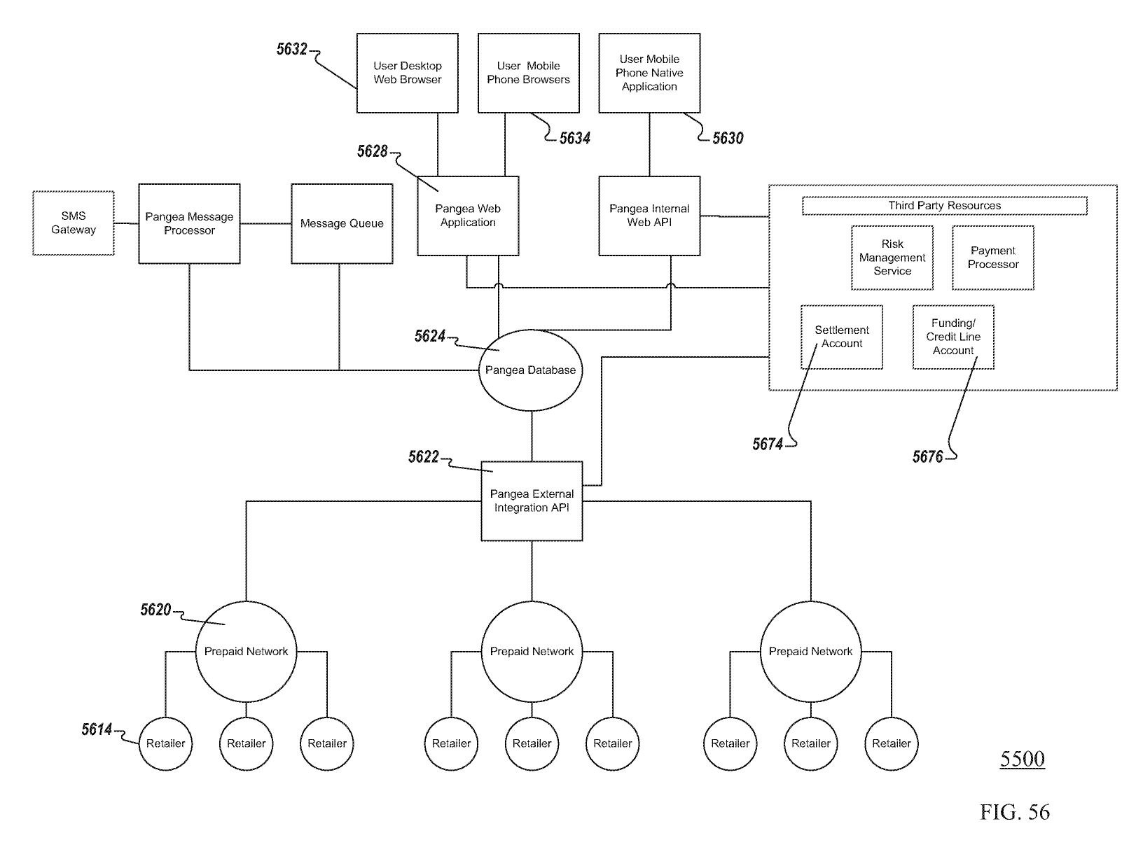

In the example system shown in FIG. 56, a user desktop web browser 5632 and a user mobile phone browser 5634 accesses a Pangea (e.g., MTP) web application in order to interact with the MTP system. In some implementations, the user mobile phone native application 5630 can communicate with the Pangea internal web API (e.g., Pangea/MTP mobile API) in order to interact with the MTP system. The Pangea web application 5628 and Pangea external integration API (e.g., a partner API) 5622 store and fetch data from the Pangea database 5624. The Retailer 5614 connects to the prepaid network partner 5620, which in turn can connect to the Pangea external API 5622 in order to coordination transfer cash payouts. The funding/credit line account 5676 is used to pay to the foreign exchange partner in order to prefund transfers in a destination country/location. The settlement account 5674 is used to receive funds from the network partner from cash-ins, and reimburse the funding/credit line account 5676.

Turning now to the example method shown in FIG. 57, in some implementations, the sender 5512 can also initiate by going to a retail location 5738, shown in FIG. 57, and purchasing a stored value reloadable pack, which is activated by a prepaid partner, with the desired amount of funds to load onto the example system 5500 account 5740. The sender 5512 then goes to the example system's 5500 website 5742 and logs into his or her account. Once logged in, the sender 5512 chooses to add value to his or her account from a stored value reloadable pack 5744. The sender 5512 enters in the amount to transfer, the account digits from the card, and the PIN that is hidden behind scratch-off ink on the back of the card 5746. The example system 5500 uses the prepaid partner's API to mark funds as transferable to the example system 5500 and receives a successful confirmation from the prepaid partner 5748. The example system 5500 then adds the specified funds to the sender's 5512 account and the sender 5512 can choose these funds as a funding source when creating a web or mobile application funds transfer 5750.

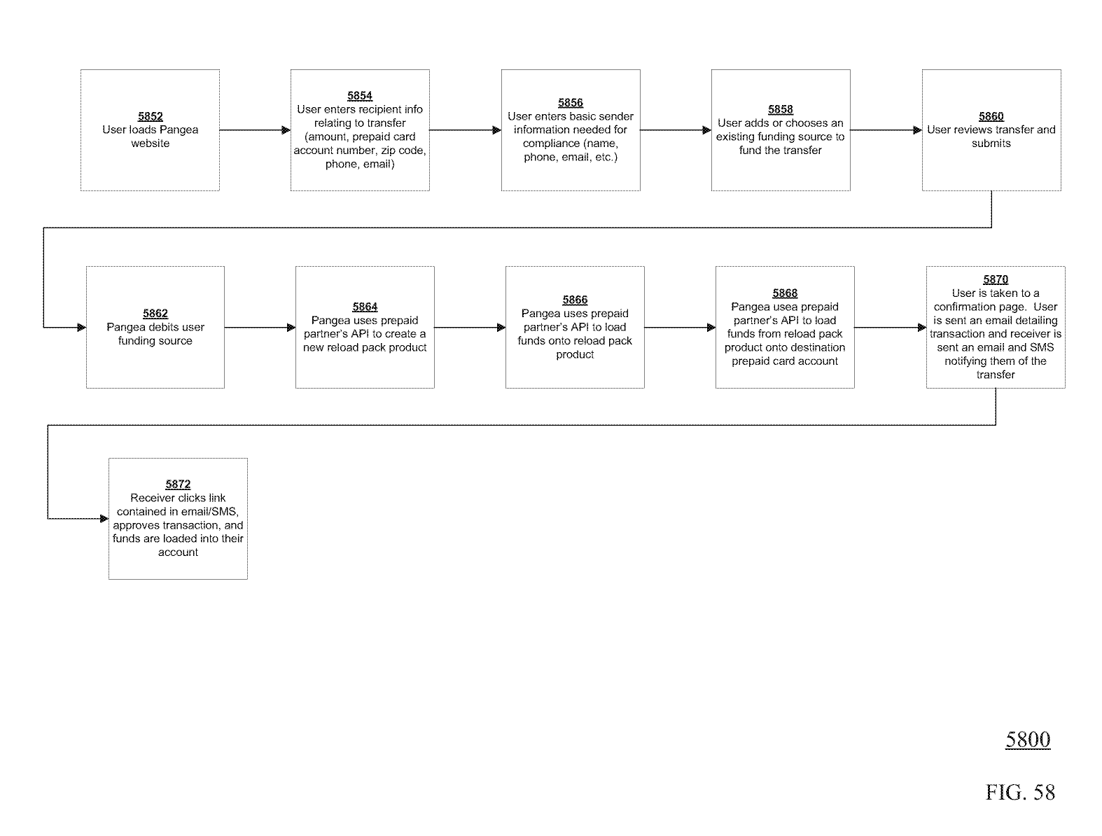

To initiate a transfer online or through a mobile application, an example method shown in FIG. 58, the sender 5512 loads the example system's 5500 website 5852 and the sender 5512 can either log into his or her account or initiates a transaction without an account. The sender 5512 then enters the basic KYC information for the transaction. If the receiver 5516 has a single card on file in the example system 5500, the sender 5512 then enters the recipient's 5516 information relating to the transfer 5854, such as the receiver's 5516 name, phone number, the amount to transfer, the card account number, zip code, and/or email address. The sender 5512 enters his or her own basic information 5856, which is needed for compliance, such as the sender's 5512 name, phone number, and/or email address. The sender 5512 will also enter a password and an account will be created in the example system 5500. The sender 5512 then adds or chooses an existing funding source to fund the transfer 5858. The sender 5512 reviews the transfer and submits the transfer for processing 5860. The example system 5500 debits the sender's 5512 funding source 5862 and uses the prepaid partner API to create a new reload pack product 5864. The example system 5500 uses the prepaid partner's API to load funds onto the reload pack product 5866 and then to load funds from the reload pack product onto the destination prepaid card account 5868. The sender 5512 is then taken to a confirmation page, the sender 5512 is sent an email detailing the transaction, and the receiver 5516 is sent an email and SMS message notifying them of the transfer 5870 and will include a URL allowing the receiver 5516 to accept the funds transfer to their account. The receiver 5516 at 5872 clicks the link contained within the email or SMS message, approves the transaction, and the funds are loaded onto their account58. If the receiver 5516 has multiple cards on file in the example system 5500, the receiver 5516 can choose the card on file on which to load the funds.

In the example method, if the receiver 5516 does not have a card on file in the example system 5500, the sender logs into the system's 5500 website 5628 (shown in the example method of FIG. 56), or uses the example system 5500 as a guest, and the sender 5512 enters basic KYC information, such as their name, phone number, password and an optional email address. The sender 5512 submits the KYC information, an account is created, the sender 5512 is logged into the example system 5500 and is redirected to the transaction landing page. The sender 5512 then initiates a transaction and enters the details for the transfer, including the amount to transfer and chooses the payment method, if it's already linked to the sender's 5512 account, or enters a new payment method if that payment method is not already linked to the sender's 5512 account. If entering a new payment method, the account details are sent to the payment processor directly and tokenized into a card or customer token, allowing for minimal PCI scope of the example system 5500 application. The example system 5500 requires the sender 5512 to enter the payment details, such as the card number, card security code, the expiration date, and the billing zip code when entering a new payment method. The token is saved in order to keep a list of linked payment methods for the sender 5512 to choose from in the future. The sender 5512 then enters the receiver's 5516 name, phone number, and the transfer pincode and submits the transaction. The sender 5512 is then directed to the confirmation page, displaying the status of the transaction and the status of the notification. The system generates the MTC 26 and will send a notification of the transfer with the MTC 26 to the receiver 5516 using SMS message or email.

In the example method, if the receiver 5516 has multiple cards on file, the receiver 5516 can be required to contact the example system 5500, by logging into the website 5628 or mobile application 5630 (refer to FIG. 56), and to select the card in which to load the funds. The receiver 5516 will use one of the cards issued in previous transfers, allowing the example system 5500 to directly load funds onto that card in real time. Alternatively, the receiver 5516 can obtain a new card by using a retailer location map. The retailer location map is a searchable interactive web-based map similar to a locations map displayed in the mobile software application (e.g., similar to FIGS. 19-20) with geo-location capability. The retailer location map allows the receiver 5516 to find all locations in a region or all locations closest to him or her. The receiver 5516 then goes to the retail store of their choosing and chooses a pre-paid card to have the retailer activate and load the amount of the transferred funds.

The foregoing description of an illustrated implementation of the disclosure has been presented for purposes of illustration and description, and is not intended to be exhaustive or limiting to the precise form disclosed. The description was selected to best explain the principles and practical application of the principles to enable others skilled in the art to best utilize the described subject matter in various implementations and various modifications as are suited to the particular use contemplated. It is intended that the scope of the disclosure not be limited by the specification, but be defined by the claims set forth below.

As will be apparent to those of ordinary skill in the art, elements of FIGS. 55-58 are, in some implementations, consistent with elements of FIGS. 1-54. For example, receiver 104 of FIG. 1 can, in some implementations, be the same as receiver 5516 of FIG. 55. In other implementations, receiver 104 and receiver 5516 can be different. In some implementations, other elements of FIGS. 55-58 are considered to be the same as corresponding elements of FIGS. 1-54 in a manner consistent with this disclosure.

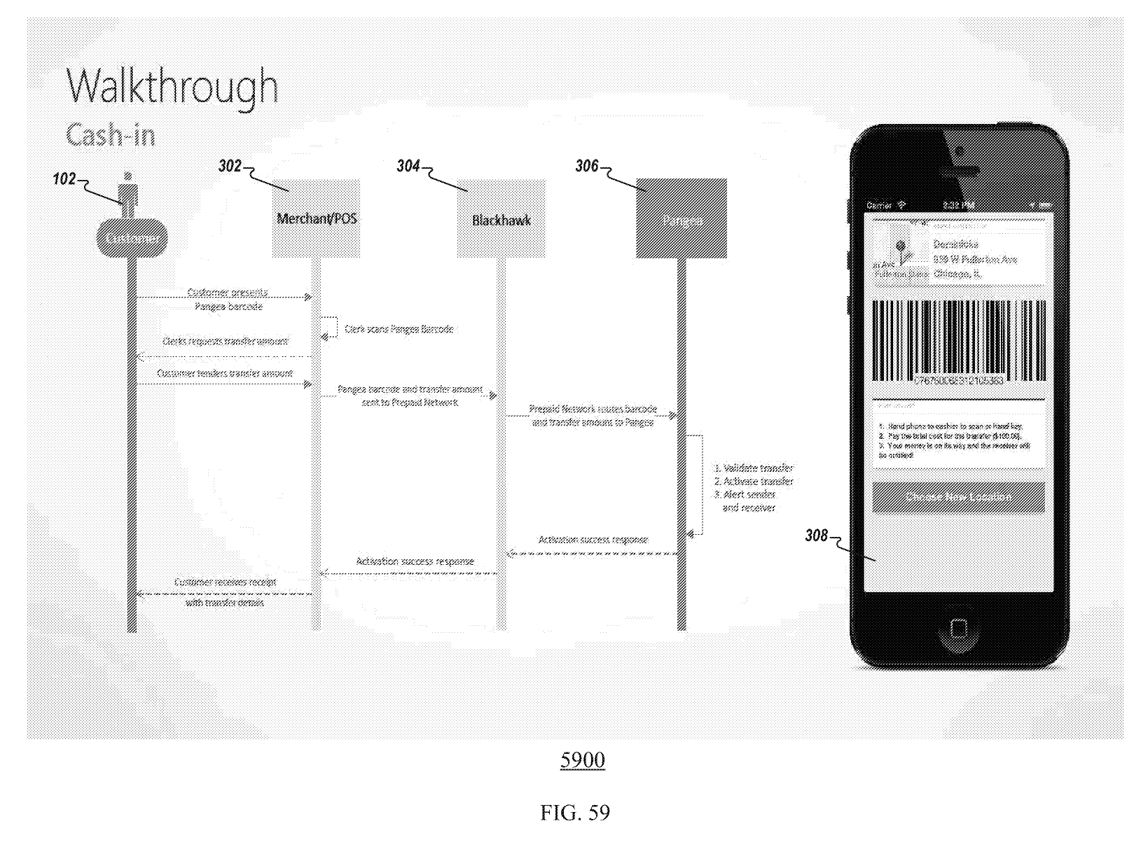

FIG. 59 illustrates a walkthrough of an example cash-in process 5900. A customer (sender) 102 presents a barcode (e.g., illustrated on mobile application 308) to a merchant (e.g., a retailer) 302. In some implementations, generated barcodes can begin with a standard product SKU designating a prepaid network 304/MTP 306 product (e.g., 5 digits representing the transfer amount followed by a variable length number identifying a transfer in the MTP 306.) In some implementations, the transfer amount can be limited, say $50.00 to $500.00 or some other amount/range. In some implementations, ranges are stored in a merchant 302 database (e.g., 07699000099xxxxxxx to 07699099999xxxxxxx). An example of a $100.99 transfer could be represented by barcode: “076990100995067585083456598999” with “076990” as the prepaid network 304 identifier, “10099” transfer amount of $100 dollars and 99 cents, and a MTP 306 transfer identifier of “5067585083456598999.”

In the example method, the merchant 302 scans the presented barcode and request a transfer amount from the sender 102. The sender 102 provides a transfer amount to the merchant 302. The merchant 302 sends the barcode and transfer amount to a prepaid network 304 (e.g., Blackhawk Network). The prepaid network 304 routes the barcode and transfer amount to a MTP 306 (e.g., Pangea). The MTP 306 validates the transfer, activates the transfer, and alerts the sender and receiver (e.g., using SMS messages, email, etc.). The MTP 306 transmits an activation success response to the prepaid network 304 which routes the activation success response to the merchant 302 which transmits a receipt with transfer details to the sender 102.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example, a programmable processor, a computer, or multiple processors or computers. The apparatus can also be or further include special purpose logic circuitry, e.g., a central processing unit (CPU), a field programmable gate array (FPGA), or an application-specific integrated circuit (ASIC). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a cathode ray tube (CRT), liquid crystal display (LCD), light emitting diode (LED), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers using this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations, but rather as descriptions of features that may be specific to particular implementations of the described subject matter. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results. Accordingly, the above description of example implementations does not define or constrain this disclosure. Other changes, substitutions, and alterations are also possible without departing from the spirit and scope of this disclosure. Thus, it is to be understood that, within the scope of the appended claims, the disclosure may be practiced otherwise than is specifically described above.

The foregoing description of the disclosure has been presented for purposes of illustration and description, and is not intended to be exhaustive or to limit the disclosure to the precise form disclosed. The description was selected to best explain the principles of the present teachings and practical application of these principles to enable others skilled in the art to best utilize the disclosure in various implementations and various modifications as are suited to the particular use contemplated. It is intended that the scope of the disclosure not be limited by the specification, but be defined by the claims set forth below.

What is claimed is:

1. A method of electronic funds transfer, comprising:
receiving a funds transfer transaction request for transferring funds from a first location to a receiver in a second location, the funds transfer transaction request associated with a funds pack credited with an amount of funds;
requesting, by operation of a computer, validation of a unique identifier associated with the funds pack from a first payment network provider associated with the first location;
receiving, by operation of a computer, a validation success notification responsive to the requested validation of a unique identifier from the first payment network provider;
generating, by operation of a computer, a termination identifier identifying the funds transfer transaction request;
transmitting the termination identifier to the receiver;
providing instructions, by operation of a computer, causing funds to be paid to the receiver upon presentation of the termination identifier; and
receiving a request for funds from a second payment network provider associated with the second location, the request for funds associated with payment of funds based on presentation of the termination identifier.

2. The method of claim 1, further comprising initiating a fund-in process for the funds transfer transaction request using the funds pack.

3. The method of claim 1, further comprising transmitting geographic locations that may be used for a fund-in process using the funds pack.

4. The method of claim 3, wherein a mobile software application initiates a display of the transmitted geographic locations.

5. The method of claim 1, further comprising storing encrypted data generated from the termination identifier and data associated with the funds transfer transaction request.

6. The method of claim 1, further comprising:
receiving the unique identifier associated with the funds pack and an amount of funds to credit to the funds pack; and
storing the unique identifier and the amount of funds to credit to the funds pack to a database.

7. The method of claim 6, further comprising initiating a funds transfer process to transfer a particular amount of credited funds from the first location to the second location.

8. The method of claim 7, further comprising generating instructions to:
convert the particular amount of credited funds into a different currency type; and
credit the different currency type to the second payment network provider.

9. A method of electronic funds transfer, comprising:
receiving an indication of an interest in transferring funds from a sender at a first location to a receiver at a second location;
receiving an indication of an initial funds transfer amount in a first currency for transfer to a receiver at the second location;
receiving a currency exchange rate value for an exchange of a first currency used at the first location and a second currency used at the second location;
converting, using the currency exchange rate, the initial funds transfer amount into a whole value initial funds receiving amount as measured in the second currency;
determining, by a computer, at least one whole value funds receiving amount associated with the initial funds receiving amount, in a whole value amount lower than the initial funds receiving amount or a whole value amount higher than the initial funds receiving amount, as measured in the second currency; and
initiating a display of the whole value initial funds receiving amount and the whole value funds receiving amount.

10. The method of claim 9, further comprising initiating a request for the currency exchange rate value between funds for the first location and the second location.

11. The method of claim 9, further comprising:
determining, by a computer, two whole value funds receiving amounts associated with the whole value initial funds receiving amount, one whole value funds receiving amount lower than the whole value initial funds receiving amount and one whole value funds receiving amount higher than the whole value initial funds receiving amount, as measured in the second currency; and
initiating a display of the whole value initial funds receiving amount and the two whole value funds receiving amounts.

12. The method of claim 11, further comprising:
receiving withdrawal denominations associated with automatic teller machines proximate to the receiver; and
using the withdrawal denominations to determine the two whole value funds receiving amounts.

13. The method of claim 11, further comprising initiating a display of a funds transfer history received from a money transfer platform (MTP) transfer service.

14. The method of claim 11, further comprising transmitting a funds transfer transaction request to a MTP transfer service, the funds transfer transaction request associated with a funds pack credited with an amount of funds for transfer from the first location to the receiver.

15. The method of claim 11, further comprising initiating a display of geographic locations available for the receiver to receive funds near the second location.

16. The method of claim 11, further comprising initiating a display of geographic locations available for the sender to provide funds to be transferred near the first location.

17. The method of claim 9, further comprising initiating a funds transfer transaction request for transferring funds from the first location to the receiver.

18. The method of claim 9, wherein the first currency is different than the second currency.

19. The method of claim 9, wherein the first location is in a country that is different than the country in which the second location is located.

20. The method of claim 9, further comprising receiving an indication of the currency to be used as the second currency transferred to the receiver at the second location.

21. The method of claim 9, wherein fees charged for the electronic funds transfer are subtracted from the initial funds transfer amount prior to converting currencies.

22. The method of claim 9, wherein fees charged for the electronic funds transfer are obtained by providing the sender an exchange rate different than an exchange rate received by an entity facilitating the electronic funds transfer.

23. The method of claim 9, wherein fees charged for the electronic funds transfer are denominated in the first currency.

24. A method of electronic funds transfer, comprising:
receiving an automatic identification and data capture (AIDC) code from a point-of-sale (POS), the AIDC code comprising a particular product identifier, transfer amount, and a unique transfer identifier;
transmitting the AIDC code to a money transfer platform (MTP) transfer service;
receiving an activation response from the MTP transfer service, the activation response responsive to the MTP transfer service:
validating, by a computer, the identified transfer;
activating the transfer; and
alerting a receiver uniquely identified by the unique transfer identifier; and
transmitting an activation response to the POS.

25. The method of claim 24, wherein the AIDC code includes one of a linear code or a matrix code.

26. The method of claim 24, wherein the receiver is uniquely identified by at least one of a telephone number, an address, a government issued identifier, or an employer issued identifier.

27. The method of claim 24, further comprising the POS requesting and receiving the transfer amount responsive to receiving the AIDC code.

28. The method of claim 27, wherein the POS receives the AIDC code from a mobile computing device.

29. The method of claim 27, further comprising the POS processing the received AIDC code.

30. The method of claim 24, wherein the MTP transfer service exposes an application programming interface (API) for receiving a request containing the AIDC code.
